(19) United States
(12) Patent Application Publication
(10) Pub. No.: US 2018/0357199 A1
(43) Pub. Date: Dec. 13, 2018

(54) SLAVE-TO-SLAVE COMMUNICATION IN I3C BUS TOPOLOGY

(71) Applicant: QUALCOMM Incorporated, San Diego, CA (US)

(72) Inventors: Lalan Jee MISHRA, San Diego, CA (US); Richard Dominic WIETFELDT, San Diego, CA (US); Radu PITIGOI-ARON, San Jose, CA (US)

(21) Appl. No.: 15/994,675

(22) Filed: May 31, 2018

Related U.S. Application Data
(60) Provisional application No. 62/518,564, filed on Jun. 12, 2017.
(60) Provisional application No. 62/554,399, filed on Sep. 5, 2017.
(60) Provisional application No. 62/568,302, filed on Oct. 4, 2017.

(51) Int. Cl. G06F 13/42; G06F 13/40; G06F 13/24

(52) U.S. Cl. CPC G06F 13/4282; G06F 2213/0016; G06F 13/24; G06F 13/4004

(57) ABSTRACT

Systems, methods, and apparatus for a slave-to-slave communication over a serial communication link are provided. An apparatus includes an interface adapted to couple the apparatus to a serial bus, and a processing circuit. The processing circuit may be configured to receive a request for a slave-to-slave transaction while servicing an in-band interrupt detected on a serial bus, the request for the slave-to-slave transaction indicating a source address and a target address, generate a first frame that includes the source address, the target address and a command code configured to initiate the slave-to-slave transaction between the source slave device and at least one target slave device, and initiate a data transfer on the serial bus between the source slave device and the at least one target slave device by transmitting the first frame on the serial bus.

### PRIORITY CLAIM

This application claims priority to and the benefit of provisional patent application No. 62/518,564 filed in the United States Patent Office on Jun. 12, 2017, provisional patent application No. 62/554,399 filed in the United States Patent Office on Sep. 5, 2017, and provisional patent application No. 62/568,302 filed in the United States Patent Office on Oct. 4, 2017, and the entire content of these applications is incorporated herein by reference as if fully set forth below in its entirety and for all applicable purposes.

### TECHNICAL FIELD

The present disclosure relates generally to serial communication and, more particularly, to facilitating slave-to-slave communication over a serial communication link.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a serial bus or a parallel bus. General-purpose serial interfaces known in the industry include the Inter-Integrated Circuit (I2C or I²C) serial bus and its derivatives and alternatives, including interfaces defined by the Mobile Industry Processor Interface (MIPI) Alliance, such as I3C and the Radio Frequency Front-End (RFFE) interface.

In one example, the I2C serial bus is a serial single-ended computer bus that was intended for use in connecting low-speed peripherals to a processor. Some interfaces provide multi-master buses in which two or more devices can serve as a bus master for different messages transmitted on the serial bus. In another example, the RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links.

General purpose input/output (GPIO) enables an integrated circuit designer to provide generic pins that may be customized for particular applications. For example, a GPIO pin is programmable to be either an output or an input pin depending upon a user's needs. A GPIO module or peripheral will typically control groups of pins which can vary based on the interface requirement. Because of the programmability of GPIO pins, they are commonly included in microprocessor and microcontroller applications. For example, an applications processor in mobile devices may use a number of GPIO pins to conduct handshake signaling such as inter-processor communication (IPC) with a modem processor.

In many instances, a number of command and control signals are employed to connect different component devices in mobile communication devices. These connections consume precious general-purpose input/output (GPIO) pins within the mobile communication devices and it would be desirable to replace the physical interconnects with signals carried in information transmitted over existing serial data links. However, the serial data links are associated with latencies that can prevent conversion of physical command and control signals to virtual signals, particularly in real-time embedded system applications supported by mobile communication devices that define firm transmission deadlines.

As mobile communication devices continue to include a greater level of functionality, improved serial communication techniques are needed to support low-latency transmissions between peripherals and application processors.

### SUMMARY

Certain aspects of the disclosure relate to systems, apparatus, methods and techniques that can communicate slave-to-slave communications over a data line.

In various aspects of the disclosure, a method for facilitating slave-to-slave communication is performed at a device coupled to a serial bus and includes receiving a request for a slave-to-slave transaction while servicing an in-band interrupt detected on a serial bus, the request for the slave-to-slave transaction indicating a source slave address and a target address, generating a first frame that indicates the source slave address and the target address and includes a command code configured to initiate the slave-to-slave transaction between the source slave device and at least one target slave device, and initiating a data transfer on the serial bus between the source slave device and the at least one target slave device by transmitting the first frame on the serial bus.

In one aspect, the target address is a broadcast address that is configured to cause a plurality of slave devices to receive payload data transmitted by the source slave device in the first frame.

In one aspect, a first indicator is provided in the source slave address to indicate that the data on the source slave device is to be read as a part of the first frame.

In certain aspects, the command code is configured to cause the source slave device to transmit a data payload as a part of the first frame. The command code may be further configured to cause the at least one target slave device to monitor the serial bus and receive the data payload.

In certain aspects, the indication of the source slave address and the command code are received while servicing the in-band interrupt in a second frame transmitted by an initiating slave device, and the first frame is transmitted in response to reception of the second frame. A target slave address may be provided in the second frame. The target slave address may identify the at least one target slave device. Data identifier information may be received in the second frame. A write command may be transmitted in the first frame, the write command being configured to cause the data identifier information to be written to the source slave device.

In one aspect, the first frame includes a data payload transmitted by the source slave device.

In one aspect, the command code comprises a broadcast command code that is configured to cause a plurality of slave devices to receive payload data transmitted by the source slave device in the first frame.

In one aspect, the source address or the target address identifies a bus master device.

In various aspects of the disclosure, an apparatus includes an interface adapted to couple the apparatus to a serial bus, and a processing circuit. The processing circuit may be configured to receive a request for a slave-to-slave transaction while servicing an in-band interrupt detected on a serial bus, the request for the slave-to-slave transaction indicating a source slave address and a target address, generate a first frame that indicates the source slave address and the target address and includes a command code configured to initiate the slave-to-slave transaction between the source slave device and at least one target slave device, and initiate a data transfer on the serial bus between the source slave device and the at least one target slave device by transmitting the first frame on the serial bus.

In one aspect, the target address is a broadcast address that is configured to cause a plurality of slave devices to receive payload data transmitted by the source slave device in the first frame.

In one aspect, a first indicator is provided in the source slave address to indicate that the data on the source slave device is to be read as a part of the first frame.

In certain aspects, the command code is configured to cause the source slave device to transmit a data payload as a part of the first frame. The command code may be further configured to cause the at least one target slave device to monitor the serial bus and receive the data payload.

In certain aspects, the indication of the source slave address and the command code are received while servicing the in-band interrupt in a second frame transmitted by an initiating slave device, and the first frame is transmitted in response to reception of the second frame. A target slave address may be provided in the second frame. The target slave address may identify the at least one target slave device. Data identifier information may be received in the second frame. A write command may be transmitted in the first frame, the write command being configured to cause the data identifier information to be written to the source slave device.

In various aspects of the disclosure, a method for slave-to-slave communication includes asserting in-band interrupt on a serial bus, transmitting a request for a slave-to-slave transaction while the in-band interrupt is serviced, the request for the slave-to-slave transaction indicating a source slave address and a target address, receiving a first frame that indicates the source slave address and the target address and includes a command code configured to initiate the slave-to-slave transaction between the source slave device and at least one target slave device, and participating in the slave-to-slave transaction as the source slave device or the target slave device.

In one aspect, the target address is a broadcast address and payload data transmitted by the source slave device is received as part of the first frame. In another aspect, the method includes transmitting a data payload as a part of the first frame.

In one aspect, the method includes transmitting an indication of the source slave address and the command code in a second frame while the in-band interrupt is serviced.

In one aspect, the command code is a broadcast command code that is configured to cause a plurality of slave devices to receive payload data transmitted by the source slave device in the first frame.

In one aspect, the source address or the target address identifies a bus master device.

In various aspects of the disclosure, a processor-readable storage medium having one or more instructions which, when executed by at least one processor of a processing circuit, cause the processing circuit to assert in-band interrupt on a serial bus, transmit a request for a slave-to-slave transaction while the in-band interrupt is serviced, the request for the slave-to-slave transaction indicating a source slave address and a target address, receive a first frame that indicates the source slave address and the target address and includes a command code configured to initiate the slave-to-slave transaction between the source slave device and at least one target slave device, and participate in the slave-to-slave transaction as the source slave device or the target slave device.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device that employs an RFFE bus to couple various radio frequency front-end devices.

FIG. 4 illustrates a device that employs an I3C bus to couple various front-end devices in accordance with certain aspects disclosed herein.

FIG. 5 illustrates an apparatus that includes an Application Processor and multiple peripheral devices that may be adapted according to certain aspects disclosed herein.

FIG. 6 illustrates an apparatus that has been adapted to support Virtual GPIO in accordance with certain aspects disclosed herein.

FIG. 7 illustrates examples of VGI broadcast frames according to certain aspects disclosed herein.

FIG. 8 illustrates examples of VGI directed frames according to certain aspects disclosed herein.

FIG. 9 illustrates configuration registers that may be associated with a physical pin according to certain aspects disclosed herein.

FIG. 10 is a diagram illustrating example VGI implementations according to certain aspects disclosed herein.

FIG. 11 illustrates a block diagram of an example general purpose input/output (GPIO) network.

FIG. 12 illustrates a block diagram of an example general purpose input/output (GPIO) network 1200 in accordance with various aspects of the disclosure.

FIG. 13 illustrates block level representations of a point-to-point slave-initiated slave-to-slave packet transfer and a point-to-multipoint (broadcast) slave-initiated slave-to-slave packet transfer.

FIG. 14 illustrates frame structures for a point-to-point slave-initiated slave-to-slave packet transfer in accordance with certain aspects disclosed herein.

FIG. 15 illustrates frame structures for a point-to-multipoint (broadcast) slave-initiated slave-to-slave packet transfer in accordance with certain aspects disclosed herein.

FIG. 16 illustrates frame structures for a point-to-point slave-initiated slave-to-slave packet transfer where a target slave monitors data line transactions in accordance with certain aspects disclosed herein.

FIG. 17 illustrates frame structures for a point-to-multipoint (broadcast) slave-initiated slave-to-slave packet transfer where target slaves monitor data line transactions in accordance with certain aspects disclosed herein.

FIG. 18 illustrates frame structures for a slave-initiated broadcast transfer in accordance with certain aspects disclosed herein.

FIG. 19 illustrates a frame structure for a master-initiated broadcast transfer in accordance with certain aspects disclosed herein.

FIG. 20 illustrates frame structures for a slave-initiated monitoring broadcast transfer in accordance with certain aspects disclosed herein.

FIG. 21 illustrates a frame structure for a master-initiated monitoring broadcast transfer in accordance with certain aspects disclosed herein.

FIG. 22 illustrates frame structures for a slave-initiated direct write transfer in accordance with certain aspects disclosed herein.

FIG. 23 illustrates a frame structure for a master-initiated direct write transfer in accordance with certain aspects disclosed herein.

FIG. 24 illustrates frame structures for a slave-initiated direct read transfer in accordance with certain aspects disclosed herein.

FIG. 25 illustrates a frame structure for a master-initiated direct read transfer in accordance with certain aspects disclosed herein.

FIG. 26 illustrates frame structures for a slave-initiated monitoring direct write transfer in accordance with certain aspects disclosed herein.

FIG. 27 illustrates a frame structure for a master-initiated monitoring direct write transfer in accordance with certain aspects disclosed herein.

FIG. 28 illustrates frames structures for a slave-initiated monitoring direct read transfer in accordance with certain aspects disclosed herein.

FIG. 29 is a frame structure for a master-initiated monitoring direct read transfer in accordance with certain aspects disclosed herein.

FIG. 30 illustrates an example of a slave-initiated transfer between two slave devices in accordance with certain aspects disclosed herein.

FIG. 31 illustrates a first example of transmissions corresponding to FIG. 30 in accordance with certain aspects disclosed herein.

FIG. 32 illustrates a second example of transmissions corresponding to FIG. 30 in accordance with certain aspects disclosed herein.

FIG. 33 illustrates an example of a slave-initiated broadcast transfer in accordance with certain aspects disclosed herein.

FIG. 34 illustrates a first example of transmissions corresponding to FIG. 33 in accordance with certain aspects disclosed herein.

FIG. 35 illustrates a second example of transmissions corresponding to FIG. 33 in accordance with certain aspects disclosed herein.

FIG. 36 illustrates an example of a master-initiated transfer between two slave devices in accordance with certain aspects disclosed herein.

FIG. 37 illustrates a first example of transmissions corresponding to FIG. 36 in accordance with certain aspects disclosed herein.

FIG. 38 illustrates a second example of transmissions corresponding to FIG. 36 in accordance with certain aspects disclosed herein.

FIG. 39 illustrates an example of a master-initiated broadcast transfer in accordance with certain aspects disclosed herein.

FIG. 40 illustrates a first example of transmissions corresponding to FIG. 39 in accordance with certain aspects disclosed herein.

FIG. 41 illustrates a second example of transmissions corresponding to FIG. 39 in accordance with certain aspects disclosed herein.

FIG. 42 illustrates an example of an apparatus employing a processing circuit that may be adapted according to certain aspects disclosed herein.

FIG. 43 is a first flowchart illustrating certain operations of an application processor adapted in accordance with certain aspects disclosed herein.

FIG. 44 is a second flowchart illustrating certain operations of an application processor adapted in accordance with certain aspects disclosed herein.

FIG. 45 is a third flowchart illustrating certain operations of an application processor adapted in accordance with certain aspects disclosed herein.

FIG. 46 illustrates a first example of a hardware implementation for an apparatus adapted in accordance with certain aspects disclosed herein.

FIG. 47 is a fourth flowchart illustrating certain operations of an application processor adapted in accordance with certain aspects disclosed herein.

FIG. 48 is a fifth flowchart illustrating certain operations of an application processor adapted in accordance with certain aspects disclosed herein.

FIG. 49 illustrates a second example of a hardware implementation for an apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

### Overview

Devices that include multiple SoC and other IC devices often employ a shared communication interface that may include a serial bus or other data communication link to connect processors with modems and other peripherals. The serial bus or other data communication link may be operated in accordance with multiple standards or protocols defined. In one example, a serial bus may be operated in accordance with I2C, I3C, and/or RFFE protocols. In certain applications, the serial bus may be used to carry high-priority, real-time messages that are transmitted with an expectation of low latency between sender and receiver. In some instances, the high-priority, real-time messages are generated at a first slave device and directed to a second slave device. In many serial bus architectures, a bus master initiates and/or controls all transactions conducted over the serial bus, and the involvement of a bus master in a slave-to-slave transaction can significantly increase latency associated with the serial bus. For example, in some systems, the bus master is required to read a slave device to determine availability of messages, read the messages and then transmit the messages to the destination slave device. In some applications, the requirement that a bus master determine need for slave-to-slave transactions prior to initiating slave-to-slave transactions can introduce unacceptable latency in the slave-to-slave transactions.

Certain aspects disclosed herein enable slave devices to initiate slave-to-slave transactions. In one example, slave-to-slave transactions may be used in reduced input/output (RIO) implementations where a serial bus may be used to exchange virtual GPIO state, changes in state and event and/or exception notifications that would otherwise be transmitted through physical GPIO pins. The signaling state of physical GPIO pins may be virtualized by representing physical GPIO state using one or more bits of data that can be transmitted in a virtual GPIO state payload over a data communication link Virtual GPIO state may be transmitted over a variety of communication links, including links that include wired and radio communication links. For example, virtual GPIO state can be packetized or otherwise formatted for transmission over a radio access network, such as a Bluetooth, WLAN, cellular and/or another network. Examples involving wired communication links are described herein to facilitate understanding of certain aspects.

In another example, slave-to-slave transactions may be used to enable RFFE devices to exchange high-priority, low-latency coexistence management information. Coexistence management information may be exchanged when the operation of certain RFFE devices can interfere and/or damage with other RFFE devices, and where two or more RFFE devices share or use common resources, such as an antenna, a low-noise amplifier, a power amplifier, a switch, etc. For example, an RF transmitter may transmit a coexistence message to signal a receiver that a high power transmission is imminent such that the receiver can disable or protect sensitive low-power amplifiers.

A number of different protocol schemes may be used for communicating messages and various types of data over communication links. Existing protocols have well-defined and immutable structures in the sense that their structures cannot be changed to optimize transmission latencies based on variations in use cases, and/or coexistence with other protocols, devices and applications. It is an imperative of real-time embedded systems that certain deadlines must be met. In certain real-time applications, meeting transmission deadlines is of paramount importance. When a common bus supports different protocols, it is generally difficult or impossible to guarantee optimal latency under all use cases. In some examples, an I2C, I3C, RFFE or SPMI serial communication bus may be used to tunnel different protocols with different latency requirements, different data transmission volumes and/or different transmission schedules.

Certain aspects disclosed herein relate to communication links, including implementations in which data is serialized and transmitted in accordance with one or more protocols. Data may be communicated in bits, bytes, characters and/or symbols that can be transmitted in signals transmitted over one or more wires. In a serial interface, for example, data may be serialized to obtain a sequential series of bits in a payload that can be transmitted with link management data that may identify, source, destination and/or nature of the data carried in the payload. Payload data transmitted in a signal over one or more wires of a serial link may be carried in groupings, including frames and/or transactions defined by a protocol. The protocol may prepend additional data to the payload including, for example, header data (e.g. Start bit or Start sequence), bus management data (e.g. identifiers for in-band-interrupts, bus handover, etc. The payload data may be referred to “application data” transmitted from a sender device to receiver device. For example, the payload data may include data generated by a sensor, controller, application, or other component and the payload data may be directed to a different sensor, controller, application, or other component. The payload data may be followed by error protection data (including parity or cyclic redundancy check bits, and terminating and/or footer data including Stop bits or a stop sequence. Management data may be referred to herein as control and command information transmitted to effect management of the bus. Management data may relate to functions such as bus arbitration, in-band-interrupts, as well as commands and signaling used to control modes of operation of the bus, selection of protocols, etc.

In the example of an I3C bus, management data includes Common Command Codes and bits, bytes or words identifying certain bus management functions. A transaction may include management and/or payload data bookended by a preceding Start bit and a terminating Stop bit. A transaction can include multiple frames, where a frame may be a sub-portion of the transaction. For example, payload data may be divided and carried over several frames. In some examples, a frame may include a packet or protocol unit that includes payload data encapsulated in protocol-specific management data, where a transmitting application encapsulates the payload data in management data and a receiving application strips the management data to obtain the payload data.

Certain aspects disclosed herein provide methods, circuits, and systems that are adapted to facilitate slave-to-slave communication over a serial link In certain implementations, an I3C single data rate (SDR) protocol serves as the default data transfer protocol used in slave-to-slave communication. A high data rate (HDR) protocol may be used for slave-to-slave communication, and entry to HDR modes may be effected prior to data transmission phases of a slave-to-slave transaction. In certain aspects, a slave-to-slave transaction may be initiated by a slave device using an in-band interrupt (IBI) request.

In one example, a single RIO command code is reserved in the MIPI Alliance I3C specification for use in defining a mode of slave-to-slave communication and a course of action to be adopted by each device involved in the slave-to-slave communication. The reserved RIO command code may be referred to herein as a Direct RIO command code. The character of data transmitted in a slave-to-slave transaction may be defined a priori. A slave-to-slave transaction may be initiated when a master device issues a Direct RIO command code. The Data transfer can be terminated early, using protocols defined in the MIPI Alliance I3C specification, for example.

Other types of payload, including coexistence management message payloads may be transmitted between slaves in accordance with certain aspects disclosed herein. The various features, concepts and techniques disclosed herein can be applied to multiple types of interface, including interfaces governed by I2C, I3C and RFFE protocols.

Examples of Apparatus that Employ Serial Communication Links

According to certain aspects, a serial communication link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similarly functioning device.

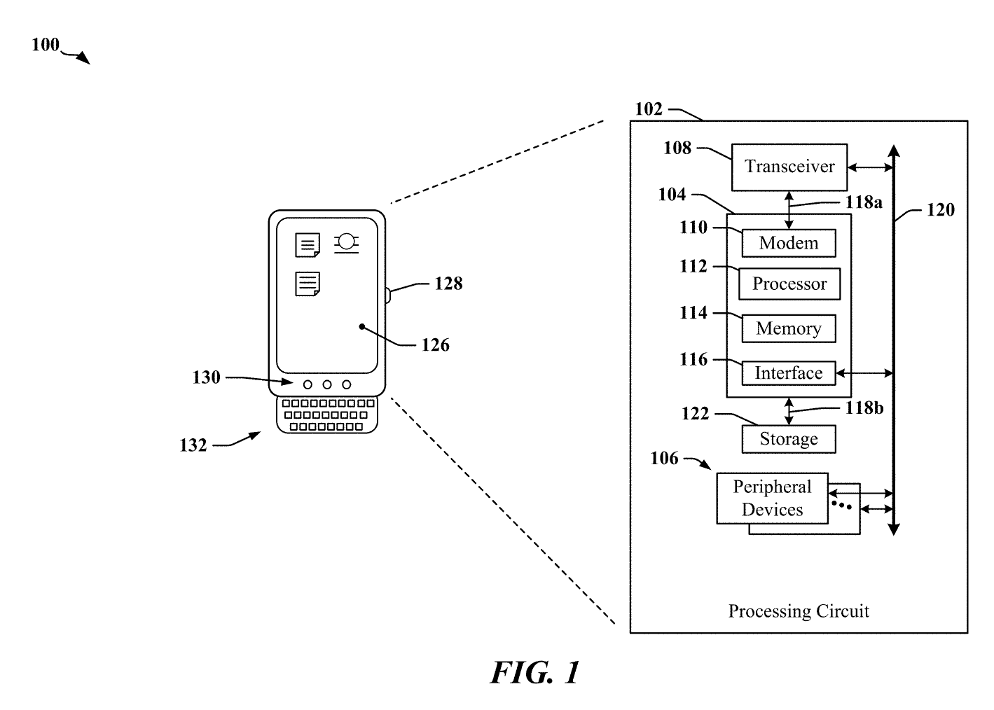

FIG. 1 illustrates an example of an apparatus 100 that may employ a serial communication bus. The apparatus 100 may include a processing circuit 102 having multiple circuits or devices 104, 106, and/or 108, which may be implemented in one or more application-specific integrated circuits (ASICs) or in an SoC. In one example, the apparatus 100 may be a communication device and the processing circuit 102 may include a processing device provided in an ASIC 104, one or more peripheral devices 106, and a transceiver 108 that enables the apparatus to communicate with a radio access network, a core access network, the Internet, and/or another network.

The ASIC 104 may have one or more processors 112, one or more modems 110, on-board memory 114, a bus interface circuit 116, and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as a display 126, operator controls, such as switches or buttons 128, 130, and/or an integrated or external keypad 132, among other components. A user interface module may be configured to operate with the display 126, keypad 132, etc. through a dedicated communication link or through one or more serial buses.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic, and other configurable circuits or modules. In one example, the bus interface circuit 116 may be configured to operate in accordance with communication specifications or protocols. The processing circuit 102 may include or control a power management function that configures and manages the operation of the apparatus 100.

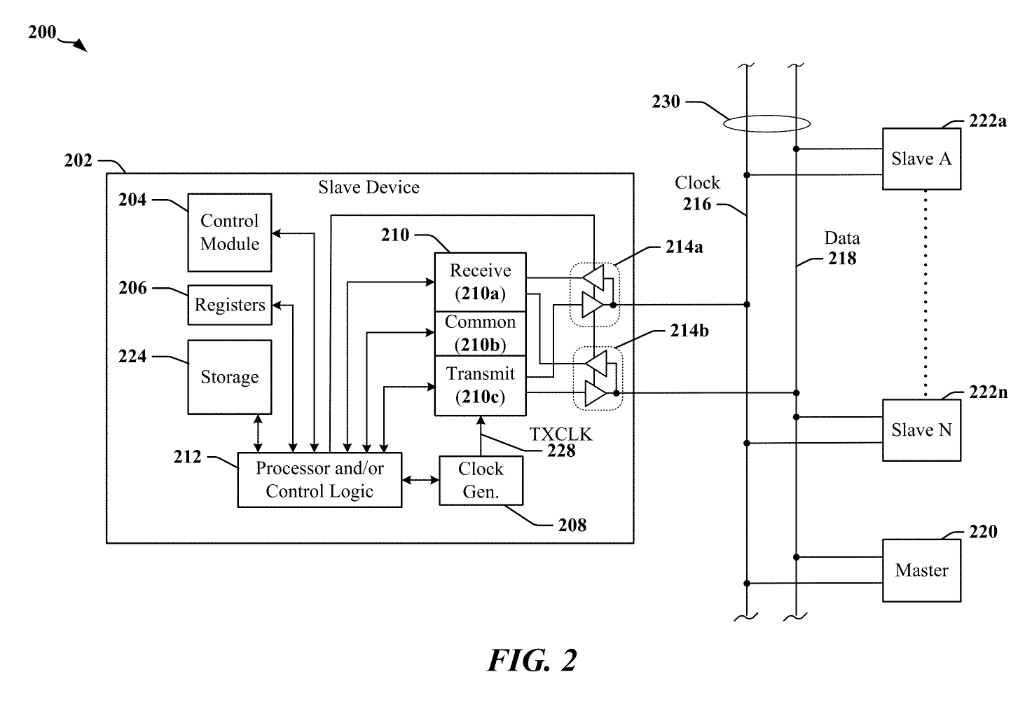

FIG. 2 illustrates certain aspects of an apparatus 200 that includes multiple devices 202, 220, and 222a-222n connected to a serial bus 230. The devices 202, 220, and 222a-222n may include one or more semiconductor IC devices, such as an applications processor, SoC or ASIC. Each of the devices 202, 220, and 222a-222n may include, support or operate as a modem, a signal processing device, a display driver, a camera, a user interface, a sensor, a sensor controller, a media player, a transceiver, and/or other such components or devices. Communications between devices 202, 220, and 222a-222n over the serial bus 230 are controlled by a bus master 220. Certain types of bus can support multiple bus masters 220.

The apparatus 200 may include multiple devices 202, 220, and 222a-222n that communicate when the serial bus 230 is operated in accordance with I2C, I3C, or other protocols. At least one device 202, 222a-222n may be configured to operate as a slave device on the serial bus 230. In one example, a slave device 202 may be adapted to provide a control function 204. In some examples, the control function 204 may include circuits and modules that support a display, an image sensor, and/or circuits and modules that control and communicate with one or more sensors that measure environmental conditions. The slave device 202 may include configuration registers 206 or other storage 224, control logic 212, a transceiver 210 and line drivers/receivers 214a and 214b. The control logic 212 may include a processing circuit such as a state machine, sequencer, signal processor, or general-purpose processor. The transceiver 210 may include a receiver 210a, a transmitter 210c, and common circuits 210b, including timing, logic, and storage circuits and/or devices. In one example, the transmitter 210c encodes and transmits data based on timing in one or more signals 228 provided by a clock generation circuit 208.

Two or more of the devices 202, 220, and/or 222a-222n may be adapted according to certain aspects and features disclosed herein to support a plurality of different communication protocols over a common bus, which may include an I2C, and/or I3C protocol. In some instances, devices that communicate using the I2C protocol can coexist on the same 2-wire interface with devices that communicate using I3C protocols. In one example, the I3C protocols may support a mode of operation that provides a data rate between 6 megabits per second (Mbps) and 16 Mbps with one or more optional high-data-rate (HDR) modes of operation that provide higher performance. The I2C protocols may conform to de facto I2C standards providing for data rates that may range between 100 kilobits per second (kbps) and 3.2 megabits per second (Mbps). I2C and I3C protocols may define electrical and timing aspects for signals transmitted on the 2-wire serial bus 230, in addition to data formats and aspects of bus control. In some aspects, the I2C and I3C protocols may define direct current (DC) characteristics affecting certain signal levels associated with the serial bus 230, and/or alternating current (AC) characteristics affecting certain timing aspects of signals transmitted on the serial bus 230. In some examples, a 2-wire serial bus 230 transmits data on a first wire 218 and a clock signal on a second wire 216. In some instances, data may be encoded in the signaling state, or transitions in signaling state of the first wire 218 and the second wire 216.

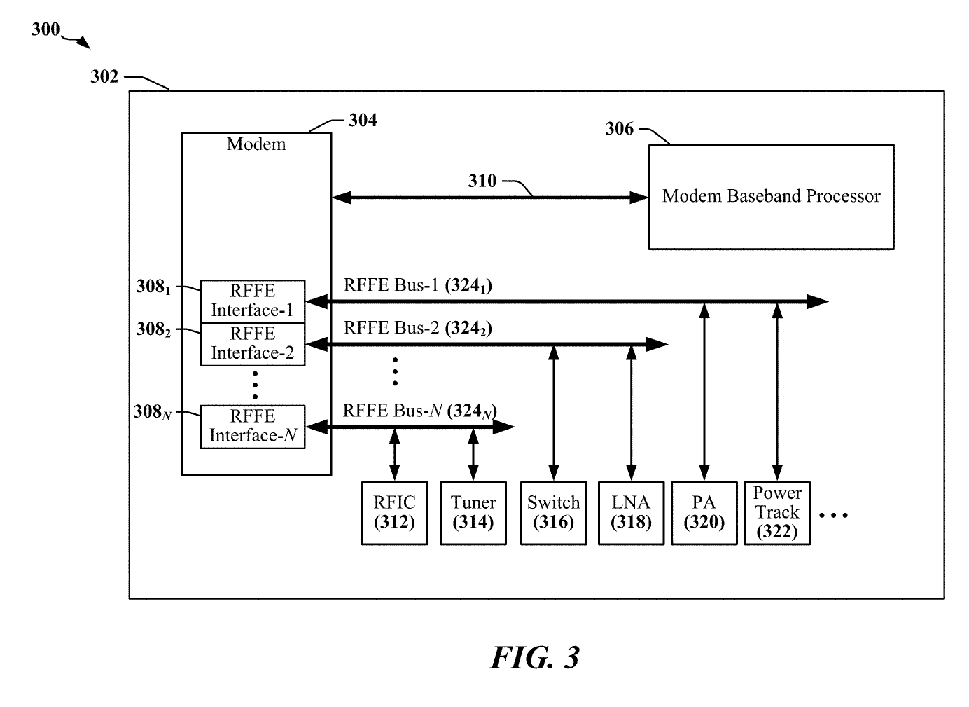

FIG. 3 illustrates a system 300 that includes a multiple RFFE buses 324₁-324_{N} provided in a chipset or device 302. The multiple RFFE buses 324₁-324_{N} may couple various combinations of front-end devices 312, 314, 316, 318, 320, 322 to a modem 304. The modem 304 may include one or more RFFE interfaces 308₁-308_{N}, each of which couples the modem 304 to a corresponding RFFE bus 324₁-324_{N}. The modem 304 may communicate with a baseband processor 306 through a separate, dedicated and/or shared communication link 310. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like. In various examples, the device 302 may be implemented with more than one baseband processors 306, modems 304, and/or other types of buses in addition to the communications links 310, 324₁-324_{N}. The device 302 may include other processors, circuits, controllers, state machines, modules and may be configured for various operations and/or different functionalities.

In the example illustrated in FIG. 3, one RFFE bus 324_{N} is coupled to an RF integrated circuit (RFIC 312) and an RF tuner 314. The RFIC 312 may include one or more controllers, state machines and/or processors that configure and control certain aspects of the RF front-end. Another RFFE bus 324₂ may couple the modem 304 to a switch 316 and an LNA 318. The LNA 318 may be a radio frequency amplifier that is provided noise amplifier (LNA) to increase signal strength of RF signals before to improve receiver sensitivity and/or to compensate for loss attributable to the signal path between antenna and receiver. Another RFFE bus 324₁ may couple the modem 304 to a power amplifier (PA 320) and a power tracking module 322. Other types of devices may be coupled by one or more of the RFFE buses 324₁-324_{N}, and other assignments and allocations of devices 312, 314, 316, 318, 320, 322 to RFFE buses 324₁-324_{N} may be configured according to application needs.

The system 300 may include multiple instances of certain device types (e.g. switch 316, LNA 318, PA 320 and other types of device) that may operate concurrently in a manner that can generate inter-device interference, or that could potentially cause damage to one or more devices. Devices that may be interfere with one another may exchange coexistence management (CxM) messages to permit each device to signal imminent actions that may result in interference or conflict. CxM messages may be used to manage operation of shared components including a switch 316, an LNA 318, a PA 320 and/or an antenna. CxM messages are typically high-priority, real time messages that are intended for transmission with minimum latency.

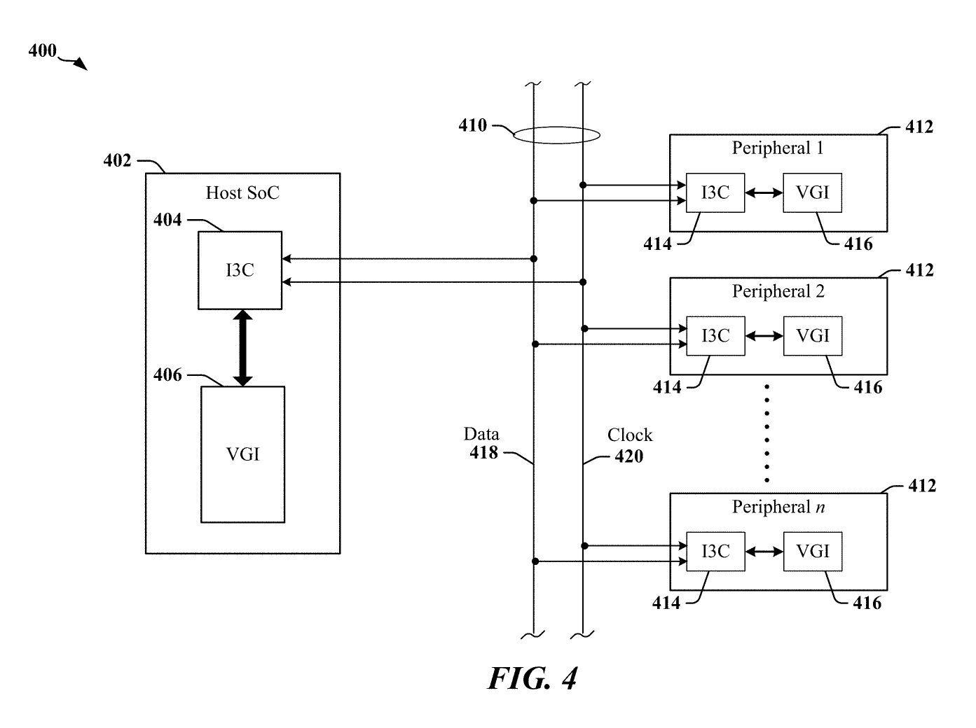

FIG. 4 illustrates an example of an apparatus 400 that uses an I3C bus to couple various devices including a host SoC 402 and a number of peripheral devices 412. The host SoC 402 may include a virtual GPIO finite state machine (VGI FSM 406) and an I3C interface 404, where the I3C interface 404 cooperates with corresponding I3C interfaces 414 in the peripheral devices 412 to provide a communication link between the host SoC 402 and the peripheral devices 412. Each peripheral device 412 includes a VGI FSM 416. In the illustrated example, communications between the SoC 402 and a peripheral device 412 may be serialized and transmitted over a multi-wire serial bus 410 in accordance with an I3C protocol. In other examples, the host SoC 402 may include other types of interface, including I2C and/or RFFE interfaces. In other examples, the host SoC 402 may include a configurable interface that may be employed to communicate using I2C, I3C, RFFE and/or another suitable protocol. In some examples, a multi-wire serial bus 410, such as an I2C or I3C bus, may transmit a data signal over a data wire 418 and a clock signal over a clock wire 420.

### Signaling Virtual GPIO Information

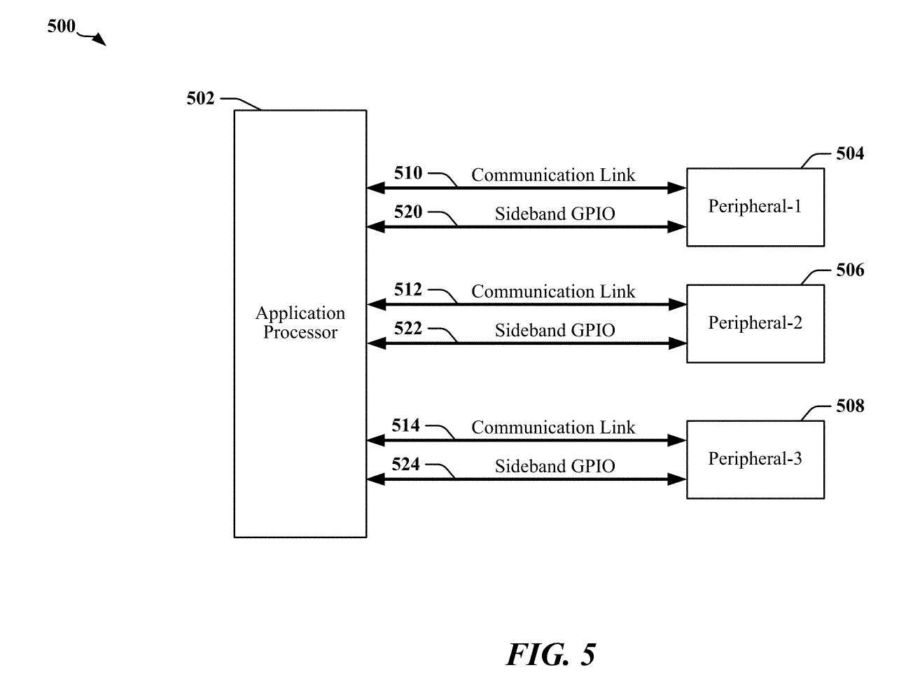

Mobile communication devices, and other devices that are related or connected to mobile communication devices, increasingly provide greater capabilities, performance and functionalities. In many instances, a mobile communication device incorporates multiple IC devices that are connected using a variety of communications links FIG. 5 illustrates an apparatus 500 that includes an Application Processor 502 and multiple peripheral devices 504, 506, 508. In the example, each peripheral device 504, 506, 508 communicates with the Application Processor 502 over a respective communication link 510, 512, 514 operated in accordance with mutually different protocols. Communication between the Application Processor 502 and each peripheral device 504, 506, 508 may involve additional wires that carry control or command signals between the Application Processor 502 and the peripheral devices 504, 506, 508. These additional wires may be referred to as sideband general purpose input/output (sideband GPIO 520, 522, 524), and in some instances the number of connections needed for sideband GPIO 520, 522, 524 can exceed the number of connections used for a communication link 510, 512, 514.

GPIO provides generic pins/connections that may be customized for particular applications. For example, a GPIO pin may be programmable to function as an output, input pin or a bidirectional pin, in accordance with application needs. In one example, the Application Processor 502 may assign and/or configure a number of GPIO pins to conduct handshake signaling or inter-processor communication (IPC) with a peripheral device 504, 506, 508 such as a modem. When handshake signaling is used, sideband signaling may be symmetric, where signaling is transmitted and received by the Application Processor 502 and a peripheral device 504, 506, 508. With increased device complexity, the increased number of GPIO pins used for IPC communication may significantly increase manufacturing cost and limit GPIO availability for other system-level peripheral interfaces.

According to certain aspects, the state of GPIO, including GPIO associated with a communication link, may be captured, packetized, serialized and transmitted over a communication link In one example, captured GPIO may be transmitted over an I3C bus using command codes to indicate that an I3C transaction includes packetized GPIO information and/or destination.

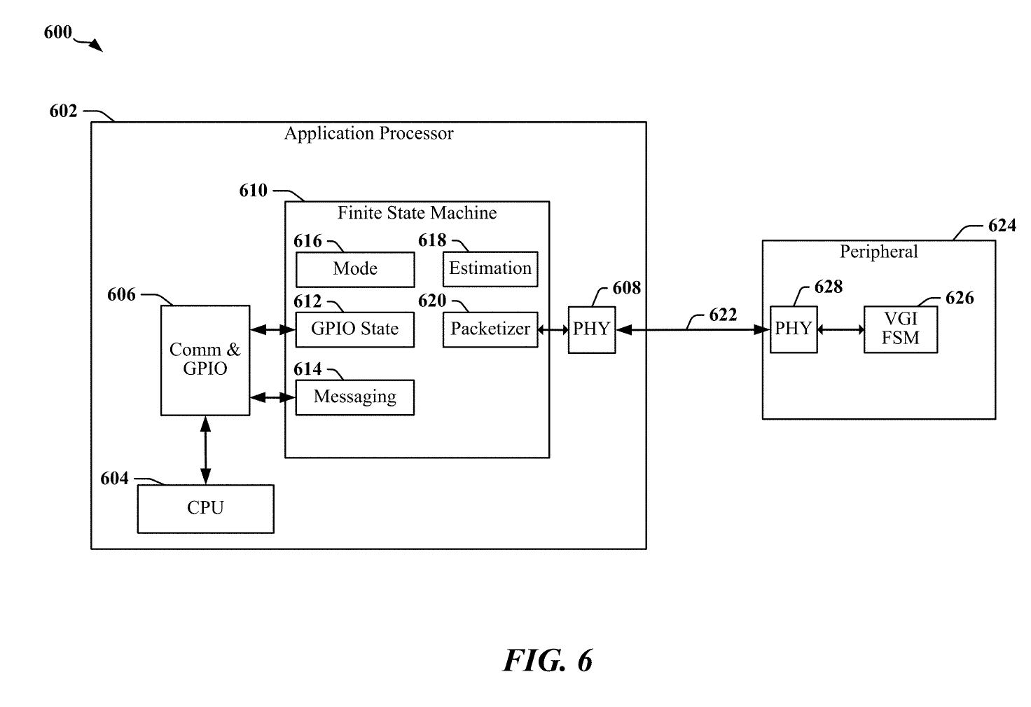

FIG. 6 illustrates an apparatus 600 that is adapted to support Virtual GPIO (VGI or VGMI) in accordance with certain aspects disclosed herein. VGI circuits and techniques can reduce the number of physical pins and connections used to connect an Application Processor 602 with a peripheral device 624. VGI enables a plurality of GPIO signals to be serialized into virtual GPIO signals that can be transmitted over a communication link 622. In one example, virtual GPIO signals may be encoded in packets that are transmitted over a communication link 622 that includes a multi-wire bus, including a serial bus. When the communication link 622 is provided as serial bus, the receiving peripheral device 624 may deserialize received packets and may extract messages and virtual GPIO signals. A VGI FSM 626 in the peripheral device 624 may convert the virtual GPIO signals to physical GPIO signals that can be presented at an internal GPIO interface.

In another example, the communication link 622 may be a provided by a radio frequency transceiver that supports communication using, for example, a Bluetooth protocol, a WLAN protocol, a cellular wide area network, and/or another communication protocol. Messages and virtual GPIO signals may be encoded in packets, frames, subframes, transactions, or other data structures that can be transmitted over the communication link 622, and the receiving peripheral device 624 may extract, deserialize and otherwise process received signaling to obtain the messages and virtual GPIO signals. Upon receipt of messages and/or virtual GPIO signals, the VGI FSM 626 or another component of the receiving device may interrupt its host processor to indicate receipt of messages and/or any changes in GPIO signals.

In an example in which the communication link 622 is provided as a serial bus, messages and/or virtual GPIO signals may be transmitted as payload data in transactions configured for an I2C, I3C, RFFE, or another standardized serial interface. In the illustrated example, VGI techniques are employed to accommodate I/O bridging between an Application Processor 602 and a peripheral device 624. The Application Processor 602 may be implemented as an ASIC, SoC, or some combination of devices. The Application Processor 602 includes a processor (central processing unit or CPU 604) that generates messages and GPIO associated with one or more communications channels 606. GPIO signals and messages produced by the communications channels 606 may be monitored by respective monitoring circuits 612, 614 in a VGI FSM 626. In some examples, a GPIO monitoring circuit 612 may be adapted to produce virtual GPIO signals representative of the state of physical GPIO signals and/or changes in the state of the physical GPIO signals. In some examples, other circuits are provided to produce the virtual GPIO signals representative of the state of physical GPIO signals and/or changes in the state of the physical GPIO signals.

An estimation circuit 618 may be configured to estimate latency information for the GPIO signals and messages, and may select a protocol, and/or a mode of communication for the communication link 622 that optimizes the latency for encoding and transmitting the GPIO signals and messages. The estimation circuit 618 may maintain protocol and mode information 616 that characterizes certain aspects of the communication link 622 to be considered when selecting the protocol, and/or a mode of communication. The estimation circuit 618 may be further configured to select a packet type for encoding and transmitting the GPIO signals and messages. The estimation circuit 618 may provide configuration information used by a packetizer 620 to encode the GPIO signals and messages. In one example, the configuration information is provided as a command that may be encapsulated in a packet such that the type of packet can be determined at a receiver. The configuration information, which may be a command, may also be provided to physical layer circuits (PHY 608). The PHY 608 may use the configuration information to select a protocol and/or mode of communication for transmitting the associated packet. The PHY 608 may then generate the appropriate signaling to transmit the packet.

The peripheral device 624 may include a VGI FSM 626 that may be configured to process data packets received from the communication link 622. The VGI FSM 626 at the peripheral device 624 may extract messages and may map bit positions in virtual GPIO signals onto physical GPIO pins in the peripheral device 624. In certain embodiments, the communication link 622 is bidirectional, and both the Application Processor 602 and a peripheral device 624 may operate as both transmitter and receiver.

The PHY 608 in the Application Processor 602 and a corresponding PHY 628 in the peripheral device 624 may be configured to establish and operate the communication link 622. The PHY 608 and 628 may be coupled to, or include a transceiver 108 (see FIG. 1). In some examples, the PHY 608 and 628 may support a two-wire interface such as an I2C, I3C, RFFE, or SMBus interface at the Application Processor 602 and peripheral device 624, respectively, and virtual GPIO signals and messages may be encapsulated into a packet transmitted over the communication link 622, which may be a multi-wire serial bus or multi-wire parallel bus for example.

VGI tunneling, as described herein, can be implemented using existing or available protocols configured for operating the communication link 622, and without the full complement of physical GPIO pins. VGI FSMs 610, 626 may handle GPIO signaling without intervention of a processor in the Application Processor 602 and/or in the peripheral device 624. The use of VGI can reduce pin count, power consumption, and latency associated with the communication link 622.

At the receiving device, virtual GPIO signals are converted into physical GPIO signals. Certain characteristics of the physical GPIO pins may be configured using the virtual GPIO signals. For example, slew rate, polarity, drive strength, and other related parameters and attributes of the physical GPIO pins may be configured using the virtual GPIO signals. Configuration parameters used to configure the physical GPIO pins may be stored in configuration registers associated with corresponding GPIO pins. These configuration parameters can be addressed using a proprietary or conventional protocol such as I2C, I3C or RFFE. In one example, configuration parameters may be maintained in I3C addressable registers. Certain aspects disclosed herein relate to reducing latencies associated with the transmission of configuration parameters and corresponding addresses (e.g., addresses of registers used to store configuration parameters).

The VGI interface enables transmission of messages and virtual GPIO signals, whereby virtual GPIO signals, messages, or both can be sent as a serial data stream over a communication link 622. In one example, a serial data stream may be packetized for transmission over an I2C, I3C, or RFFE, bus in a transaction, which may include a sequence of frames. The presence of virtual GPIO data in an I2C/I3C frame may be signaled using a special command code to identify the frame as a VGPIO frame. VGPIO frames may be transmitted as broadcast frames or addressed frames in accordance with an I2C or I3C protocol. In some implementations, a serial data stream may be transmitted in a form that resembles a universal asynchronous receiver/transmitter (UART) signaling and messaging protocol, in what may be referred to as a UART_VGI mode of operation. This may also be referred to as a VGI messaging interface or VGMI.

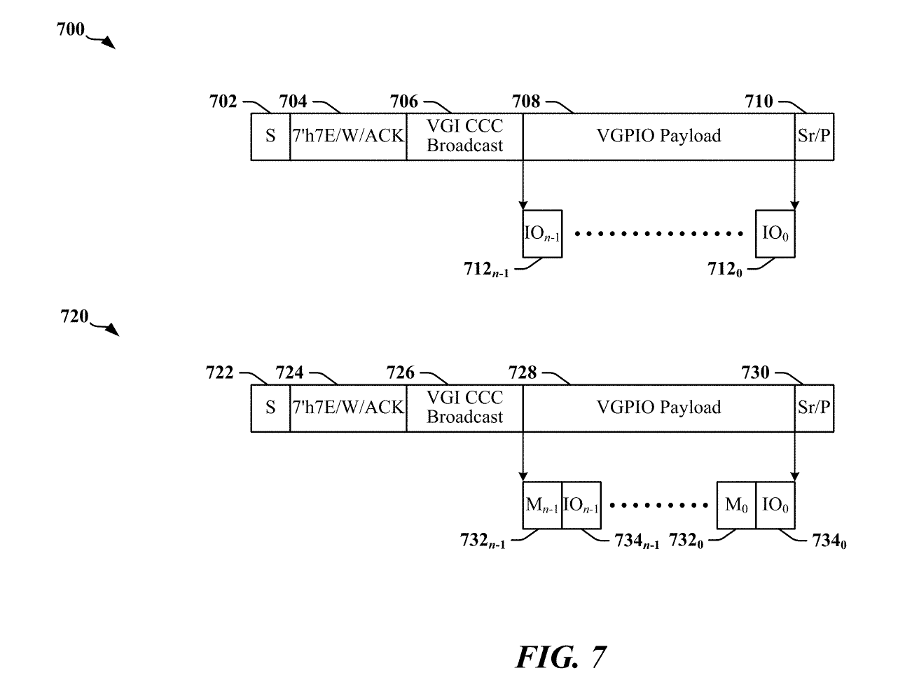

FIG. 7 illustrates examples of VGI broadcast frames 700, 720. In a first example, a broadcast frame 700 commences with a start bit 702 (S) followed by a header 704 in accordance with an I2C or I3C protocol. A VGI broadcast frame may be identified using a VGI broadcast command code 706. A VGPIO payload 708 includes a number (n) of virtual GPIO signals 712₀-712ₙ₋₁, ranging from a first virtual GPIO signal 712₀ to an nth virtual GPIO signal 712ₙ₋₁. A VGI FSM may include a mapping table that maps bit positions of virtual GPIO signals in a VGPIO payload 708 to conventional GPIO pins. The virtual nature of the signaling in the VGPIO payload 708 can be transparent to processors in the transmitting and receiving devices.

In the second example, a masked VGI broadcast frame 720 may be transmitted by a host device to change the state of one or more GPIO pins without disturbing the state of other GPIO pins. In this example, the I/O signals for one or more devices are masked, while the I/O signals in a targeted device are unmasked. The masked VGI broadcast frame 720 commences with a start bit 722 followed by a header 724. A masked VGI broadcast frame 720 may be identified using a masked VGI broadcast command code 726. The VGPIO payload 728 may include I/O signal values 734₀-734ₙ₋₁ and corresponding mask bits 732₀-732ₙ₋₁, ranging from a first mask bit M₀ 732₀ for the first I/O signal (I0₀) to an nth mask bit M_{n-1 7}32ₙ₋₁ for the nth I/O signal IOₙ₋₁.

A stop bit or synchronization bit (Sr/P 710, 730) terminates the VGI broadcast frame 700, 720. A synchronization bit may be transmitted to indicate that an additional VGPIO payload is to be transmitted. In one example, the synchronization bit may be a repeated start bit in an I2C interface.

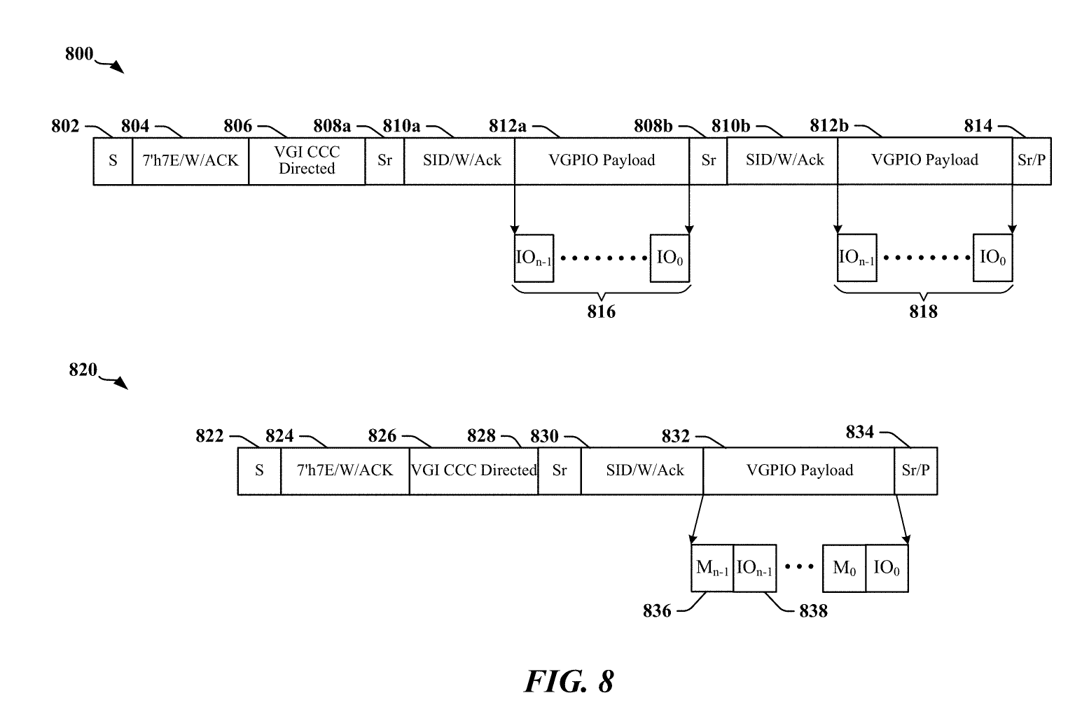

FIG. 8 illustrates examples of VGI directed frames 800, 820. In a first example, VGI directed frames 800 may be addressed to a single peripheral device or, in some instances, to a group of peripheral devices. The first of the VGI directed frames 800 commences with a start bit 802 (S) followed by a header 804 in accordance with an I2C or I3C protocol. A VGI directed frame 800 may be identified using a VGI directed command code 806. The directed command code 806 may be followed by a synchronization field 808a (Sr) and an address field 810a that includes a slave identifier to select the addressed device. The directed VGPIO payload 812a that follows the address field 810a includes values 816 for a set of I/O signals that pertain to the addressed device. VGI directed frames 800 can include additional directed VGPIO payloads 812b for additional devices. For example, the first directed VGPIO payload 812a may be followed by a synchronization field 808b and a second address field 810b. In this example, the second directed VGPIO payload 812b includes values 818 for a set of I/O signals that pertain to a second addressed device. The use of VGI directed frames 800 may permit transmission of values for a subset or portion of the I/O signals carried in a VGI broadcast frame 700, 720.

In the second example, a masked VGI directed frame 820 may be transmitted by a host device to change the state of one or more GPIO pins without disturbing the state of other GPIO pins in a single peripheral device and without affecting other peripheral devices. In some examples, the I/O signals in one or more devices may be masked, while selected I/O signals in one or more targeted device are unmasked. The masked VGI directed frame 820 commences with a start bit 822 followed by a header 824. A masked VGI directed frame 820 may be identified using a masked VGI directed command code 826. The masked VGI directed command code 826 may be followed by a synchronization field 828 (Sr) and an address field 830 that includes a slave identifier to select the addressed device. The directed payload 832 that follows includes VGPIO values for a set of I/O signals that pertain to the addressed device. For example, the VGPIO values in the directed payload 832 may include I/O signal values 838 and corresponding mask bits 836.

A stop bit or synchronization bit (Sr/P 814, 834) terminates the VGI directed frames 800, 820. A synchronization bit may be transmitted to indicate that an additional VGPIO payload is to be transmitted. In one example, the synchronization bit may be a repeated start bit in an I2C interface.

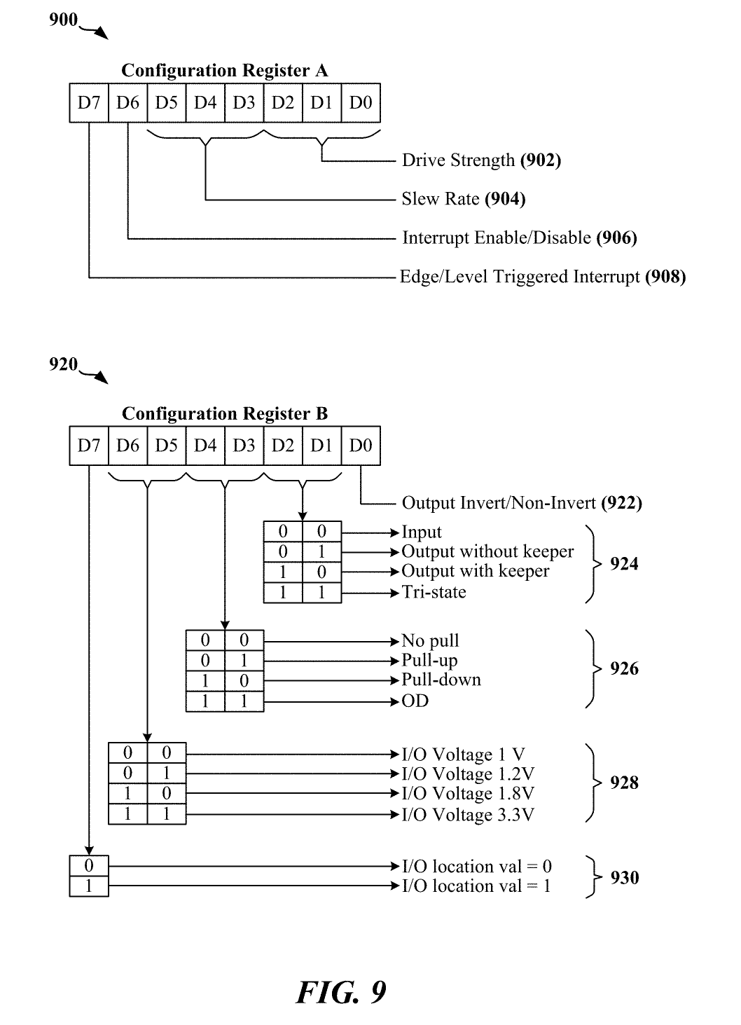

At the receiving device (e.g., the Application Processor 502 and/or peripheral device 504, 506, 508), received virtual GPIO signals are expanded into physical GPIO signal states presented on GPIO pins. The term “pin,” as used herein, may refer to a physical structure such as a pad, pin or other interconnecting element used to couple an IC to a wire, trace, through-hole via, or other suitable physical connector provided on a circuit board, substrate or the like. Each GPIO pin may be associated with one or more configuration registers that store configuration parameters for the GPIO pin. FIG. 9 illustrates configuration registers 900 and 920 that may be associated with a physical pin. Each configuration register 900, 920 is implemented as a one-byte (8 bits) register, where different bits or groups of bits define a characteristic or other features that can be controlled through configuration. In a first example, bits D0-D2 902 control the drive strength for the GPIO pin, bits D3-D5 904 control the slew rate for GPIO pin, bit D6 906 enables interrupts, and bit D7 908 determines whether interrupts are edge-triggered or triggered by voltage-level. In a second example, bit D0 922 selects whether the GPIO pin receives an inverted or non-inverted signal, bits D1-D2 924 define a type of input or output pin, bits D3-D4 926 defines certain characteristics of an undriven pin, bits D5-D6 928 define voltage levels for signaling states, and bit D7 930 controls the binary value for the GPIO pin (i.e., whether GPIO pin carries carry a binary one or zero).

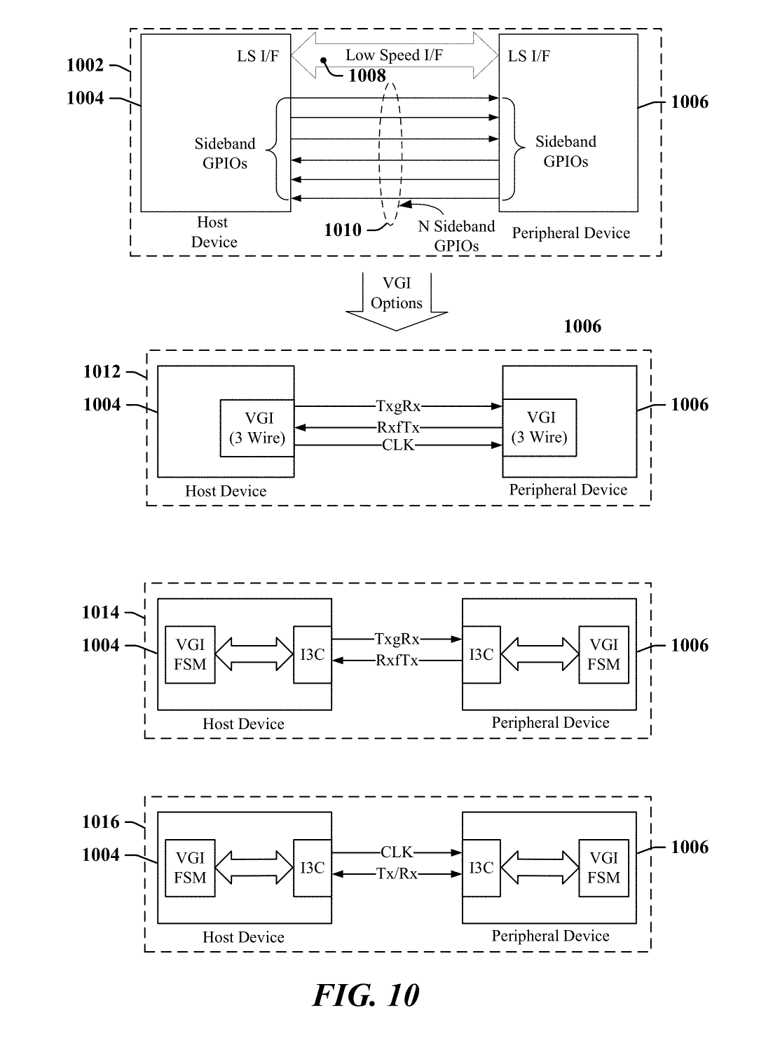

FIG. 10 is a diagram illustrating example VGI implementations. FIG. 10 shows an example configuration 1002 that includes a host device 1004 (e.g., host SoC) coupled to a peripheral device 1006. The host device 1004 and the peripheral device 1006 may transfer signals through a low speed (LS) interface (I/F) 1008 and may transfer an N number of sideband GPIOs 1010. In a first example VGI implementation, as shown in the configuration 1012, a host device and a peripheral device are coupled using a three-wire synchronous full-duplex VGI implementation. In a second example VGI implementation, as shown in the configuration 1014, a host device and a peripheral device are coupled using a two-wire asynchronous full-duplex VGI implementation. In the configuration 1014, the host device and the peripheral device each include a VGI FSM that can make use of a generic physical link, such as an I3C physical link. The configuration 1014 may enable NRZ messaging (UART), embedded GPIOs/interrupts, and/or in-band flow-control. In a third example VGI implementation, as shown in the configuration 1016, a host device and a peripheral device are coupled using a two-wire synchronous half-duplex VGI implementation. In the configuration 1016, the host device and the peripheral device each include a VGI FSM that can make use of a generic physical link, such as an I3C physical link.

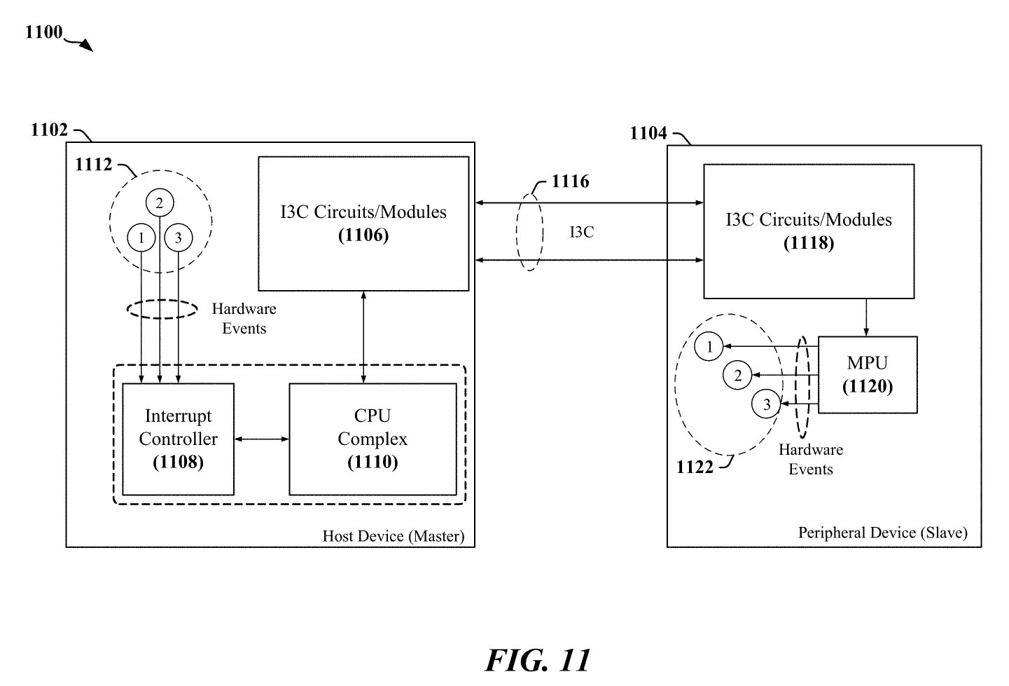

FIG. 11 illustrates a block diagram of an example general purpose input/output (GPIO) network 1100. The GPIO network 1100 includes a host device 1102 and a peripheral device 1104. As shown in FIG. 11, the host device 1102 is in communication with the peripheral device 1104 via the I3C bus 1116. For example, the I3C bus 1116 may be a two-wire bus that includes a lead for a data signal and a lead for a clock signal. In the configuration of FIG. 11, hardware events (e.g., labeled as “1”, “2”, and “3” in the region 1112) originating in the host device 1102 may be received by the interrupt controller 1108. For example, the hardware events may be internal hardware events (e.g., internal register accessible bits). In other aspects, external hardware events (e.g., externally accessible pins) are possible. The interrupt controller 1108 may communicate the hardware events to the CPU complex 1110 so that the CPU complex 1110 may generate register-mapped I3C packets for transmission to the peripheral device 1104.

For example, such register-mapped I3C packets may be transmitted to the peripheral device 1104 via the I3C IP block 1106 of the host device 1102 and the I3C bus 1116. The peripheral device 1104 may receive the register-mapped I3C packets at the I3C IP block 1118, which may provide the register-mapped I3C packets to the MPU 1120. The MPU 1120 may then identify the hardware events (e.g., labeled as “1”, “2”, and “3” in the region 1122).

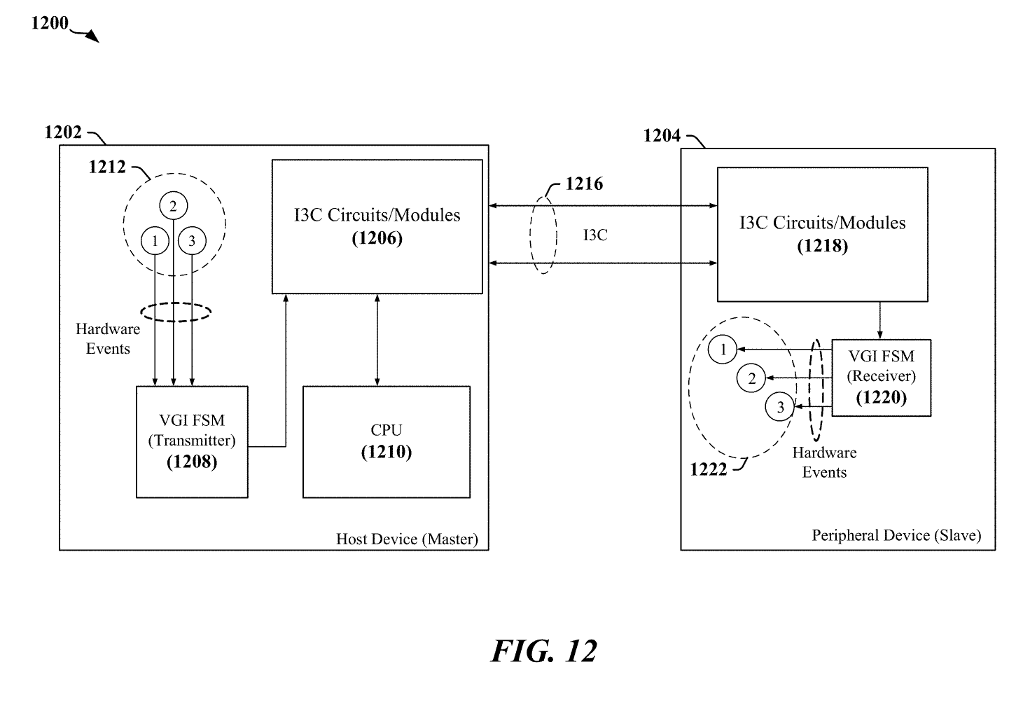

FIG. 12 illustrates a block diagram of an example general purpose input/output (GPIO) network 1200 in accordance with various aspects of the disclosure. The GPIO network 1200 includes a host device 1202 and a peripheral device 1204. As shown in FIG. 12, the host device 1202 is in communication with the peripheral device 1204 via the I3C bus 1216. In the configuration of FIG. 12, hardware events (e.g., labeled as “1”, “2”, and “3” in the region 1212) originating in the host device 1202 may be received by the VGI FSM 1208. For example, the hardware events may be internal hardware events (e.g., internal register accessible bits). In other aspects, external hardware events (e.g., externally accessible pins) are possible. The VGI FSM 1208 may generate VGI packets that include the hardware events for transmission to the peripheral device 1204. For example, such VGI packets may be transmitted to the peripheral device 1204 via the I3C IP block 1206 of the host device 1202 and the I3C bus 1216. The peripheral device 1204 may receive the VGI packets at the I3C IP block 1218, which may provide the VGI packets to the VGI FSM 1220. The VGI FSM 1220 may then identify the hardware events (e.g., labeled as “1”, “2”, and “3” in the region 1222). It should be noted that in the configuration of FIG. 12, the VGI FSM 1208 may generate and transmit the VGI packets without involvement (e.g., without waking up to generate VGI packets) of the CPU 1210 in the host device 1202, whereas the configuration of FIG. 11 requires involvement (e.g., waking up to generate VGI packets) of the CPU 1210 in the host device 1202 to generate and transmit the VGI packets.

While the VGI protocol and the VGI over I3C protocol may enable I/O state transfer features in masked and non-masked modes using directed and broadcast configurations, the aspects described herein include approaches for transmitting electrical configurations for an I/O pin (such as drive strength, polarity, slew rate etc.). As discussed herein, various I/O configuration protocols for mapped I/Os may be implemented to ensure the availability of a packet structure providing the least latency with respect to a given use case. In one aspect, and as described herein, separate configuration and event messages may be implemented. In other aspects, a merged message that includes both configuration signals and event signals may be implemented. For example, the separate message protocol may be implemented in situations where I/O electrical configuration is required infrequently. In another example, the merged message protocol may be implemented in situations where I/O electrical configurations are desired on a frequent basis. While the separate message protocol may provide significant reduction in I/O transfer latency in most cases, the merged protocol may reduce latency when frequent I/O configuration changes are required.

### Slave Initiated Slave-to-Slave Communication in Serial Bus Topology

In certain aspects, VGI integration with I3C (I3C_VGI) enables a hardware event-state exchange between a current master and one or more slaves. An I3C master can start communication with any slave. However, conventional I3C protocol frameworks do not permit a direct slave-to-slave hardware event-state exchange. That is, slaves do not have the ability to start an interrupt cycle in order to directly transmit information to the master or to another slave. In order for a slave to transmit information on the bus, the slave must first acquire bus-owner or bus-master status. However, not all I3C slaves have the ability to become a secondary bus-owner/bus-master, and slave-initiated slave-to-slave communication is typically not possible under such circumstances.

Certain aspects disclosed herein support use cases for I3C_VGI requiring a first slave device to be able to communicate with a second slave device including when the first slave device is not the bus-owner and/or is not configurable for operating as a bus master. In various examples, complex systems include peripheral devices that are required to have a GPIO pin for connection to another peripheral device, where the GPIO connected peripheral devices are not bus masters. According to certain aspects, signals may be exchanged between peripherals using a serial bus to carry VGI information between peer slave devices when an initiating slave device is not the bus-owner and/or is not operating as a bus master in an I3C_VGI architecture.

In an aspect of the disclosure, a command code may be used to indicate whether a slave intends to transmit data to, or have a communication exchange with, another slave on the bus. Various descriptions in this disclosure may relate to the example of an I3C bus. When a serial bus used for communication complies with, or is compatible with I3C protocols, command codes may be employed that have a direct or indirect correspondence to Common Command Codes (CCCs) defined by the I3C protocols. When other bus protocols are used, command codes defined by such bus protocols may be employed. In some implementations a designer may define CCCs that can be used on a bus, including a bus that is operated in accordance with certain standardized protocols. In this disclosure, the term CCC may be used to refer to I3C Common Command Codes, command codes defined for RFFE and other command codes.

In certain descriptions provided in this disclosure, an IBI feature defined by I3C standards may be harnessed by a slave to communicate an I3C_VGI CCC that is defined to enable slave-initiated slave-to-slave communications.

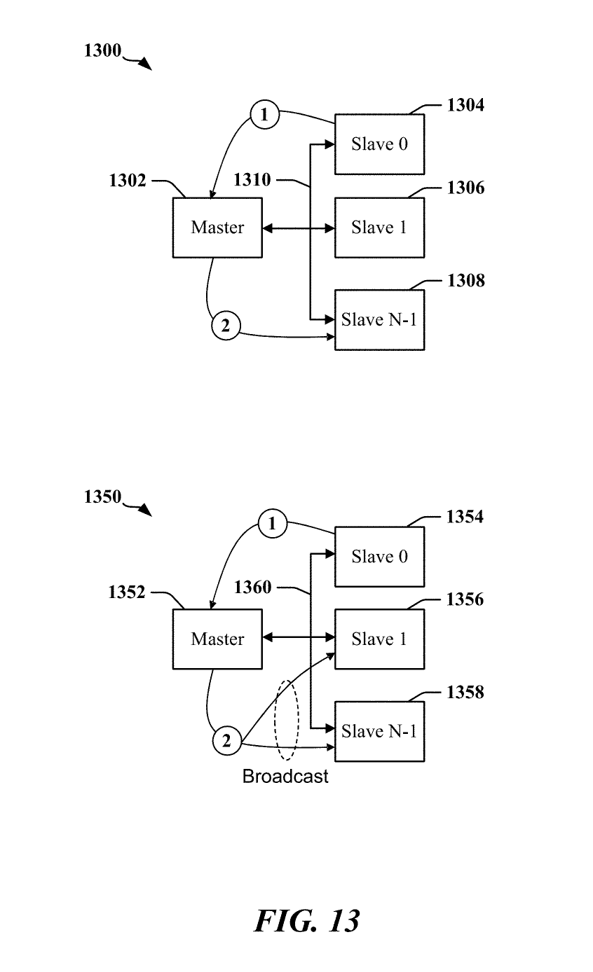

FIG. 13 illustrates slave-to-slave transfers, including block level representations of a slave-initiated point-to-point transfer 1300, and a point-to-multipoint (broadcast) slave-initiated transfer 1350. In the point-to-point transfer 1300, a source slave 1304 may initiate a slave-to-slave transfer to one other slave 1306 or 1308 over a bus 1310. A bus master 1302 acts as a bridge between the two slaves 1304, 1306/1308 permitting the packet transfer to take place. In the point-to-multipoint slave-initiated transfer 1350, a source slave 1354 may initiate a slave-to-multi-slave packet transfer (broadcast packet transfer) to two or more slaves 1356 and 1358 on the bus. Here, a bus master 1352 acts as a bridge between the source slave 1354 and the two or more slaves 1356 and 1358 permitting the broadcast transfer to take place.

In an aspect of the disclosure, a transaction on an I3C bus may include an I3C_VGI CCC transmitted to indicate a slave-to-slave communication (slave-to-slave CCC). The transaction may be originated by a source slave 1304, 1354 as part of an IBI. The transaction may further include a target slave address and a payload including a bit stream representing data (e.g., hardware event status) to be received by the target slave 1306, 1308, 1356 and/or 1358. The CCC may indicate a single target slave 1306 or 1308, 1356 or 1358 or a broadcast ID identifying a target group of slaves 1306 and 1308, 1356 and 1358.

When a bus master 1302, 1352 detects the specific CCC, the bus master 1302, 1352 may determine that the incoming bit stream, which may include hardware event status bits, are not for internal use by the bus master 1302, 1352, but rather, for a point-to-point transfer to the target slave 1306 or 1308, 1356 or 1358 or for a broadcast transfer to the target group of slaves 1306 and 1308, 1356 and 1358. The bus master 1302, 1352 may then transmit an identifier of the source slave 1304, 1354 to the target slaves 1306, 1308, 1356 and/or 1358 with a bit stream, which may include hardware event status bits. Thus, the bus master 1302, 1352 acts as a bridge between the source slave 1304, 1354 and the target slaves 1306, 1308, 1356 and/or 1358, permitting hardware event status information to be exchanged. Hence, the source slave 1304, 1354 can exchange information with a target slave 1306, 1308, 1356, 1358 without having to gain the bus-owner/bus-master status.

A source slave-initiated packet may be unified with, or handled independently of, a master-initiated packet. In one example, a first transaction on an I3C bus may include a source slave-initiated packet and may optionally include a Stop (P) bit. In another example, a second transaction on the I3C bus may include a master-initiated packet, and may optionally include a Start (S) bit or a Start-Repeat (Sr) bit. When the source slave-initiated packet is unified with the master-initiated packet, devices may be capable of receiving an incoming unified data packet.

In accordance with certain aspects disclosed herein, the techniques described herein can reduce or eliminate latencies otherwise present due to a bus-master handoff operation.

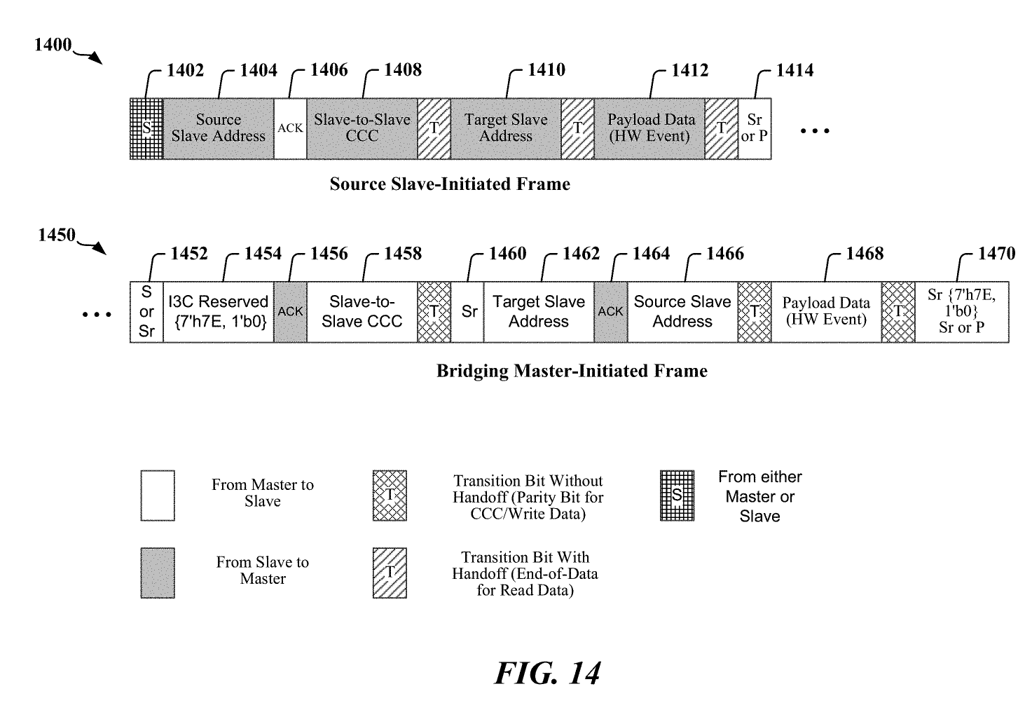

FIG. 14 illustrates frame structures for a point-to-point, slave-initiated slave-to-slave packet transfer. A source slave-initiated frame 1400 commences with an IBI Start (S) bit 1402, followed by a source slave address 1404, a bridging master ACK 1406, and a slave-to-slave CCC 1408. The slave-to-slave CCC 1408 indicates to the bridging master that the message to follow is not for the bridging master's own consumption but is to be used by a target slave. Following the slave-to-slave CCC 1408 is a target slave address 1410 that indicates the intended recipient of the message. Thereafter, payload data 1412 is provided. In an example, the payload data 1412 includes a hardware event status, which may indicate a number of GPIO states that the source slave wishes to communicate to the target slave. In another example, the payload data 1412 includes VGI-type data. The payload data 1412 may be followed by a Stop (P) bit or Start-Repeat (Sr) bit 1414.

When the bridging master observes the slave-to-slave CCC 1408, the bridging master may determine that the incoming payload data 1412 is not for the bridging master's own usage, but rather, the payload data 1412 is to be transferred to the target slave. The bridging master may then begin communication with the target slave to transmit the source slave address and the payload data 1412. A bridging master-initiated frame 1450 commences with a Start (S) bit or Start-Repeat (Sr) bit 1452, followed by a header 1454 in accordance with an I3C protocol. After an acknowledgement by the slave (slave ACK 1456), a slave-to-slave CCC 1458 is transmitted. The slave-to-slave CCC 1458 indicates to a receiving slave that the message to follow is originated by the source slave. A Start-Repeat (Sr) bit 1460 and a target slave address 1462 transmitted after the slave-to-slave CCC 1458 indicates the intended recipient of the message. A target slave ACK 1464 follows the target slave address 1462. Thereafter, a source slave address 1466 and payload data 1468 is provided. The payload data 1468 may be the same as the payload data 1412 included in the source slave-initiated frame 1400. The payload data 1468 may be followed by a Stop (P) bit or Start-Repeat (Sr) bit 1470.

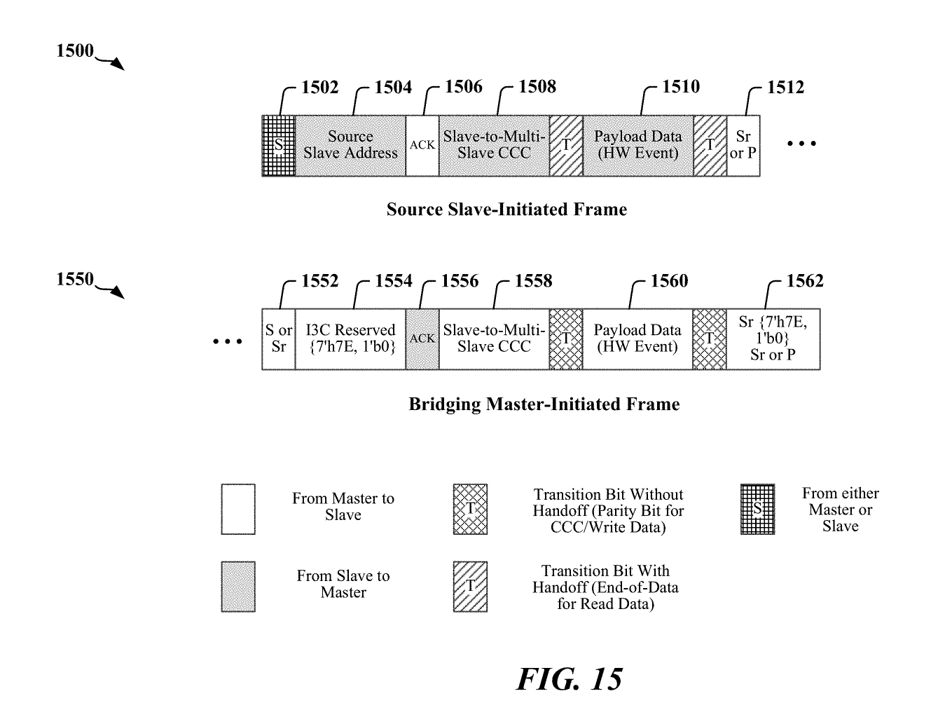

FIG. 15 illustrates frame structures for a point-to-multipoint (broadcast) slave-initiated slave-to-slave packet transfer. A source slave-initiated frame 1500 commences with an IBI Start (S) bit 1502 followed by a source slave address 1504. After a bridging master ACK 1506, a slave-to-multi-slave CCC 1508 (broadcast CCC) is transmitted. The slave-to-multi-slave CCC 1508 indicates to the bridging master that the message to follow is not for the bridging master's own consumption but is to be used by a group of target slaves (e.g., all of the slaves on the bus that are not the source slave). Following the slave-to-multi-slave CCC 1508, payload data 1510 is provided. In one example, the payload data 1510 relates to a hardware event status, which may indicate a number of GPIO states that the source slave wishes to communicate to the target slaves. In another example, the payload data 1510 may include VGI-type data. The payload data 1510 may be followed by a Stop (P) bit or Start-Repeat (Sr) bit 1512. The point-to-multipoint source slave-initiated frame 1500 does not include a target slave address since the message may be broadcast to all slaves on the bus.

When the bridging master observes the slave-to-multi-slave CCC 1508, the bridging master may determine that the incoming payload data 1510 is not for the bridging master's own usage, but rather, the payload data 1510 is to be transferred to the group of target slaves. The bridging master may then begin communication with the target slaves to transmit the payload data 1510. A bridging master-initiated frame 1550 commences with a Start (S) bit or Start-Repeat (Sr) bit 1552, followed by a header 1554 in accordance with an I3C protocol. After a slave ACK 1556, a slave-to-multi-slave CCC 1558 is transmitted. The slave-to-multi-slave CCC 1558 indicates to the group of target slaves that the message to follow is originated by the source slave. Following the slave-to-multi-slave CCC 1558, payload data 1560 is provided. The payload data 1560 is the same as the payload data 1510 included in the source slave-initiated frame 1500. The payload data 1560 may be followed by a Stop (P) bit or Start-Repeat (Sr) bit 1562.

### Slave Monitoring of Communications in a Serial Bus Topology

According to certain aspects disclosed herein, bus latency may be reduced by eliminating the need for a bridging master to retransmit data to one or more slave devices. A bus monitoring mode may be implemented whereby a slave device can be commanded to listen to a transaction on the serial bus in order to capture payloads that include VGI data targeted to the slave device. In one example, monitoring may be implemented in directed transactions, where a slave is identified by a slave ID transmitted in the transaction. In another example, monitoring may be implemented in a broadcast mode, where multiple slaves may receive VGI information from a broadcast transaction. In each of the two latter examples, the payload data in the transactions is transmitted on the serial bus by a slave device.

Certain concepts, techniques, configurations and other aspects disclosed herein are applicable to a variety of bus topologies. Certain aspects are described in the context of a serial bus that is operated in accordance with an I3C protocol. The example of I3C is employed to facilitate description and it is contemplated that the various aspects apply equally to other protocols and bus topologies including, for example, I2C, I3C, RFFE, SPMI and/or other protocols.

Slave monitoring modes may be initiated using CCCs. Table 1 illustrates an example of the use of CCCs for slave monitoring modes including bit settings for two different CCCs.

TABLE 1
Example of CCCs for Slave Monitoring Modes

| | | | | Source | Target |
|---|---|---|---|---|---|
| CCC | Address Mode | Initiator | Direction | RnW | RnW |
| 0x60 | Broadcast | Slave | From Slave | R | N/A |
| 0x60 | Broadcast | Master | From Master | R | N/A |
| 0xDB | Direct | Slave | From Slave | R | W |
| 0xDB | Direct | Master | From Master | W | W |
| 0xDB | Direct | Slave | To Slave | R | R |
| 0xDB | Direct | Master | To Master | R | R |

The CCCs in Table 1 may correspond to some degree with Common Command Codes defined by I3C standards and/or defined based on application needs or requirements. Any number of CCCs and/or combination of CCC values may be defined to satisfy with application needs and/or comply with specifications defined by standards bodies. For example, reduced input/output (RIO) Common Command Codes may be reserved in MIPI I3C specifications and may be used to define slave monitoring modes. In the example illustrated in Table 1, a first CCC (0x60) is used to indicate broadcast slave monitoring modes and a second CCC (0xDB) is used to indicate direct addressing slave monitoring modes. A read/write bit (RnW) in address fields indicates whether the addressed slave is involved in a read or write transaction. The combination of CCCs, address fields and RnW bits can be used to select the mode of operation of devices in slave monitoring modes. The character of transactions may be defined a priori. the target is made of all devices. The Target address RnW may be ignored since, in broadcast transactions (initiated after a CCC=0x60), data is written to multiple target devices, and the bus typically cannot support simultaneous reads from multiple devices.

For each slave monitoring mode, a default data transfer protocol may be set. In one example, the default data transfer protocol may be set to single data rate (SDR). The master device may select a different data transfer protocol, which may be a high data rate (HDR) protocol before frames that include payload data are initiated. For ease of description, the examples illustrated herein relate to SDR protocol.

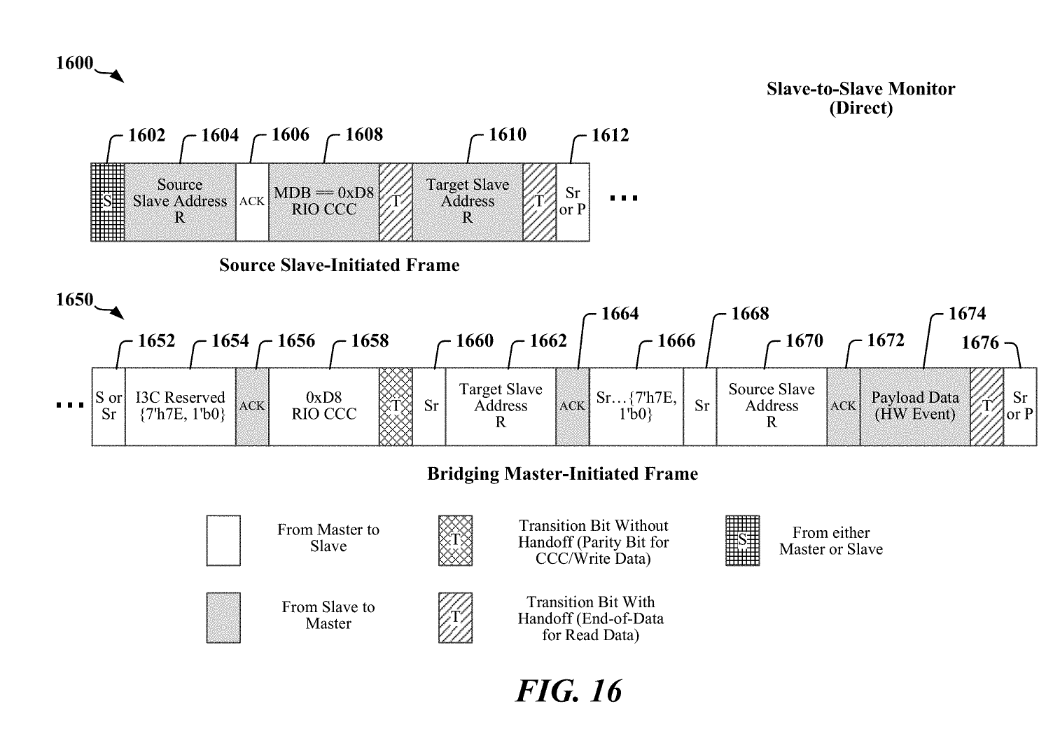

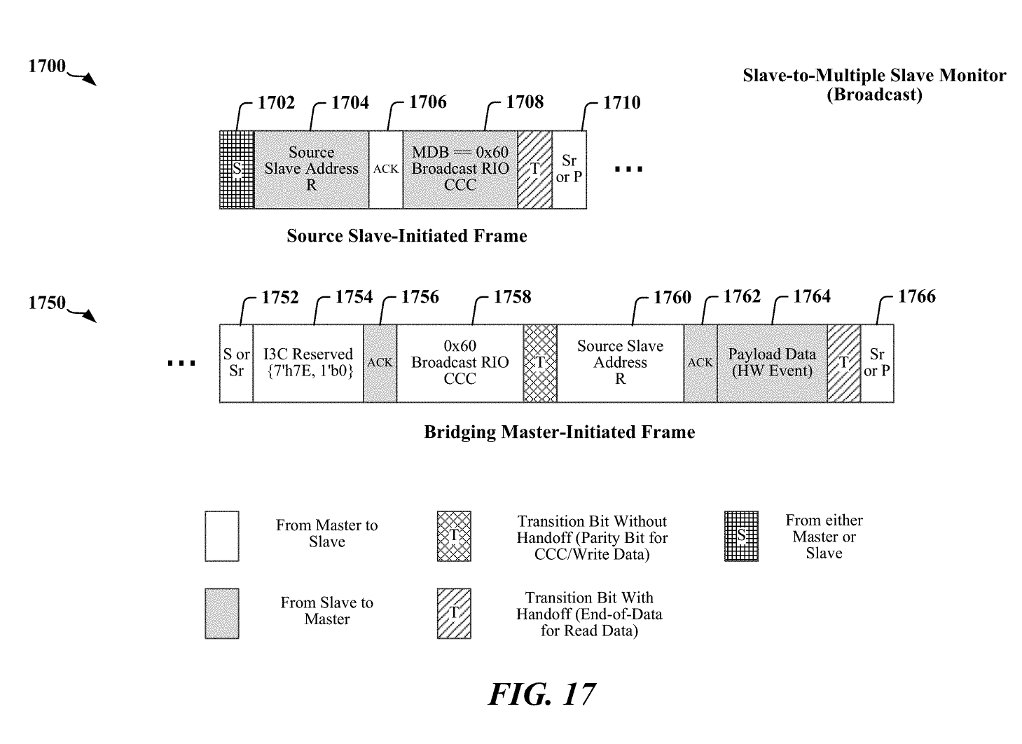

FIGS. 16 and 17 illustrate transmissions during slave monitoring modes. In one aspect, a slave-initiated transfer is triggered through an IBI request 1600, 1700. A mandatory data byte (MDB 1608, 1708) in the IBI request 1600, 1700 has the numerical value of the RIO CCC corresponding to the desired slave monitoring mode to be initiated. The IBI request 1600, 1700 includes a one-byte source address 1604, 1704 identifying the slave that is the source of the IBI. In another aspect, an IBI request 1600 carrying a direct addressing RIO CCC in the MDB 1608 includes a one-byte target address 1610 identifying the slave device that is to receive or transmit data in the slave monitoring mode. A Start-Repeat 1612, 1710 terminates the IBI request 1600, 1700. The least significant bits (LSBs) of the source address 1604, 1704 and the target address 1610 serve as the RnW bit (see Table 1), indicating data direction on the bus.

FIG. 16 illustrates frame structures for a point-to-point, slave-initiated slave-to-slave transfer, where a target slave monitors data line transactions to receive payload data. In this mode, the bus master reads data from a source device, while one or more slave-to-slave (S2S) enabled slaves monitor the transaction and collects payload data. The master may select target devices by addressing individual slaves or groups of slaves. In some aspects of the disclosure, the slave can monitor a data line transaction to receive data signals (e.g., sniff the data signals) after the slave is instructed through a certain command.

A slave that needs or desires to transfer data initiates the transaction through an IBI request 1600 initiated by a source slave. The IBI request 1600 commences with an IBI Start (S) bit 1602, followed by the source address 1604, a master ACK 1606, and a slave-to-slave monitor CCC transmitted in the MDB 1608 (MDB=0xDB). The value in the MDB 1608 indicates to the master that the message is not for the master's own consumption but is to be used by a target slave. Following the MDB 1608 is a target address 1610 that indicates the target slave that is to monitor a data line in order to receive and/or capture data from the source slave. The master reads the target slave address, which is provided with RnW=1′b0 (i.e. W). The W value of the RnW bit indicates that data is to be written to one or more target slaves. The MDB 1608 may be followed by a Stop (P) bit or Start-Repeat (Sr) bit 1612. The IBI request 1600 does not include a payload data field in this scenario since the target slave will be commanded to monitor the data line to receive the data from the source slave via a master-initiated frame.

When the master observes the slave-to-slave monitor CCC in the MDB 1608, the master knows that the IBI request 1600 is not directed to the master, but rather, the IBI request 1600 is intended to prompt the master to command the target slave to monitor the data line in order to receive data from the source slave. The master may then begin communication with the target slave to transmit the source slave address. The master may change protocol (SDR or HDR) before continuing.

A master-initiated frame 1650 commences with a Start (S) bit or Start-Repeat (Sr) bit 1652, followed by a header 1654 in accordance with an I3C protocol, a slave ACK 1656, and a slave-to-slave monitor CCC 1658. The slave-to-slave monitor CCC 1658 indicates to a slave that the message to follow is a command originated by the source slave to monitor the data line to receive data from the source slave. Following the slave-to-slave monitor CCC 1658 is a Start-Repeat (Sr) bit 1660 and a target slave address 1662 that indicates the specific slave that is to monitor the data line for the data. The target slave address 1662 has RnW set to 1′b0 (i.e., W). The RnW bit being set to the W value indicates that the data is to be collected by the target slave (written into the target slave. A target slave ACK 1664 follows the target slave address 1662. Following the target slave ACK 1664 is a Start-Repeat (Sr) bit 1666 in accordance with an I3C protocol, followed by a source slave address 1670. The source slave address 1670 is included to indicate the source of the data. The source slave address 1670 has RnW set to 1′b1 (i.e., R). The RnW bit being set to the R value indicates that the data is to be read from the source slave. After a target slave ACK 1672, the target slave will then monitor the data line and capture payload data 1674 originating from the source slave.

The requester (initiator of the IBI request 1600) monitors the READ and collects the payload data 1674. Since the CCC was set to 0xDB, only the requester need monitor the transaction and collect the payload data 1674. In one example, the payload data 1674 includes hardware event status, which may indicate a number of GPIO states that the source slave wishes to communicate to the target slave. In another example, the payload data 1674 may include VGI-type data.

The master-initiated frame 1650 may conclude with a Stop (P) bit or Start-Repeat (Sr) bit 1676. Accordingly, because the payload data 1674 from the source slave does not need to be included in the IBI request 1600, the payload data 1674 is read only once during the master-initiated frame 1650, thus reducing latency especially for a long transaction.

FIG. 17 illustrates frame structures for a point-to-multipoint (broadcast) slave-initiated slave-to-slave packet transfer where target slaves monitor data line transactions to receive payload data. In this mode, the bus master reads data from a source device, while slave-to-slave (S2S) enabled slaves monitor the transaction and collect payload data. All S2S enabled devices collect payload data. In an aspect of the disclosure, if a group of slaves are instructed to take action following a certain command, then the group of slaves can monitor a data line transaction to receive data transmitted over the data line (e.g., sniff the data).

In one aspect, a slave that needs to transfer data initiates the IBI request 1700. The MDB 1708 may be set to 0x60, i.e. the appropriate RIO CCC for broadcast mode monitoring. A source slave-initiated IBI request 1700 commences with an IBI Start (S) bit 1702, followed by a source address 1704, a master ACK 1706, and the MDB 1708 (a slave-to-multi-slave monitor CCC, or broadcast CCC). The slave-to-multi-slave monitor CCC in the MDB 1708 indicates to the master that the message is not for the master's own consumption but is to be used by the group of target slaves. Following the MDB 1708 is a Stop (P) bit or Start-Repeat (Sr) bit 1710. The Master may terminate the IBI request 1700 by transmitting a STOP (P) or Repeated START (Sr) 1710. There is no data to be read from the Slave at this stage. The IBI request 1700 does not include a payload data field in this scenario since the group of target slaves are yet to be commanded to monitor the data line to receive data from the source slave via a master-initiated frame.

When the master observes the slave-to-multi-slave monitor CCC in the MDB 1708, the master recognizes that the source slave-initiated IBI request 1700 is not directed for the master's own usage, but rather, the IBI request 1700 is to prompt the master to command the group of target slaves to monitor the data line in order to receive data from the source slave. The master may then begin communication with the group of target slaves to transmit the source slave address. The master may change protocol (SDR or HDR) before continuing.

A master-initiated frame 1750 commences with a Start (S) bit or Start-Repeat (Sr) bit 1752, followed by a header 1754 in accordance with an I3C protocol, a slave ACK 1756, and a slave-to-multi-slave monitor CCC 1758 (broadcast CCC). The slave-to-multi-slave monitor CCC 1758 indicates to the group of target slaves that the message to follow is a command originated by the source slave to monitor the data line to receive data from the source slave. Following the slave-to-multi-slave monitor CCC 1758 a source slave address 1760 is transmitted. The source slave address 1760 is included to indicate the source of the data. The source slave address 1760 has the RnW=1′b1 (i.e. READ). Setting the RnW bit to the R value indicates that the Source Slave is to provide Data to be transferred. The payload data 1764 follows, as read by the master from the source slave. All S2S enabled devices monitor the transaction and collect the payload data 1764. After a slave ACK 1762, the group of target slaves will then monitor the data line and capture the payload data 1764 originating from the source slave. In an example, the payload data 1764 include hardware event status, which may indicate a number of GPIO states that the source slave wishes to communicate to the group of target slaves. In another example, the payload data 1764 may include VGI-type data.

The master-initiated frame 1750 may then conclude with a Stop (P) bit or Start-Repeat (Sr) bit 1766. Accordingly, because data from the source slave does not need to be included in the IBI request 1700, the data is read only once during the master-initiated frame 1750, and therefore, latency is reduced especially for a long transaction. In an aspect, due to reduced latency benefits, the above-described frame structures for the broadcast slave-initiated slave-to-slave packet transfer, where target slaves monitor data line transactions, may be used for VGMI or in cases where a large amount of data is to be transferred to numerous devices, for example.

In various aspects, the broadcast mode may be initiated by the master device. The IBI request 1700 is not necessarily transmitted, and the transaction is initiated by transmitting the master-initiated frame 1750.

According to certain aspects of the disclosure, the frame structures and/or protocols described herein may apply to SDR implementations as well as HDR implementations.

### Slave-to-Slave Communications

The MIPI I3C interface provides transactions that are routed through a master. These procedures may add latency. A first device can transfer data to a target device when the first device operates a current master or when the first device can send the data to the current master for forwarding to the target device. Certain aspects disclosed herein provide a faster transfer path in VGI or VGMI applications without using mastership handoff, when the data transfer is desired between two devices that are not operating in the master role.

In an aspect, RIO CCCs may correspond to RIO Common Command Codes reserved in the MIPI I3C specification may be used to provide a flexible, fast, and comprehensive set of slave-to-slave data transfer procedures. RIO CCCs may be used to control VGI/VGMI transactions in devices configured to process such data packets. A specific character of the data received are defined a priori, and managed by an upper controller layer.

Principles applied for the solution include: 1) a slave's initiated transfer is performed via an IBI request, where a mandatory data byte (MDB) has the same value as the RIO CCC that will be used for completing a respective procedure; 2) a direct RIO CCC will have a defining data byte before the presently required Repeated Start (Sr), the byte will indicate the originator or the requester of the data, and an RnW bit will indicate the direction of the data; and 3) a data transfer can be terminated early, following the rules specified in I3C specifications.

### Basic Broadcast RIO CCC

According to certain aspects, a broadcast CCC with a value 0x5C may be used for data transfers when the master temporarily stores data and then transfers the data to target devices. Devices capable of slave-initiated slave-to-slave communication may be required to process the slave-to-slave transaction as defined by protocol when these devices are coupled to the bus.

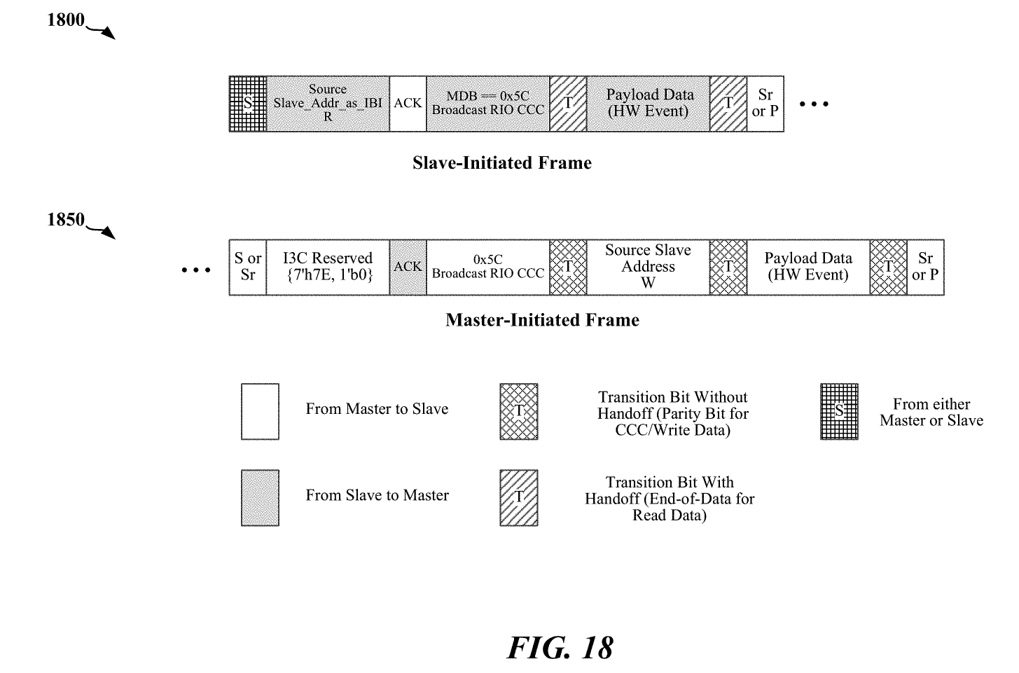

FIG. 18 illustrates frame structures for a slave-initiated broadcast transfer (Bcast_SL). A source slave that needs to transfer data may initiate the IBI via a slave-initiated frame 1800, with MDB=0x5C, i.e., the appropriate RIO CCC for this type of transaction. A master reads the data and may either continue after a Sr or stop (P).

The master initiates the RIO broadcast CCC 0x5C via a master-initiated frame 1850. A first byte of the appended data to the CCC contains a source slave address, where RnW=1′b0, i.e., WRITE (W). The W value of the RnW bit indicates that the source slave has provided the data to be transferred. The next byte(s) contain(s) the data, as received from the source slave.

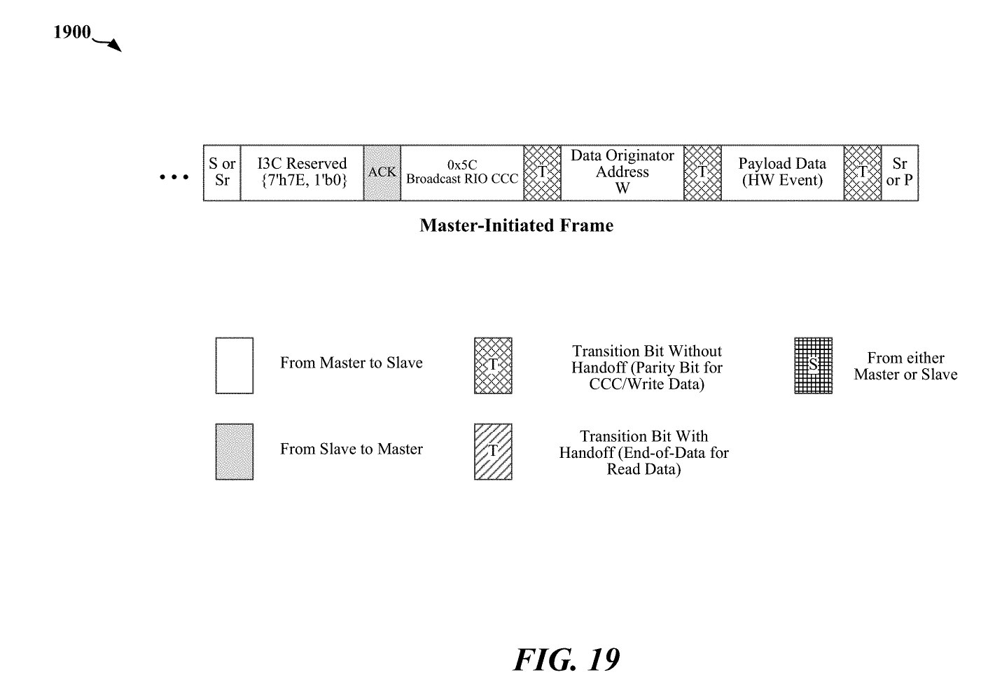

FIG. 19 illustrates a frame structure for a master-initiated broadcast transfer (Bcast_M). A master initiates the RIO broadcast CCC 0x5C via a master-initiated frame 1900. A first byte of appended data to the CCC contains an address of a data originator, where the RnW=1′b0, i.e., WRITE (W). The W value of the RnW bit indicates that the data has been provided, and consequently, the devices need to collect the data. The data originator may be the master or another device from which the master has received information, possibly via other means (e.g., outside the I3C bus). The next byte(s) contain(s) the data, as received from the originator.

### Monitoring Broadcast RIO CCC

According to certain aspects, a broadcast CCC with a value 0x5D may serve as a monitoring broadcast RIO CCC that can be used to avoid repetitive transfer of data in which data is first transferred from a source device to the bus master, and then from the bus master to a target device. Devices capable of slave-initiated slave-to-slave communication may be required to process the slave-to-slave transaction as defined by protocol when these devices are coupled to the bus.

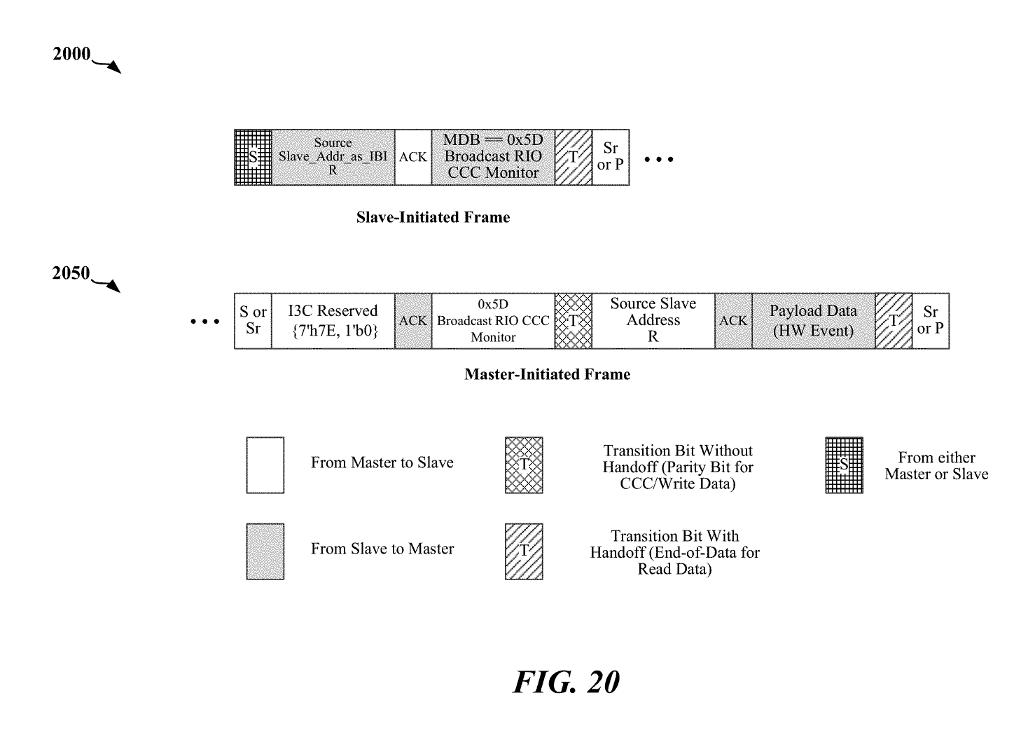

FIG. 20 illustrates frame structures for a slave-initiated monitoring broadcast transfer (Bcast_Monitor_SL). A source slave that needs to transfer data may initiate the IBI via a slave-initiated frame 2000, with MDB=0x5D, i.e., the appropriate RIO CCC for this type of transaction. There is no data from the source slave for a master to read in this procedure. The master may either continue after a Sr or stop (P).

The master initiates the RIO Broadcast CCC 0x5D via a master-initiated frame 2050. A first byte of appended data to the CCC contains a source slave address, where the RnW=1′b1, i.e., READ (R). The R value of the RnW bit indicates that the source slave will provide the data to be transferred. The next byte(s) contain(s) the data, as read by the master from the source slave.

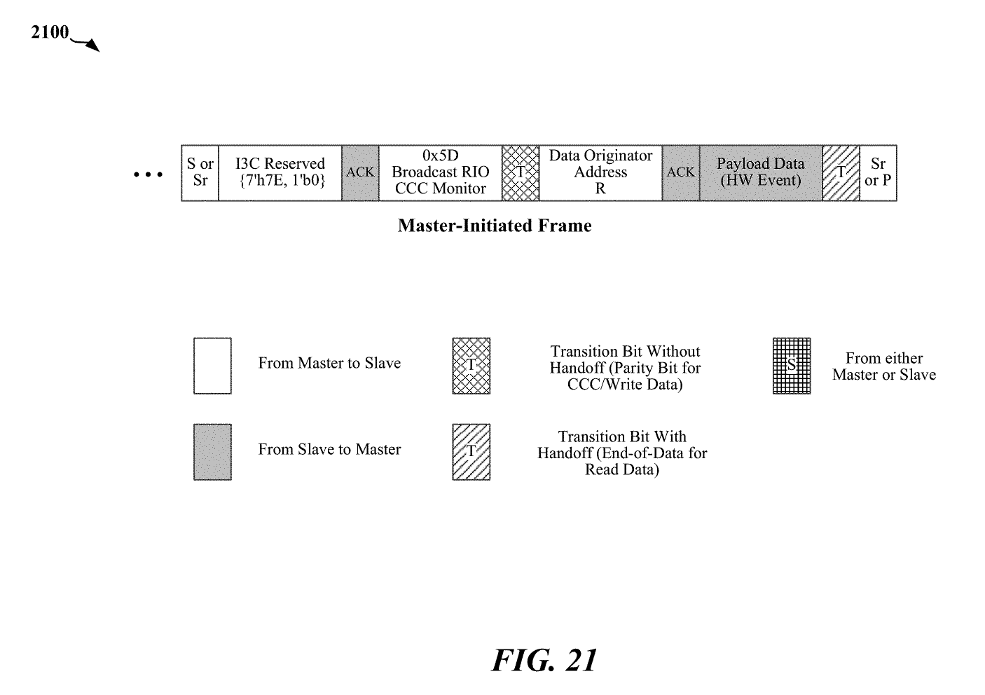

FIG. 21 illustrates a frame structure for a master-initiated monitoring broadcast transfer (Bcast_Monitor_M). A master initiates the RIO Broadcast CCC 0x5D via a master-initiated frame 2100. A first byte of appended data to the CCC contains an address of a data originator, where the RnW=1′b1, i.e., READ (R). The R value of the RnW bit indicates that the data will be provided, and consequently, the devices need to collect the data. The master will READ the data from the data originator. The next byte(s) contain(s) the data, as read from the data originator.

### Basic Direct RIO CCC

According to certain aspects, a direct CCC with a value 0xDB may be used as a basic direct CCC for data transfers when a master temporarily stores the data and then transfers the data to target devices. A basic direct CCC can address one or more specified devices. In one example, the basic direct CCC may provide a unique identifier to specify an individual device as the target device. In another example, the basic direct CCC may provide a group device to target multiple devices.

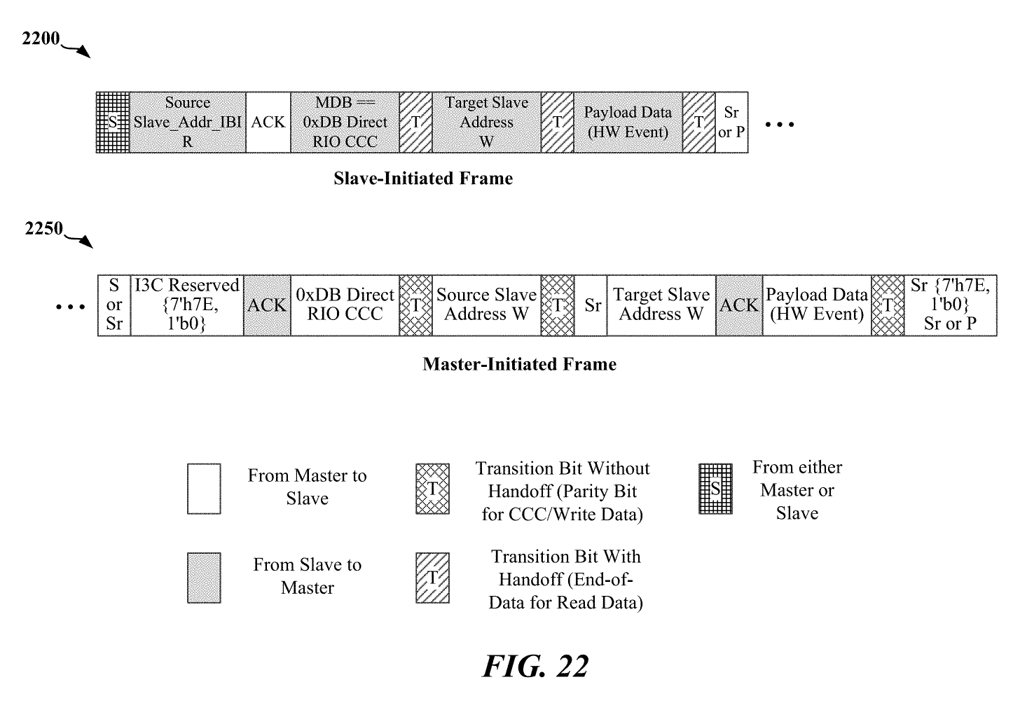

FIG. 22 illustrates frame structures for a slave-initiated direct write transfer (SL2SL_WRITE). A source slave that needs to transfer data may initiate the IBI via a slave-initiated frame 2200, with MDB=0xDB, i.e., the appropriate RIO CCC for this type of transaction. A master reads a target slave address, which is provided with RnW=1′b0, i.e., WRITE (W). The W value of the RnW bit indicates that the data is to be written to the target slave. The master then reads the data and may either continue after a Sr or stop (P).

The master initiates the direct RIO CCC 0xDB via a master-initiated frame 2250. A first byte of appended data to the CCC contains a source slave address, with the RnW=1′b0, i.e., WRITE (W). The W value of the RnW bit indicates that the source slave has provided the data to be transferred.

The direct CCC continues after Sr, with a target slave address provided with the RnW=1′b0, i.e., WRITE (W). The W value of the RnW bit indicates that the data is to be written to the target slave, as required by the I3C specification. The next byte(s) contain(s) the data, as received from the source slave. The direct CCC ends with the Sr followed by the I3C reserved combination {7′h7E, 1′b0}. Thereafter, the master may provide either a Sr or a Stop (P).

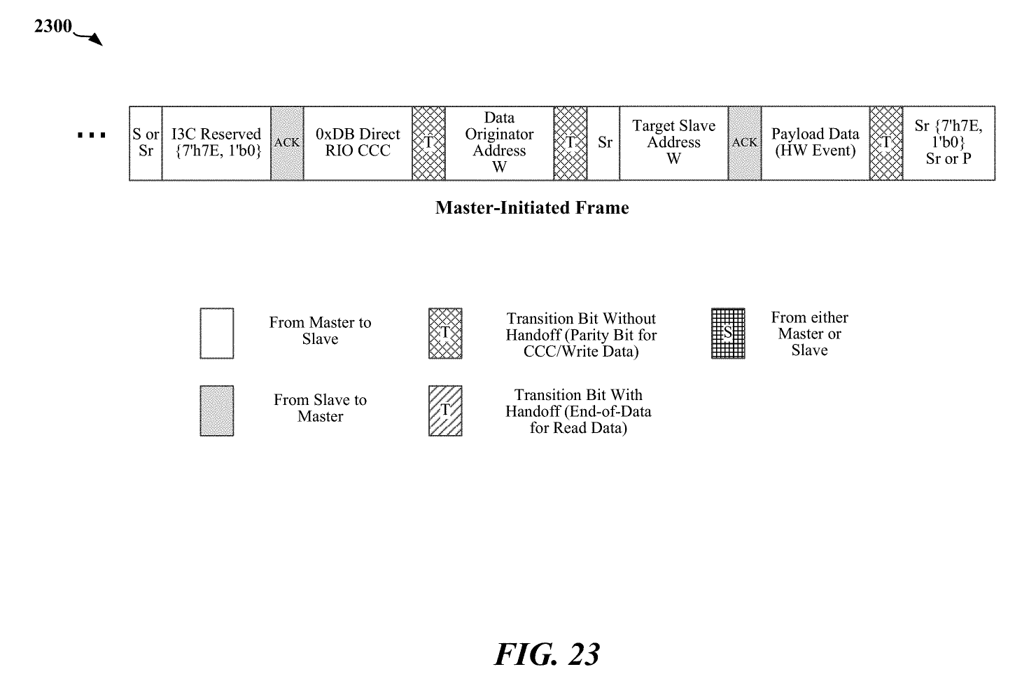

FIG. 23 illustrates a frame structure for a master-initiated direct write transfer (M2SL_WRITE). A master initiates the direct RIO CCC 0xDB via master-initiated frame 2300. A first byte of appended data to the CCC contains an address of a data originator, with the RnW=1′b0, i.e., WRITE (W). The W value of the RnW bit indicates that the data originator has provided the data to be transferred. The data originator may be either the master itself or another known device from which the master has received the data, possibly by means outside of the I3C bus.

The direct CCC continues after Sr, with a target slave address provided with the RnW=1′b0, i.e., WRITE (W). The W value of the RnW bit indicates that the data is to be written to the target Slave, as required by the I3C specification. The next byte(s) contain(s) the data, as received from the data originator. The direct CCC ends with the Sr followed by the I3C reserved combination {7′h7E, 1′b0}. Thereafter, the master may provide either a Sr or a Stop (P).

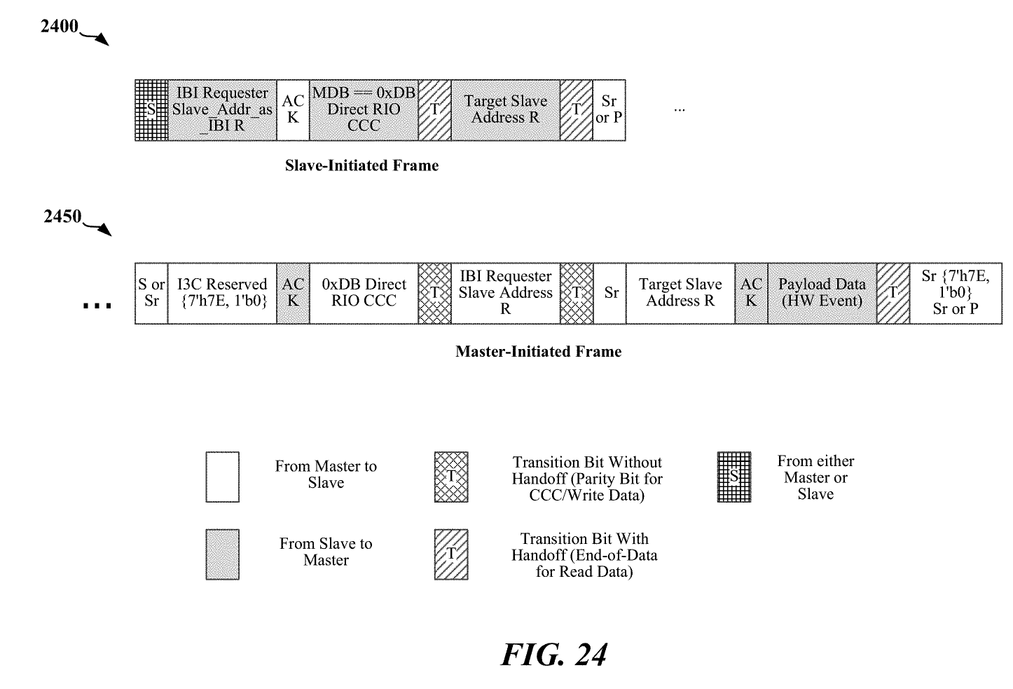

FIG. 24 illustrates frame structures for a slave-initiated direct read transfer (SL2SL_READ). A slave that needs to retrieve data may initiate the IBI via a slave-initiated frame 2400, with MDB=0xDB, i.e., the appropriate RIO CCC for this type of transaction. A master reads a target slave address, which is provided with RnW=1′b1, i.e., READ (R). The R value of the RnW bit indicates that the data is to be read from the target slave. The master may either continue after a Sr or stop (P).

The Master initiates the direct RIO CCC 0xDB via a master-initiated frame 2450. A first byte of appended data to the CCC contains an address of an IBI requester, with the RnW=1′b1, i.e., READ (R). The R value of the RnW bit indicates that the IBI requester requires the data to be read from the target slave. The direct CCC continues after Sr, with the target slave address provided with the RnW=1′b1, i.e., READ (R). The R value of the RnW bit indicates that the target slave will provide the data, as required by the I3C specification.

The next byte(s) contain(s) the data, as read from the target slave. The IBI requester will monitor the read data and collect the data. Since the CCC=0xDB, only the IBI requester needs to monitor the read data. The other S2S-enabled devices may keep active only their address matching front-end. The direct CCC ends with the Sr followed by the I3C reserved combination {7′h7E, 1′b0}. Thereafter, the master may provide either a Sr or a Stop (P).

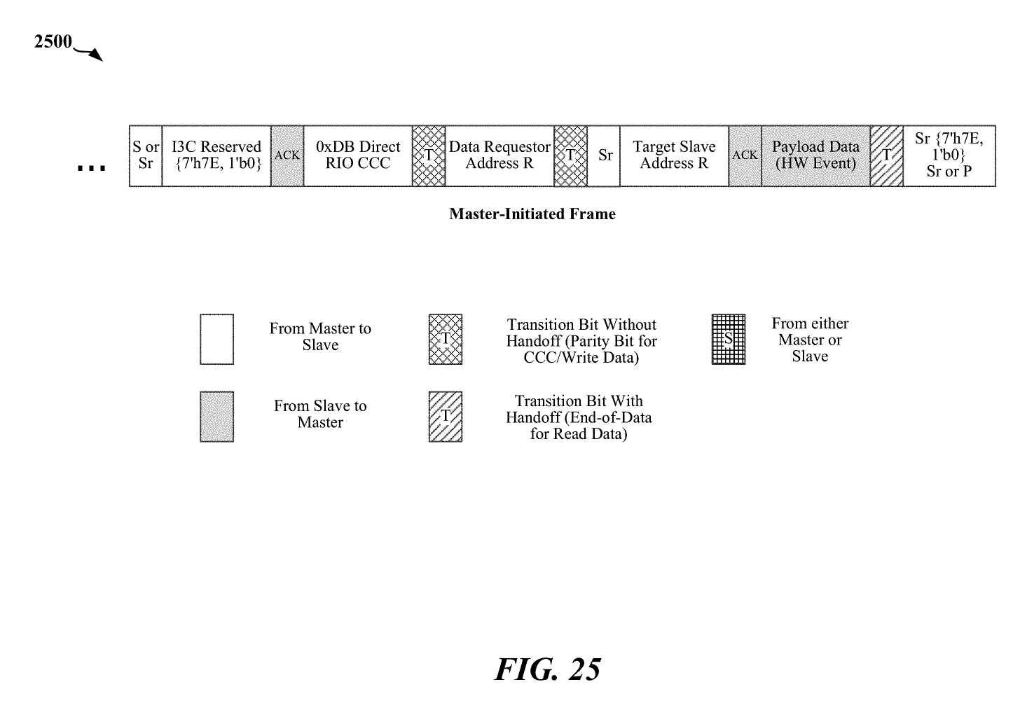

FIG. 25 illustrates a frame structure for a master-initiated direct read transfer (M2SL_READ). A master initiates the direct RIO CCC 0xDB via a master-initiated frame 2500. A first byte of appended data to the CCC contains an Address of a data requestor, with the RnW=1′b1, i.e., READ (R). The R value of the RnW bit indicates that the data requestor is the recipient of the data to be transferred. The data requestor may be either the master itself or another S2S-enabled device from the I3C bus.

The direct CCC continues after Sr, with a target slave address provided with the RnW=1′b1, i.e., READ (R). The R value of the RnW bit indicates that the target slave will provide the data, as required by the I3C specification. The next byte(s) contain(s) the data, as read from the target slave. The data requestor will monitor the read data and collect the data. The direct CCC ends with the Sr followed by the I3C reserved combination {7′h7E, 1′b0}. Thereafter, the master may provide either a Sr or a Stop (P).

### Monitoring Direct RIO CCC

According to certain aspects, a broadcast CCC with a value 0xDC may serve as a monitoring direct RIO CCC that can be used to avoid repetitive transfer of data in which data is first transferred from a source device to the bus master, and then from the bus master to a target device. Here, the monitoring direct RIO CCC can address one or more specified devices. In one example, the monitoring direct CCC may provide a unique identifier to specify an individual device as the target device. In another example, the monitoring direct CCC may provide a group device to target multiple devices

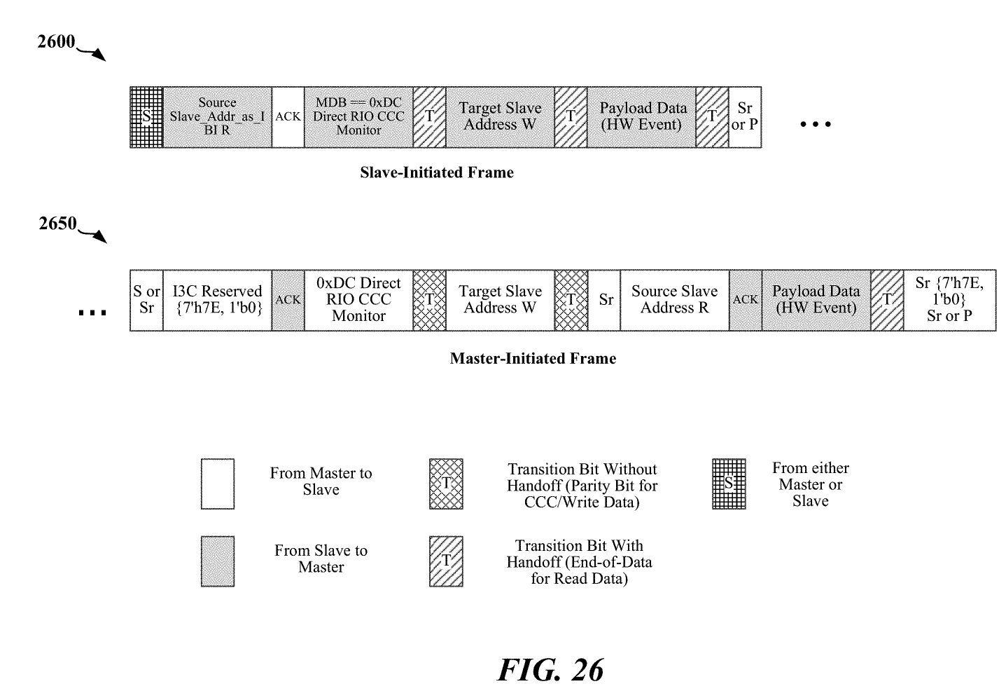

FIG. 26 illustrates frame structures for a slave-initiated monitoring direct write transfer (SL2SL_Mon_WRITE). A slave that needs to transfer data may initiate the IBI via a slave-initiated frame 2600, with MDB=0xDC, i.e., the appropriate RIO CCC for this type of transaction. A master reads a target slave address, which is provided with RnW=1′b0, i.e., WRITE (W). The W value of the RnW bit indicates that the data is to be written to the target slave(s). The master may either continue after a Sr or stop (P).

The master initiates the monitoring direct RIO CCC 0xDC via a master-initiated frame 2650. A first byte of the appended data to the CCC contains a target slave address, with the RnW=1′b0, i.e., WRITE (W). The W value of the RnW bit indicates that the data is to be collected by the target slave, hence written into the target slave. The monitoring direct CCC continues after Sr, with the source slave address provided with the RnW=1′b1, i.e., READ (R). The R value of the RnW bit indicates that the data is to be read from the source slave, as required by the I3C specification.

The next byte(s) contain(s) the data, as received from the source slave, the target slave will monitor and collect the data read. The monitoring directed CCC ends with the Sr followed by the I3C reserved combination {7′h7E, 1′b0}. Thereafter, the master may provide either a Sr or a Stop (P).

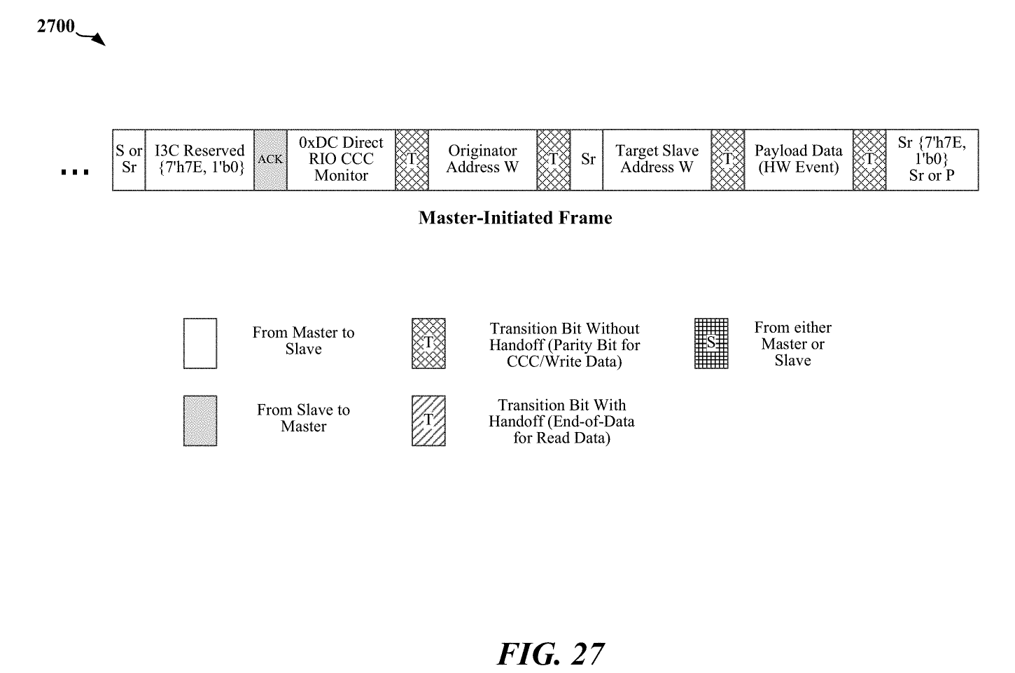

FIG. 27 illustrates a frame structure for a master-initiated monitoring direct write transfer (M2SL_Mon_WRITE). A master initiates the monitoring direct RIO CCC 0xDC via a master-initiated frame 2700. A first byte of appended data to the CCC contains an address of a data originator, with the RnW=1′b0, i.e., WRITE (W). The W value of the RnW bit indicates that the data originator has provided the data to be transferred. The data originator may be either the master itself or another known device from which the master has received the data, possibly by means outside of the I3C bus.

The monitoring direct CCC continues after Sr, with a target slave address provided with the RnW=1′b0, i.e., WRITE (W). The W value of the RnW bit indicates that the data is to be written to the target slave, as required by the I3C specification. The next byte(s) contain(s) the data, as received from the data originator. The direct CCC ends with the Sr followed by the I3C reserved combination {7′h7E, 1′b0}. Thereafter, the master may provide either a Sr or a Stop (P). Notably, the procedure for the master-initiated monitoring direct write transfer (M2SL_Mon_WRITE) is the same as the procedure for the master-initiated direct write transfer (M2SL_WRITE) of FIG. 23. Thus, M2SL_Mon_WRITE of FIG. 27 may be used when the Basic Direct RIO CCC (0xDB) is not used, saving programming space.

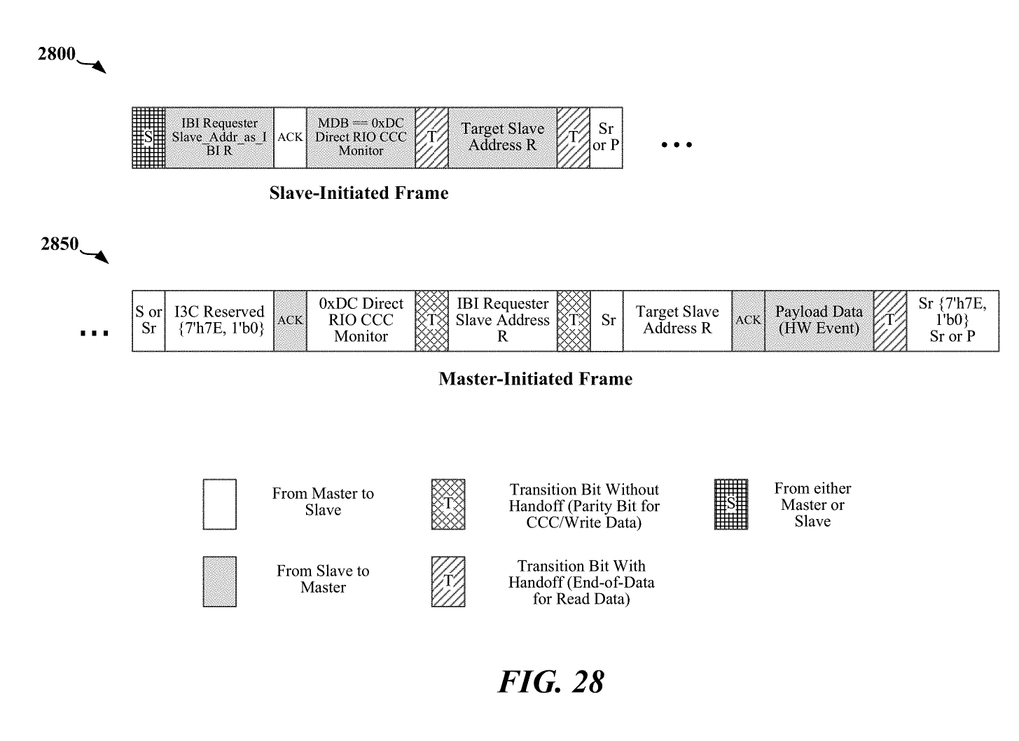

FIG. 28 illustrates frames structures for a slave-initiated monitoring direct read transfer (SL2SL_Mon_READ). A slave that needs to retrieve data may initiate the IBI via a slave-initiated frame 2800, with MDB=0xDC, i.e., the appropriate RIO CCC for this type of transaction. A master reads a target slave address, which is provided with RnW=1′b1, i.e., READ (R). The R value of the RnW bit indicates that the data is to be read from the target slave. The master may either continue after a Sr or stop (P).

The master initiates the monitoring direct RIO CCC 0xDC via a master-initiated frame 2850. A first byte of appended data to the CCC contains an address of an IBI requester, with the RnW=1′b1, i.e., READ (R). The R value of the RnW bit indicates that the IBI requester requires the data to be read from the target slave.

The directed CCC continues after Sr, with the target slave address provided with the RnW=1′b1, i.e., READ (R). The R value of the RnW bit indicates that the target Slave will provide the data, as required by the I3C specification. The next byte(s) contain(s) the data, as read from the target slave. The IBI requester will monitor the read data and collect the data. Since the CCC=0xDC, all S2S-enabled devices will monitor the read data and collect data relevant to each device. The direct CCC ends with the Sr followed by the I3C reserved combination {7′h7E, 1′b0}. Thereafter, the master may provide either a Sr or a Stop (P).

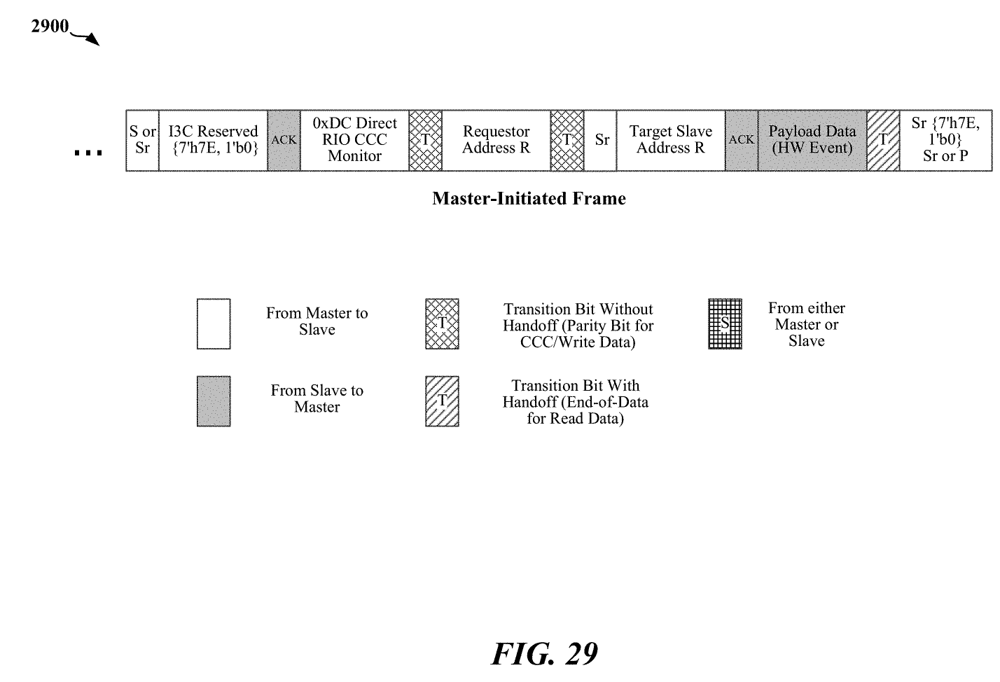

FIG. 29 is a frame structure for a master-initiated monitoring direct read transfer (M2SL_Mon_READ). A master initiates the monitoring direct RIO CCC 0xDC via a master-initiated frame 2900. A first byte of appended data to the CCC contains an address of a data requestor, with the RnW=1′b1, i.e., READ (R). The R value of the RnW bit indicates that the data requestor is the recipient of the data to be transferred. The data requestor may be either the master itself or another S2S-enabled device from the I3C bus.

The monitoring direct CCC continues after Sr, with a target slave address provided with the RnW=1′b1, i.e., READ (R). The R value of the RnW bit indicates that the target slave is to provide the data, as required by the I3C specification. The next byte(s) contain(s) the data, as read from the target slave. The data requestor and all the S2S-enabled devices will monitor the read data and collect the data. The direct CCC ends with the Sr followed by the I3C reserved combination {7′h7E, 1′b0}. Thereafter, the master may provide either a Sr or a Stop (P).

As described above, a correlated set of procedures are disclosed that allow a data transfer between devices on the I3C Bus, with minimal latency and master intervention. Notably, although the various types of CCCs identified above have been described with respect to a specific value (i.e., number), in some aspects, the value/number associated with a CCC may change, and therefore, the various types of CCCs may be associated with any value/number. Moreover, the specific value/number associated with the CCC described above is not strictly tied to the CCC, but rather, in some aspects, the specific value associated with the CCC may be used for other types of transactions.

Slave-Initiated Slave-to-Slave Communication with Reduced Master Involvement

Certain implementations disclosed herein provide techniques for I3C_VGI that enable a first slave device to communicate with a second slave device in which a bus master initiates and/or participates in the transaction. A first slave device that desires to transfer payload data to a second slave device can either take the role of current bus master or send the payload data to the current bus master for forwarding to the second slave device. According to certain aspects, faster data transfers may be achieved with reduced involvement of a bus master device. Certain techniques disclosed herein may be applied to data transfers between two slave devices when the payload data includes VGI or VGMI, without either device becoming the current bus master.

According to certain aspects disclosed herein, a single Direct RIO CCC may be used for slave-initiated slave-to-slave communication with reduced bus master involvement. Bus master involvement may be limited by specifying source and destination slave devices with the Direct RIO CCC. In I3C implementations, the Direct RIO CCC may be a Common Command Code reserved for RIO purposes within the MIPI Alliance I3C specifications. In one example, the Direct RIO CCC may have the value ‘0xDB.’ In various implementations, the character of data payloads transferred using the Direct RIO CCC may be defined a priori, and the serial bus may be operated in accordance with a default mode of communication and/or a default data transfer protocol during transfer of the data payloads. In one example, an SDR protocol may be defined as the default data transfer protocol. The mode of communication and/or data transfer protocol may be configured before data payloads are transmitted. For example, the serial bus and/or the slave devices involved in transfer of the data payloads may enter an HDR mode of operation before the data transmission phase. When the HDR mode of operation is used, the Direct RIO CCC may be transmitted in accordance with a corresponding syntax. For the purposes of the following description, the example of I3C SDR protocol is used.

In accordance with certain aspects disclosed herein, a slave device may initiate a slave-to-slave transfer using a Direct RIO CCC to initiate a broadcast or delimited transfer of a data payload. The initiating slave device specifies a source slave device that is to be read and a target slave device to be written during a slave-initiated transfer. The Data transfer can be terminated early in accordance with I3C protocols. The address of the target slave device and/or the source slave device may be indicated using various techniques that can clearly identify the respective devices. For example, source slave devices and/or target slave devices may be preconfigured and may be identified by a unique identifier or by an index or other reference. In some instances, the configuration of address and other fields in the datagram can be configured. The method of addressing, indicating and identifying source and target devices as well as datagram structure are typically established “a priori” between devices coupled to the serial bus.

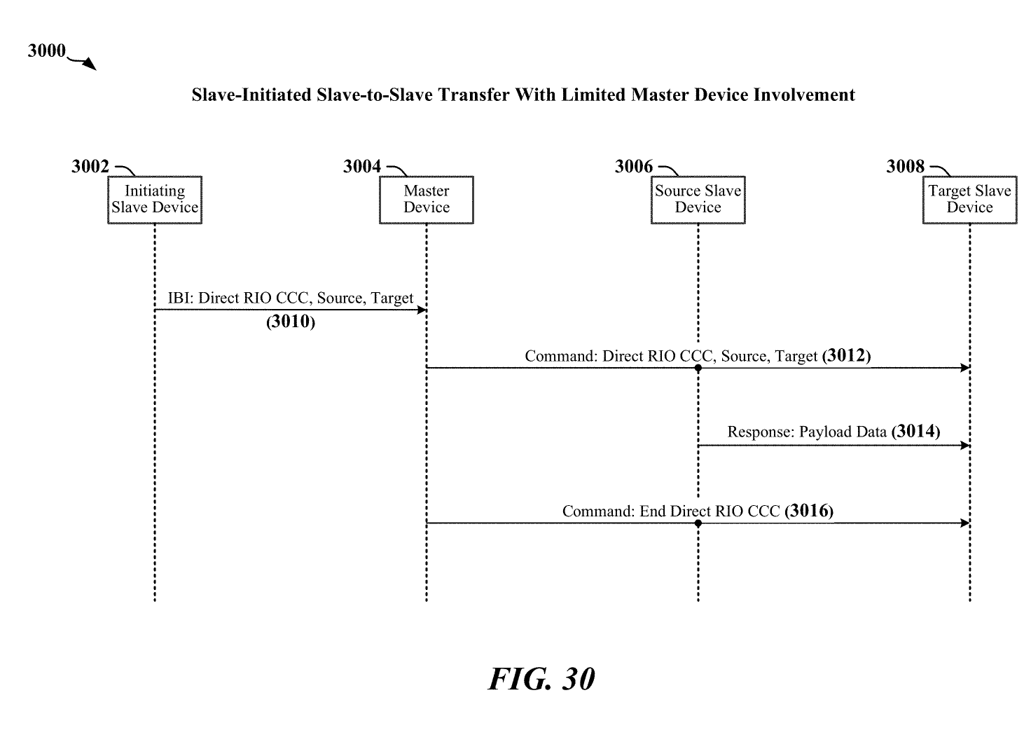

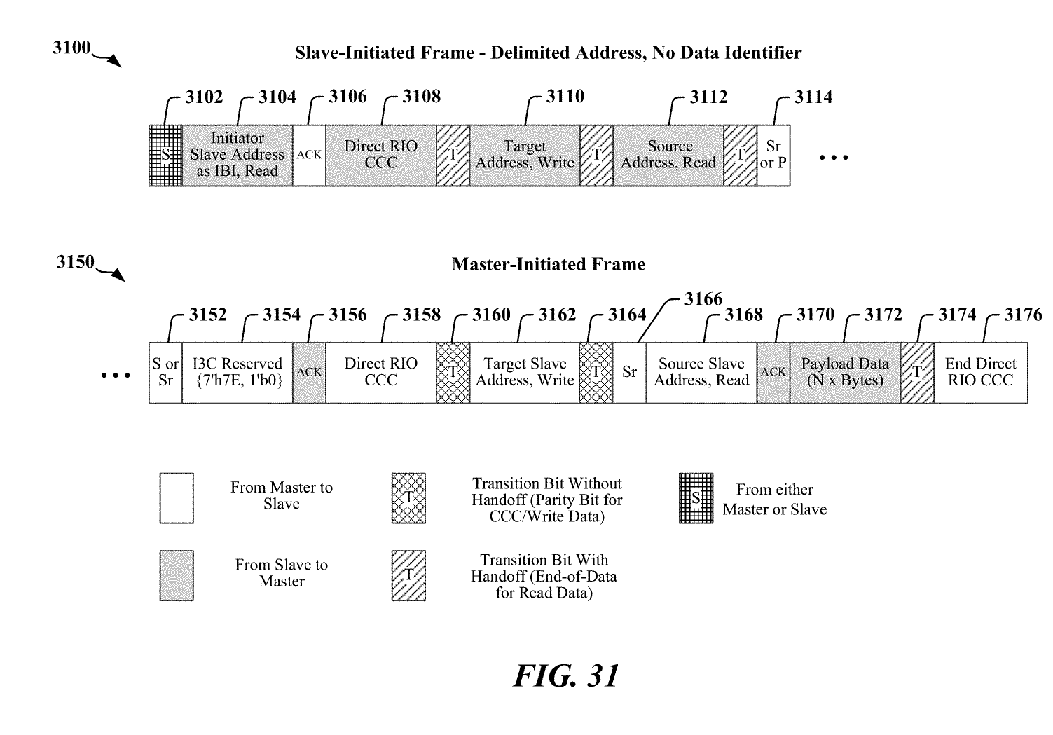

FIG. 30 is a flow diagram 3000 that illustrates an example of a slave-initiated transfer between two slave devices 3006, 3008. FIG. 31 illustrates a first example of transmissions 3100, 3150 corresponding to the flow diagram 3000. In the example, the initiating slave device 3002 is illustrated as being separate from the source slave device 3006 and the target slave device 3008. In a typical operation, the initiating slave device 3002 is also the source slave device 3006 or the target slave device 3008. The initiating slave device 3002 requests service from the current master device 3004 using an IBI 3010, where the IBI 3010 may be asserted in accordance with I3C specifications. The IBI 3010 may be asserted after a START condition 3102 is transmitted by the master device 3004 or the initiating slave device 3002. During the IBI 3010, the initiating slave device 3002 transmits its slave identifier 3104 and, after an acknowledgment 3106 from the master device 3004, the Direct RIO CCC 3108. The Direct RIO CCC 3108 may be transmitted as the mandatory byte defined by I3C protocols and may have an agreed or standards-specified value. In one example, the Direct RIO CCC 3108 may have the value 0xDB. The initiating slave device 3002 may then transmit the target address 3110 with a write bit set to indicate that the target slave device 3008 is to be written, and a source slave address 3112 with a read bit set to indicate that data is to be read from the source slave device 3006. The master device 3004 may then transmit a Repeated START or STOP condition 3114.

The master device 3004 may start 3012 the slave-to-slave transaction by transmitting a START or Repeated START condition 3152, if the master device 3004 previously transmitted a STOP condition 3114. The master device 3004 transmits a header 3154 in accordance with I3C protocols. After an acknowledgement by one or more slave devices (ACK 3156), the Direct RIO CCC 3158 is transmitted. The Direct RIO CCC 3158 is followed by a transition bit 3160 and then the address 3162 of the target slave 3008, a transition bit 3164, Repeated START bit 3166 and the address 3168 of the source slave device 3006 with the read/write bit set to read. A target slave ACK 3170 is expected after the address 3168 of the source slave device 3006.

The source slave device 3006 transmits payload data 3014, 3172, which may be monitored and written by the target slave device 3008. The payload data 3172 may be followed by a transition bit 3174, an End command 3176 and/or a Stop (P) bit or Start-Repeat (Sr) bit. The master device 3004 may send a command 3016 to terminate the slave-to-slave exchange.

In some instances, the IBI 3010 may include additional bytes of management data to configure the slave-to-slave exchange. For example, additional information may be transmitted that specifies the address of a data block to be read from the source slave device 3006, a starting location for writing data in the target device 3008, and/or a type or attribute of the data transferred in the slave-to-slave exchange. The number of additional bytes, the timing of their transmission in the IBI 3010 and the meaning of the additional bytes may be configured based on application needs, and between participating devices 3002, 3004, 3006, 3008. Additional information may be transmitted by the master device 3004 prior to reading the data involved in the slave-to-slave exchange.

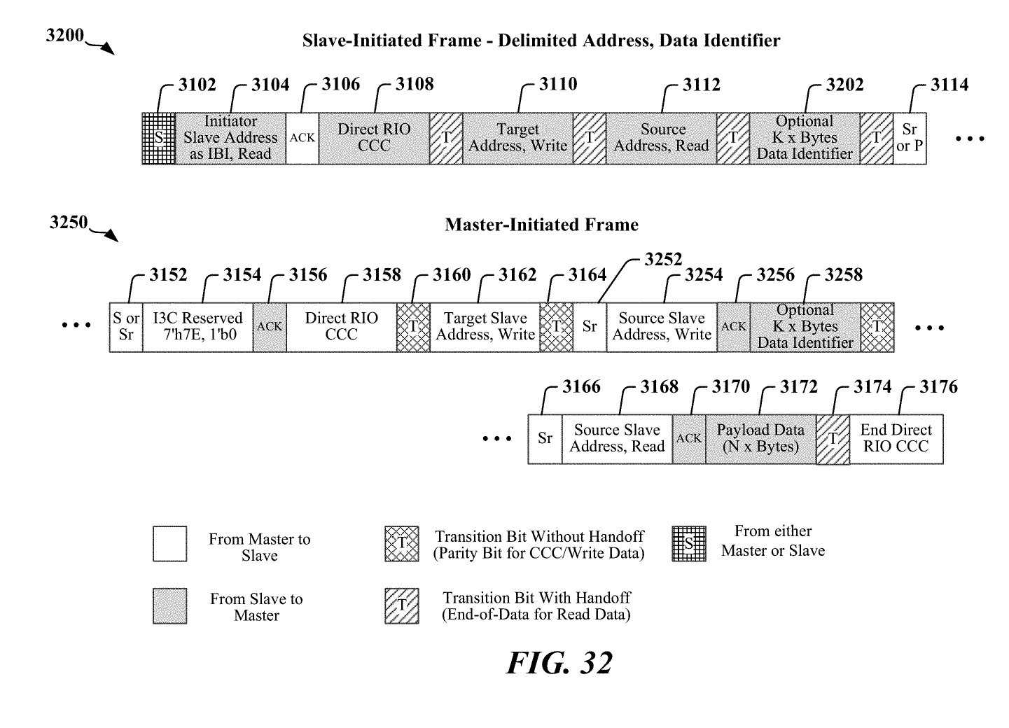

FIG. 32 illustrates a second example of transmissions 3200, 3250 corresponding to the flow diagram 3000. The transmissions 3200, 3250 include Data Identifier (DI) information in addition to the information fields illustrated in the transmissions 3100, 3150 illustrated in FIG. 31. An optional Data Identifier field 3202 may be provided by the initiating slave device 3002 during the IBI 3010, where the Data Identifier field 3202 includes K bytes of data. The Data Identifier field 3202 precedes the Repeated START or STOP condition 3114. The master device 3004 may retransmit the Data Identifier field 3202 in an optional DI field 3258 to the source slave device 3006. The master device 3004 may transmit a Repeated START condition 3252 followed by the address 3254 of the source slave device 3006 with the read/write bit set to write. The master device 3004 then transmits the DI field 3258. The master device 3004 continues the slave-to-slave transaction by transmitting the Repeated START bit 3166 and the address 3168 of the source slave device 3006 with the read/write bit set to read.

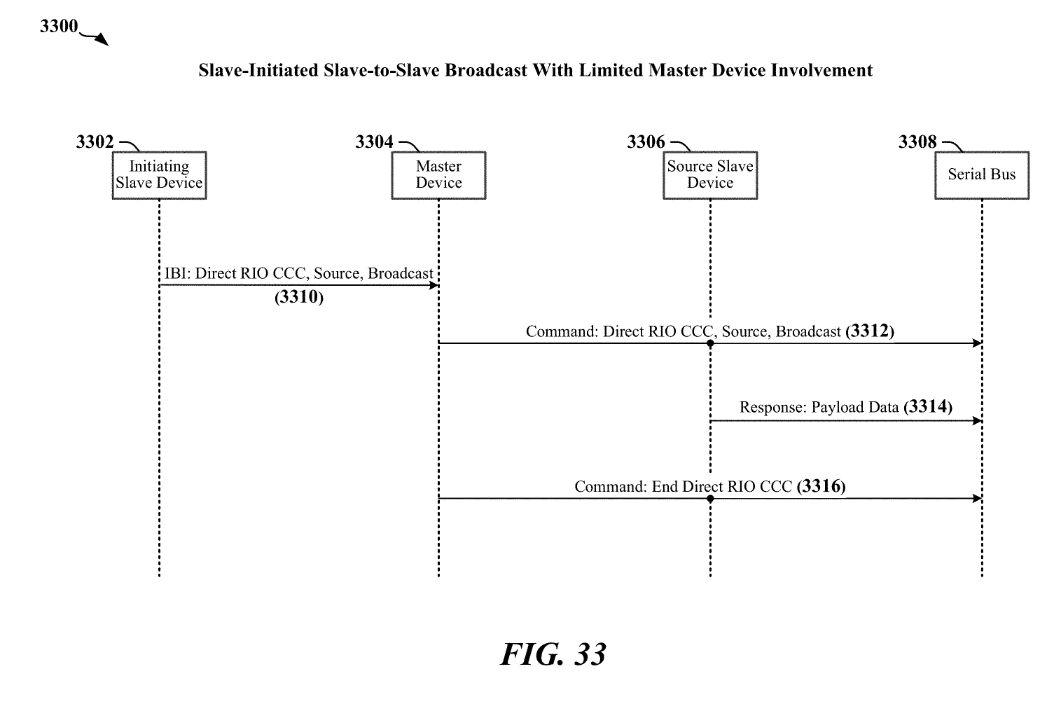

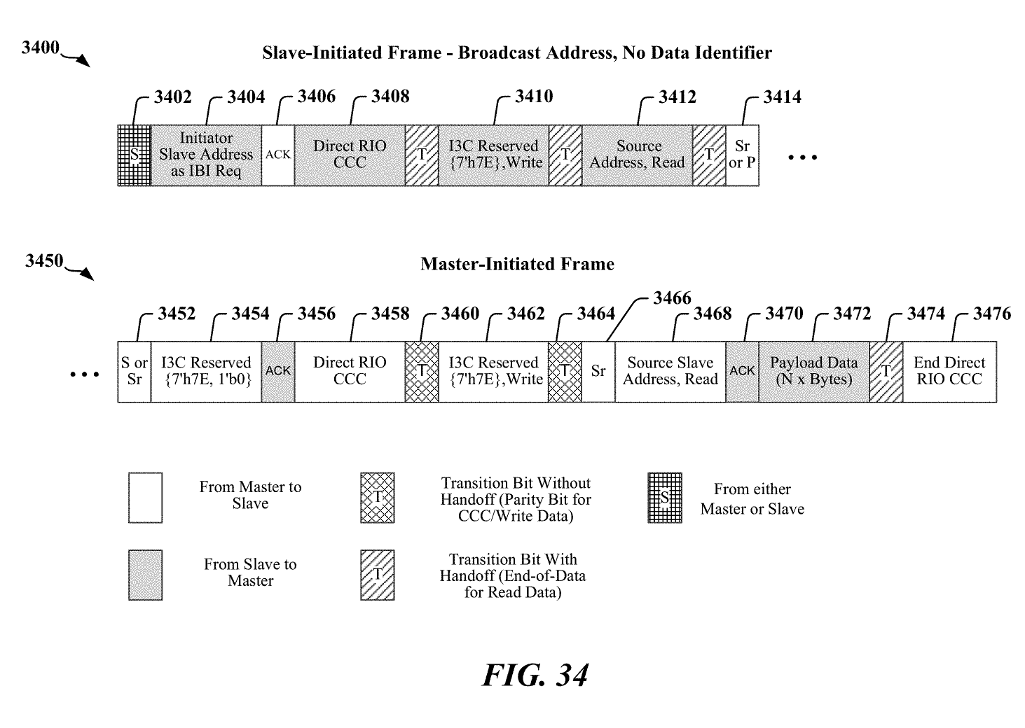

FIG. 33 is a flow diagram 3300 that illustrates an example of a slave-initiated transfer involving a broadcast. FIG. 34 illustrates a first example of transmissions 3400, 3450 corresponding to the flow diagram 3300. In the example, the initiating slave device 3302 is illustrated as being a separate device. In a typical operation, the initiating slave device 3302 is also the source slave device 3306 or a slave device coupled to the serial bus 3308 that receives data payloads broadcast by the source slave device 3306. The initiating slave device 3302 requests service from the current master device 3304 using an IBI 3310, where the IBI 3310 may be asserted in accordance with I3C specifications. The IBI 3310 may be asserted after a START condition 3402 is transmitted on the serial bus 3308 by the master device 3304 or the initiating slave device 3302. During the IBI 3310, the initiating slave device 3302 transmits its slave identifier 3404 and, after an acknowledgment 3406 from the master device 3304, the Direct RIO CCC 3408. The Direct RIO CCC 3408 may be transmitted as the mandatory byte defined by I3C protocols and may have an agreed or standards-specified value. In one example, the Direct RIO CCC 3408 may have the value 0xDB. The initiating slave device 3302 may then transmit the broadcast address 3410 defined by I3C protocols with a write bit set to indicate that the broadcast data is to be written to one or more slave devices coupled to the serial bus 3308, and a source slave address 3412 with a read bit set to indicate that data is to be read from the source slave device 3306. The master device 3304 may then transmit a Repeated START or STOP condition 3414.

The master device 3304 may start 3312 the slave-to-slave transaction on the serial bus 3308 by transmitting a START or Repeated START condition 3452, if the master device 3304 previously transmitted a STOP condition 3414. The master device 3304 transmits a header 3454 in accordance with I3C protocols. After an acknowledgement by one or more slave devices (ACK 3456), the Direct RIO CCC 3458 is transmitted. The Direct RIO CCC 3458 is followed by a transition bit 3460, the broadcast address 3410, a transition bit 3464, Repeated START bit 3466 and the address 3468 of the source slave device 3306. An ACK 3470 is expected after the address 3468 of the source slave device 3306.

The source slave device 3306 transmits payload data 3314, 3472, which may be monitored and written by any slave devices responding to the broadcast indication in the Direct RIO CCC. The payload data 3472 may be followed by a transition bit 3474, an End command 3476 and/or a Stop (P) bit or Start-Repeat (Sr) bit. The master device 3304 may send a command 3316 to terminate the slave-to-slave exchange.

In some instances, the IBI 3310 may include additional bytes of management data to configure the slave-to-slave exchange. For example, additional information may be transmitted that specifies the address of a data block to be read from the source slave device 3306, a starting location for writing data in the target devices, and/or a type or attribute of the data transferred in the slave-to-slave exchange. The number of additional bytes, the timing of their transmission in the IBI 3310 and the meaning of the additional bytes may be configured based on application needs, and between participating devices. Additional information may be transmitted by the master device 3304 prior to reading the data involved in the slave-to-slave exchange.

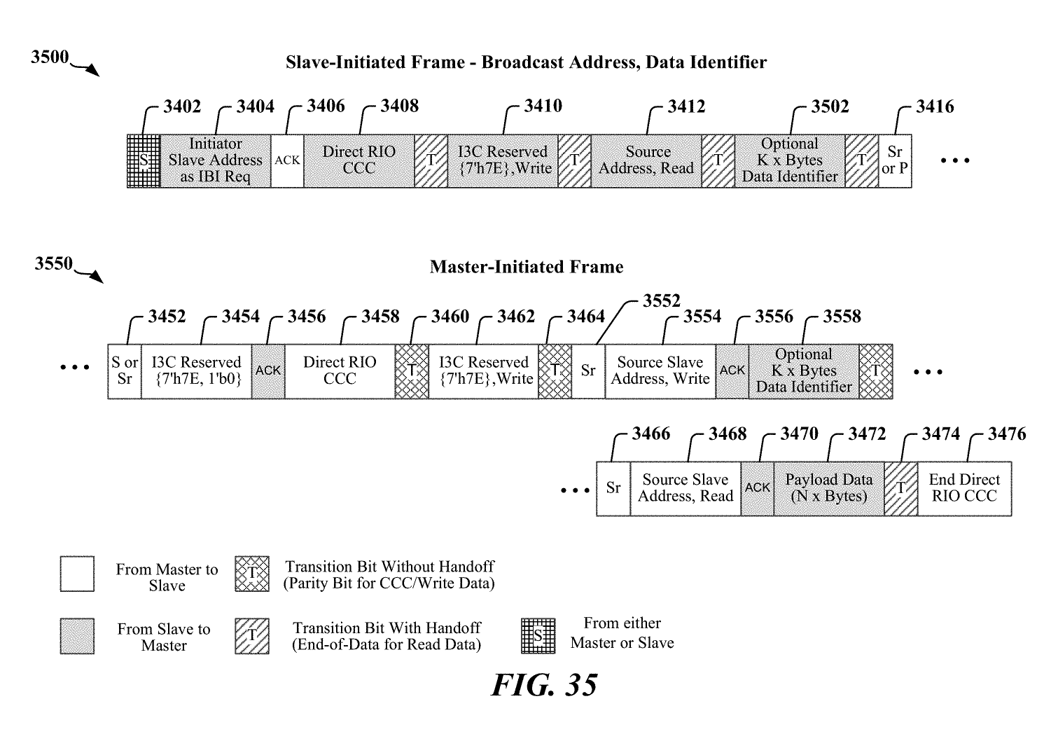

FIG. 35 illustrates a second example of transmissions 3500, 3550 corresponding to the flow diagram 3300. The transmissions 3500, 3550 include Data Identifier (DI) information in addition to the information fields illustrated in the transmissions 3400, 3450 illustrated in FIG. 34. An optional Data Identifier field 3502 may be provided by the initiating slave device 3302 during the IBI 3310, where the Data Identifier field 3502 includes K bytes of data. The Data Identifier field 3502 precedes the Repeated START or STOP condition 3414. The master device 3304 may retransmit the Data Identifier field 3502 in an optional DI field 3558 to the source slave device 3306. The master device 3304 may transmit a Repeated START condition 3552 followed by the address 3554 of the source slave device 3306 with the read/write bit set to write. The master device 3304 then transmits the DI field 3558. The master device 3304 continues the slave-to-slave transaction by transmitting the Repeated START bit 3466 and the address 3468 of the source slave device 3306 with the read/write bit set to read.

### Master-Initiated Slave-to-Slave Communication Using a Direct RIO CCC

In certain applications, it may be desirable to employ a consistent slave-to-slave protocol for both slave-initiated and master-initiated transactions. A master-initiated transfer can be performed using the Direct RIO CCC disclosed herein, whereby the bus master supplies the source and target slave addresses. In certain instances, the master-initiated transfer can be terminated early. Early termination may be supported when a bus is operated in accordance with I3C protocols, for example.

The Master device may use the Direct RIO CCC to initiate transfer of data between slave devices without storing the data. When the Direct RIO CCC is transmitted, identified target slave devices monitor the transaction. In various implementations, the Master uses a conventional directed read command to obtain data from a target slave device for the sole use of the Master device. In some instances, the Master device may transmit a Direct RIO CCC to transfer data for its own use and for writing to other devices. In some examples, the master device may use a Direct RIO CCC to obtain data solely for its own use, where the master device may specify its own identifier as the address of the target device.

Any device identified as a target for a Direct RIO CCC transfer operation monitors the transaction to capture payload data. When the Direct RIO CCC specifies a broadcast address, multiple devices may capture the payload data.

If the Master has already the data stored, it shall use at the Source Address its own address, provide the ACK, and then the Data.

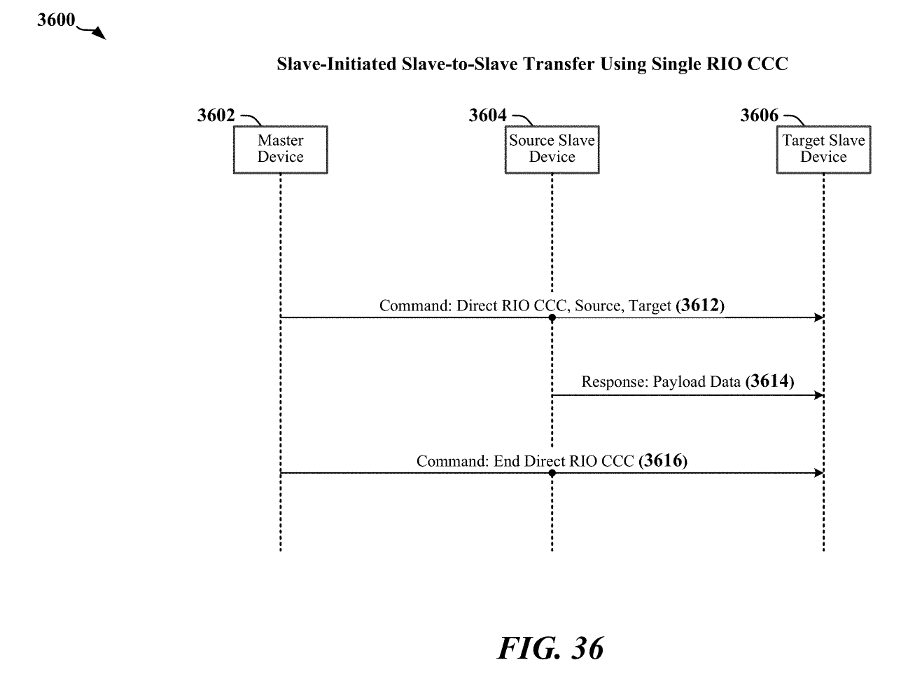

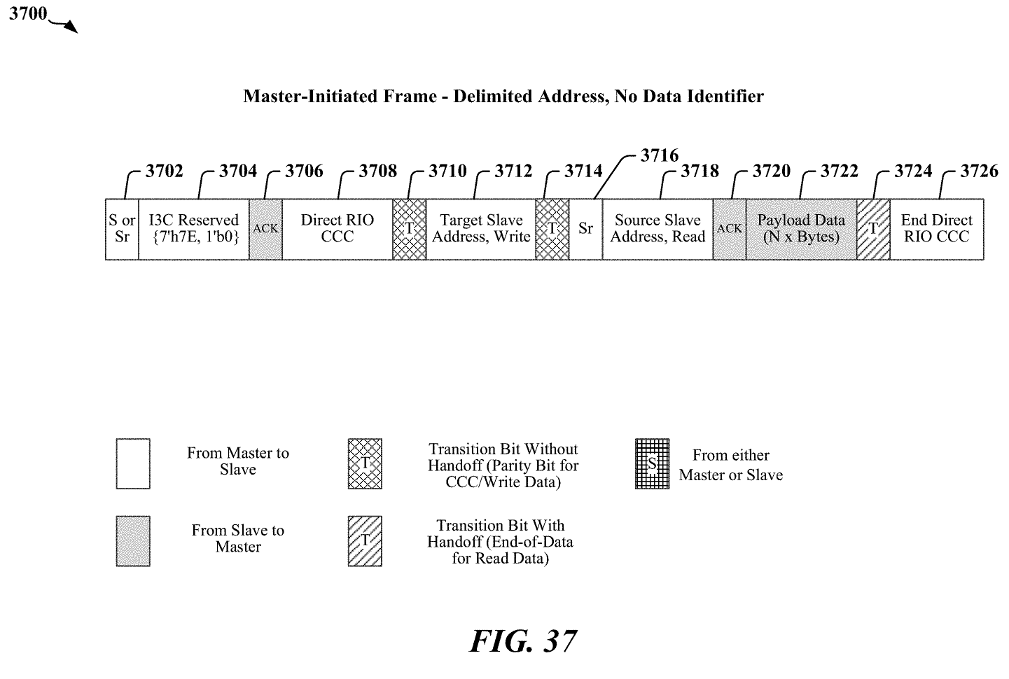

FIG. 36 is a flow diagram 3600 that illustrates an example of a master-initiated transfer between two slave devices 3604, 3606. FIG. 37 illustrates a first example of transmissions 3700 corresponding to the flow diagram 3600. The master device 3602 may start 3612 the slave-to-slave transaction by transmitting a START or Repeated START condition 3702. The master device 3602 transmits a header 3704 in accordance with I3C protocols. After an acknowledgement by one or more slave devices (ACK 3706), the Direct RIO CCC 3708 is transmitted. The Direct RIO CCC 3708 is followed by a transition bit 3710 and then the address 3712 of the target slave device 3606, a transition bit 3714, Repeated START bit 3716 and the address 3718 of the source slave device 3604. A target slave ACK 3720 is expected after the address 3718 of the source slave device 3604.

The source slave device 3604 transmits payload data 3614, 3722, which may be monitored and written by the target slave device 3606. The payload data 3722 may be followed by a transition bit 3724, an End command 3726 and/or a Stop (P) bit or Start-Repeat (Sr) bit. The master device 3602 may send a command 3616 to terminate the slave-to-slave exchange.

In some instances, the master device 3602 may transmit additional bytes of management data with the Direct RIO CCC 3708 to configure the slave-to-slave exchange. For example, additional information may be transmitted that specifies the address of a data block to be read from the source slave device 3604, a starting location for writing data in the target slave device 3606, and/or a type or attribute of the data transferred in the slave-to-slave exchange. The number of additional bytes, the timing of their transmission in the IBI 3610 and the meaning of the additional bytes may be configured based on application needs, and between participating devices 3602, 3604, 3606. The additional information may be transmitted by the master device 3602 prior to reading the data involved in the slave-to-slave exchange.

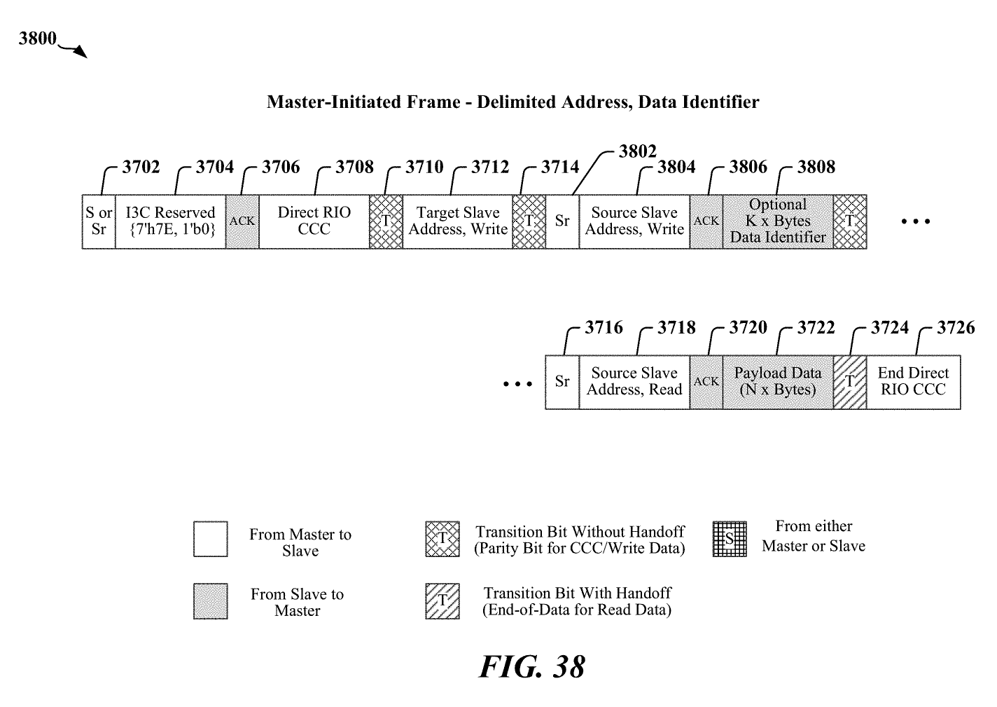

FIG. 38 illustrates a second example of transmissions 3800, 3850 corresponding to the flow diagram 3600. The transmissions 3800, 3850 include Data Identifier (DI) information in addition to the information fields illustrated in the transmissions 3700, 3750 illustrated in FIG. 37. The master device 3602 may retransmit the Data Identifier field 3802 in an optional DI field 3858 to the source slave device 3604. The master device 3602 may transmit a Repeated START condition 3852 followed by the address 3854 of the source slave device 3604 with the read/write bit set to write. The master device 3602 then transmits the DI field 3858. The master device 3602 continues the slave-to-slave transaction by transmitting the Repeated START bit 3766 and the address 3768 of the source slave device 3604 with the read/write bit set to read.

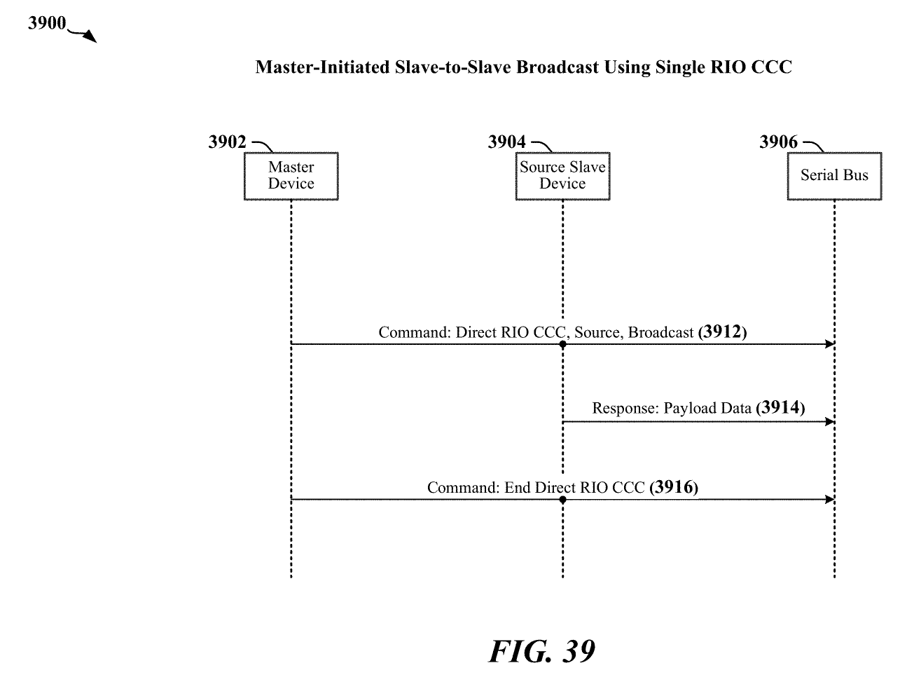

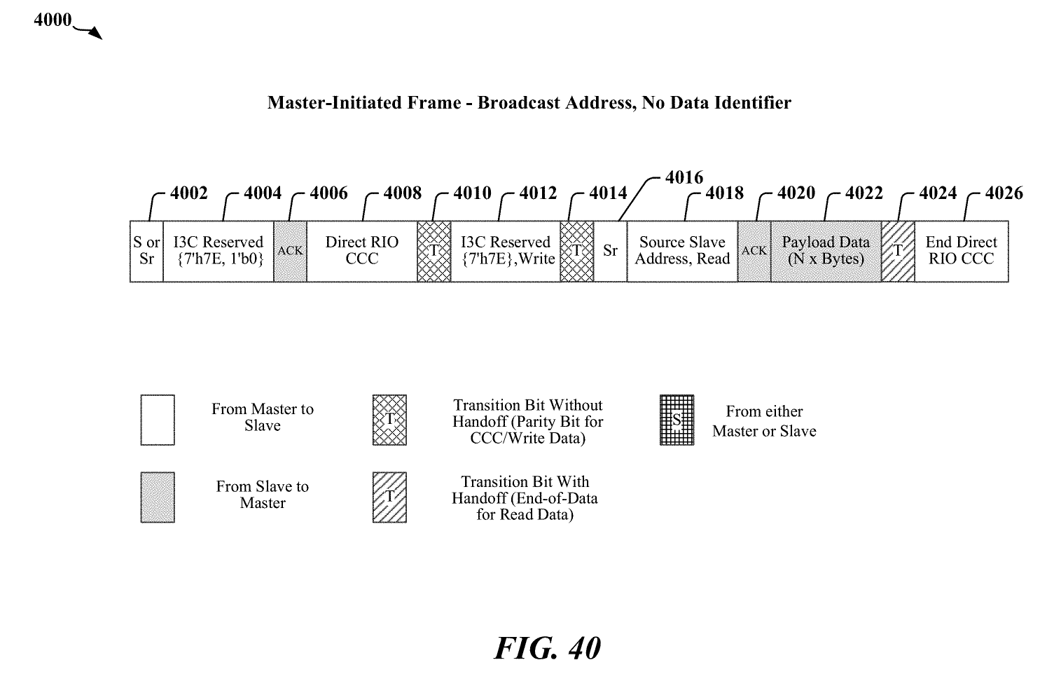

FIG. 39 is a flow diagram 3900 that illustrates an example of a master-initiated transfer by broadcast. FIG. 40 illustrates a first example of transmissions 4000 corresponding to the flow diagram 3900. The master device 3902 may start the slave-to-slave transaction on the serial bus 3908 by transmitting a START or Repeated START condition 4002. The master device 3902 transmits a header 4004 in accordance with I3C protocols. After an acknowledgement by one or more slave devices (ACK 4006), the Direct RIO CCC 4008 is transmitted. The Direct RIO CCC 4008 is followed by a transition bit 4010, the broadcast address 4012, a transition bit 4014, Repeated START bit 4016 and the address 4018 of the source slave device 3904. An ACK 4020 is expected after the address 4018 of the source slave device 3904.

The source slave device 3904 transmits payload data 3914, 4022, which may be monitored and written by any slave devices responding to the broadcast indication in the Direct RIO CCC. The payload data 4022 may be followed by a transition bit 4024, an End command 4026 and/or a Stop (P) bit or Start-Repeat (Sr) bit. The master device 3902 may send a command 3916 to terminate the slave-to-slave exchange.

In some instances, the IBI 3910 may include additional bytes of management data to configure the slave-to-slave exchange. For example, additional information may be transmitted that specifies the address of a data block to be read from the source slave device 3904, a starting location for writing data in the target devices, and/or a type or attribute of the data transferred in the slave-to-slave exchange. The number of additional bytes, the timing of their transmission in the IBI 3910 and the meaning of the additional bytes may be configured based on application needs, and between participating devices. Additional information may be transmitted by the master device 3902 prior to reading the data involved in the slave-to-slave exchange.

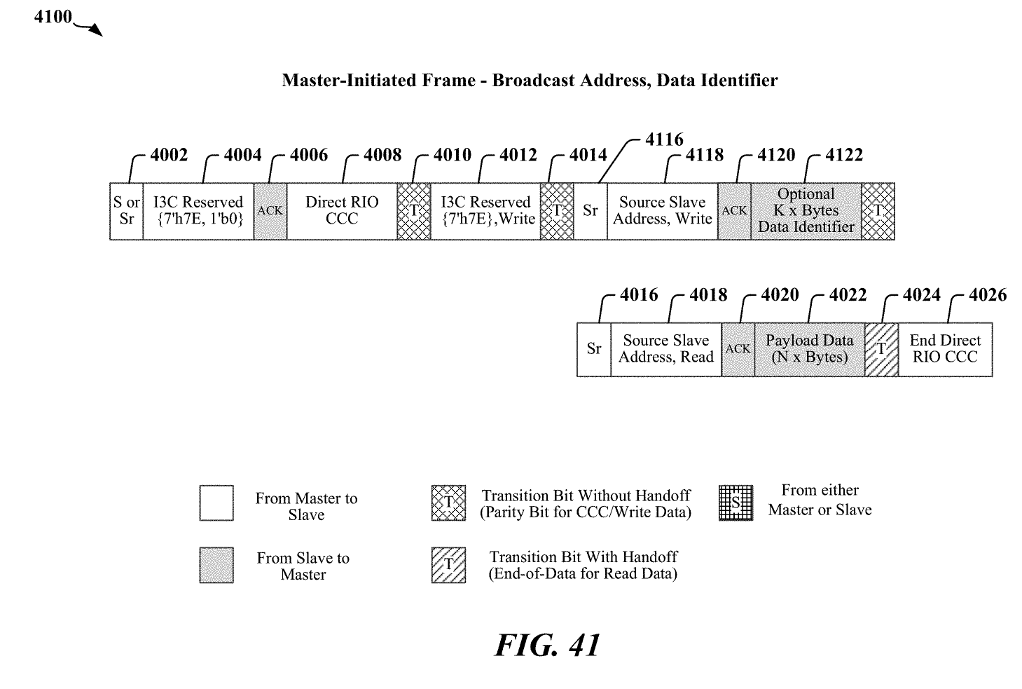

FIG. 41 illustrates a second example of transmissions 4100, 4150 corresponding to the flow diagram 3900. The transmissions 4100, 4150 include Data Identifier (DI) information in addition to the information fields illustrated in the transmissions 4000, 4050 illustrated in FIG. 40. The master device 3902 may retransmit the Data Identifier field 4102 in an optional DI field 4158 to the source slave device 3904. The master device 3902 may transmit a Repeated START condition 4152 followed by the address 4154 of the source slave device 3904 with the read/write bit set to write. The master device 3902 then transmits the DI field 4158. The master device 3902 continues the slave-to-slave transaction by transmitting the Repeated START bit 4066 and the address 4068 of the source slave device 3904 with the read/write bit set to read.

### Example of I3C Common Command Codes in Low-Latency VGI Implementations

The selection of a mode of transfer of VGI data may be determined at least in part by latency requirements imposed by application designers. In some instances, it may be desirable to minimize latency by assigning CCCs to specific operations. In other operations, operational efficiencies can be accrued at slave devices by enabling each device to interpret and respond to a CCC. For example, the use of a slave-to-slave Direct CCC can reduce the processing and storage overhead in a master device. In many implementations, trade-offs may be made dynamically, based on application requirements, power budgets and changing priorities. Table 2 provides an example of a combination of function-specific, low-latency CCCs and expandable CCCs that may be defined for the latter implementations.

TABLE 2
CCCs for Low Latency Modes

| | I3C | | |
|---|---|---|---|
| Index | VGI CCC | Characteristic | CCC Functional Assignment |
| 1 | 0x5C | Minimum | Master-Initiated Directed Write |
| 2 | 0x5D | Latency | Master-Initiated Directed Write, |
| | | | Masked |
| 3 | 0x5E | | Master-Initiated Broadcast Write |
| 4 | 0x5F | | Master-Initiated Directed Read |
| 5 | 0x60 | Latency- | VGI Command Extender |
| 6 | 0xDB | insensitive | Master-Initiated Merged Write |
| | | Commands | |
| 7 | 0xDC | Minimum | Slave-Initiated Directed Write |
| 8 | 0xDD | Latency | Slave-Initiated Directed Write, |
| | | | Masked |
| 9 | 0xDE | | Slave-Initiated Broadcast Write |
| 10 | 0xDF | | Slave-Initiated Directed Read |

### Examples of Processing Circuits and Methods

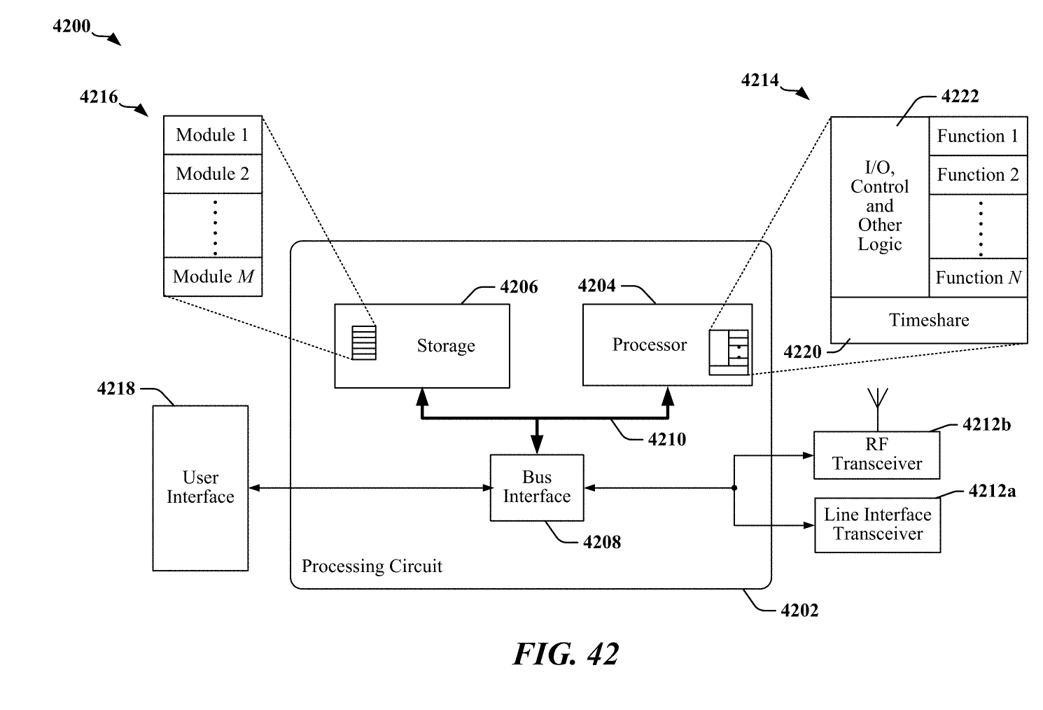

FIG. 42 is a diagram illustrating an example of a hardware implementation for an apparatus 4200 employing a finite state machine 610 to communicate in-band hardware reset signals. In some examples, the apparatus 4200 may configure the operation of the finite state machine 610. In some examples, the apparatus 4200 may perform one or more functions disclosed herein. In accordance with various aspects of the disclosure, an element, or any portion of an element, or any combination of elements as disclosed herein may be implemented using a processing circuit 4202. The processing circuit 4202 may include one or more processors 4204 that are controlled by some combination of hardware and software modules. Examples of processors 4204 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 4204 may include specialized processors that perform specific functions, and that may be configured, augmented or controlled by one of the software modules 4216. The one or more processors 4204 may be configured through a combination of software modules 4216 loaded during initialization, and further configured by loading or unloading one or more software modules 4216 during operation.

In the illustrated example, the processing circuit 4202 may be implemented with a bus architecture, represented generally by the bus 4210. The bus 4210 may include any number of interconnecting buses and bridges depending on the specific application of the processing circuit 4202 and the overall design constraints. The bus 4210 links together various circuits including the one or more processors 4204, and storage 4206. Storage 4206 may include memory devices and mass storage devices, and may be referred to herein as computer-readable media and/or processor-readable media. The bus 4210 may also link various other circuits such as timing sources, timers, peripherals, voltage regulators, and power management circuits. A bus interface 4208 may provide an interface between the bus 4210 and one or more transceivers 4212a, 4212b. A transceiver 4212a, 4212b may be provided for each networking technology supported by the processing circuit. In some instances, multiple networking technologies may share some or all of the circuitry or processing modules found in a transceiver 4212a, 4212b. Each transceiver 4212a, 4212b provides a means for communicating with various other apparatus over a transmission medium. In one example, a transceiver 4212a may be used to couple the apparatus 4200 to a multi-wire bus. In another example, a transceiver 4212b may be used to connect the apparatus 4200 to a radio access network. Depending upon the nature of the apparatus 4200, a user interface 4218 (e.g., keypad, display, speaker, microphone, joystick) may also be provided, and may be communicatively coupled to the bus 4210 directly or through the bus interface 4208.

A processor 4204 may be responsible for managing the bus 4210 and for general processing that may include the execution of software stored in a computer-readable medium that may include the storage 4206. In this respect, the processing circuit 4202, including the processor 4204, may be used to implement any of the methods, functions and techniques disclosed herein. The storage 4206 may be used for storing data that is manipulated by the processor 4204 when executing software, and the software may be configured to implement any one of the methods disclosed herein.

One or more processors 4204 in the processing circuit 4202 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 4206 or in an external computer-readable medium. The external computer-readable medium and/or storage 4206 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 4206 may also include, by way of example, a carrier wave, a transmission line, and any other suitable medium for transmitting software and/or instructions that may be accessed and read by a computer. Computer-readable medium and/or the storage 4206 may reside in the processing circuit 4202, in the processor 4204, external to the processing circuit 4202, or be distributed across multiple entities including the processing circuit 4202. The computer-readable medium and/or storage 4206 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 4206 may maintain software maintained and/or organized in loadable code segments, modules, applications, programs, etc., which may be referred to herein as software modules 4216. Each of the software modules 4216 may include instructions and data that, when installed or loaded on the processing circuit 4202 and executed by the one or more processors 4204, contribute to a run-time image 4214 that controls the operation of the one or more processors 4204. When executed, certain instructions may cause the processing circuit 4202 to perform functions in accordance with certain methods, algorithms and processes described herein.

Some of the software modules 4216 may be loaded during initialization of the processing circuit 4202, and these software modules 4216 may configure the processing circuit 4202 to enable performance of the various functions disclosed herein. For example, some software modules 4216 may configure internal devices and/or logic circuits 4222 of the processor 4204, and may manage access to external devices such as the one or more transceivers 4212a, 4212b, the bus interface 4208, the user interface 4218, timers, mathematical coprocessors, and so on. The software modules 4216 may include a control program and/or an operating system that interacts with interrupt handlers and device drivers, and that controls access to various resources provided by the processing circuit 4202. The resources may include memory, processing time, access to the one or more transceivers 4212a, 4212b, the user interface 4218, and so on.

One or more processors 4204 of the processing circuit 4202 may be multifunctional, whereby some of the software modules 4216 are loaded and configured to perform different functions or different instances of the same function. The one or more processors 4204 may additionally be adapted to manage background tasks initiated in response to inputs from the user interface 4218, the one or more transceivers 4212a, 4212b, and device drivers, for example. To support the performance of multiple functions, the one or more processors 4204 may be configured to provide a multitasking environment, whereby each of a plurality of functions is implemented as a set of tasks serviced by the one or more processors 4204 as needed or desired. In one example, the multitasking environment may be implemented using a timesharing program 4220 that passes control of a processor 4204 between different tasks, whereby each task returns control of the one or more processors 4204 to the timesharing program 4220 upon completion of any outstanding operations and/or in response to an input such as an interrupt. When a task has control of the one or more processors 4204, the processing circuit is effectively specialized for the purposes addressed by the function associated with the controlling task. The timesharing program 4220 may include an operating system, a main loop that transfers control on a round-robin basis, a function that allocates control of the one or more processors 4204 in accordance with a prioritization of the functions, and/or an interrupt driven main loop that responds to external events by providing control of the one or more processors 4204 to a handling function.

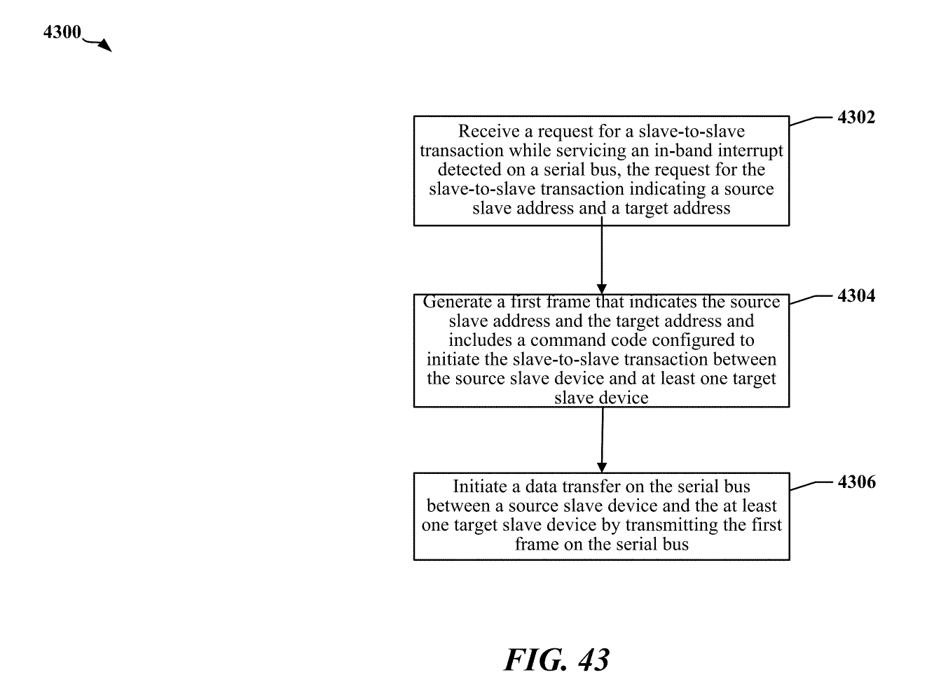

FIG. 43 is a flowchart 4300 illustrating an example of a method for facilitating a slave-to-slave communication that may be performed at a device coupled to a serial bus.

At block 4302, the device may receive a request for a slave-to-slave transaction while servicing an in-band interrupt detected on a serial bus, the request for the slave-to-slave transaction indicating a source slave address and a target address.

At block 4304, the device may generate a first frame that indicates the source slave address and the target address and includes a command code configured to initiate the slave-to-slave transaction between the source slave device and at least one target slave device.

At block 4306, the device may initiate a data transfer on the serial bus between the source slave device and the at least one target slave device by transmitting the first frame on the serial bus.

In one example, the target address is a broadcast address configured to cause a plurality of slave devices to receive payload data transmitted by the source slave device in the first frame.

In certain examples, the device provides a first indicator in the source slave address that indicates that the data on the source slave device is to be read as a part of the first frame.

In some examples, the command code is configured to cause the source slave device to transmit a data payload as a part of the first frame. The command code may be further configured to cause the at least one target slave device to monitor the serial bus and receive the data payload. The command code may be a broadcast command code that is configured to cause a plurality of slave devices to receive payload data transmitted by the source slave device in the first frame

In certain examples, the device may receive the source slave address and the command code in a second frame transmitted by an initiating slave device while servicing the in-band interrupt. The device may transmit the first frame in response to reception of the second frame. A target slave address may be provided in the second frame, the target slave address identifying the at least one target slave device. The device may receive data identifier information in the second frame. The device may transmit a write command in the first frame, the write command being configured to cause the data identifier information to be written to the source slave device.

In some examples, the first frame includes a data payload transmitted by the source slave device. The source address or the target address may identify a bus master device.

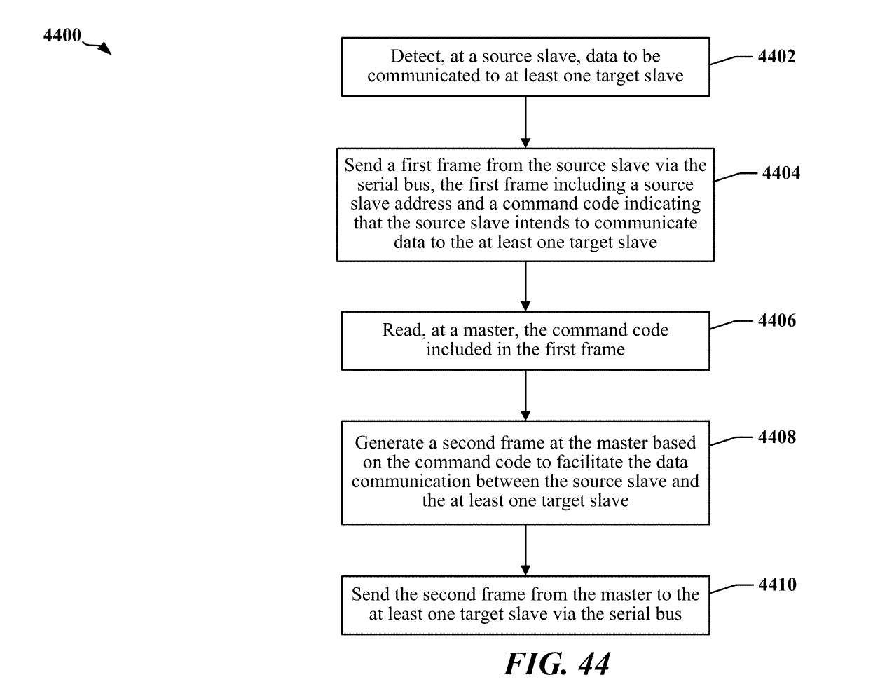

FIG. 44 is a flowchart 4400 of a method that may be performed at a device for facilitating a slave-to-slave communication on a serial bus.

At block 4402, the device may detect, at a source slave, data to be communicated to at least one target slave.

At block 4404, the device may send a first frame from the source slave via the serial bus. The first frame may include a source slave address and a command code indicating that the source slave intends to communicate data to the at least one target slave. In an aspect, the data may be a hardware event status.

At block 4406, the device may read, at a master, the command code included in the first frame.

At block 4408, the device may generate a second frame at the master based on the command code to facilitate the data communication between the source slave and the at least one target slave. In an aspect, the second frame may include a second command code indicating that the data associated with the second frame is originated by the source slave.

At block 4410, the device may send the second frame from the master to the at least one target slave via the serial bus.

In an aspect, the first frame and the second frame may include a target slave address when the source slave intends to communicate the data to a single target slave. In another aspect, the first frame includes the data to be communicated to the at least one target slave, and the second frame includes the data to be communicated to the at least one target slave.

In a further aspect, the command code included in the first frame indicates that the source slave intends to have the at least one target slave monitor a data line to receive the data from the source slave. Accordingly, the second frame commands the at least one target slave to monitor the data line to receive the data from the source slave. Moreover, the second frame may include a source slave address.

In some implementations, the data may be sent to the at least one target slave in accordance with a standards-defined protocol that controls transmissions over a shared communication link. For example, the shared communication link may include a serial bus operated in accordance with an I2C, I3C, RFFE, SPMI or other protocol defined by the MIPI Alliance.

In various aspects of the disclosure, a method performed at a device for receiving a slave-to-slave communication on a serial bus, may include detecting, at a requesting device, data to be retrieved from a target slave, sending a first frame from the requesting device via the serial bus, the first frame including a target slave address and a command code indicating that the requesting device intends to retrieve the data from the target slave, reading, at a master, the command code included in the first frame, generating a second frame at the master based on the command code to facilitate a data communication between the requesting device and the target slave, and sending the second frame from the master to the target slave via the serial bus. In an aspect, the data is a hardware event status. In a further aspect, the second frame commands the target slave to send the data via the serial bus.

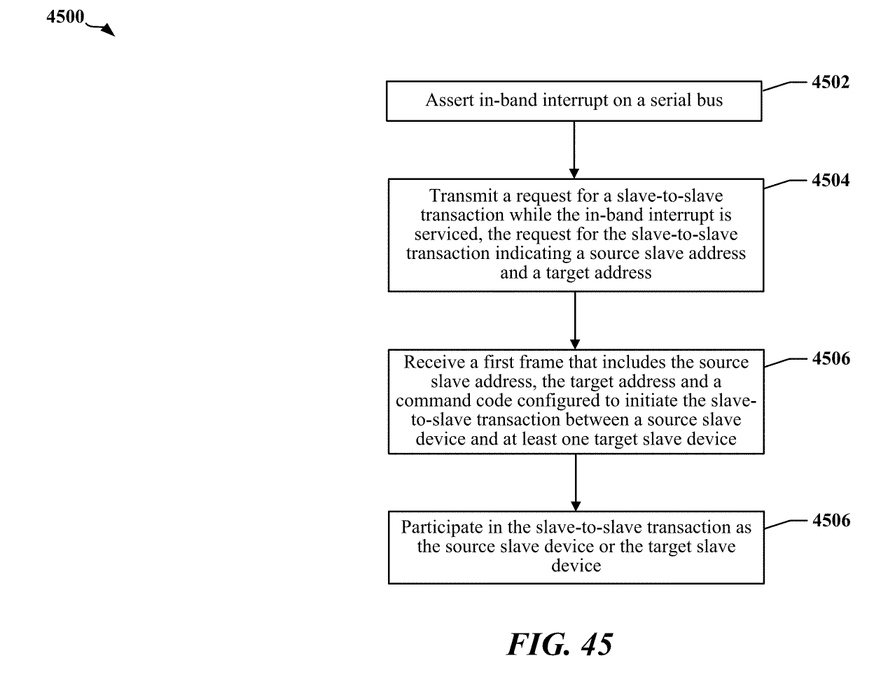

FIG. 45 is a flowchart 4500 of a method for a slave-to-slave communication on a serial bus that may be performed at a slave device.

At block 4502, the slave device may assert in-band interrupt on the serial bus.

At block 4504, the slave device may transmit a request for a slave-to-slave transaction while the in-band interrupt is serviced. The request for the slave-to-slave transaction may indicate a source slave address and a target address.

At block 4506, the slave device may receive a first frame that includes the source slave address. The target address and a command code may be configured to initiate the slave-to-slave transaction between the source slave device and at least one target slave device. At block 4508, the slave device may participate in the slave-to-slave transaction as the source slave device or the target slave device.

In one example, the target address is a broadcast address and the slave device may receive payload data transmitted by the source slave device as part of the first frame.

In another example, the slave device may transmit a data payload as a part of the first frame.

In some examples, the slave device may transmit the source slave address and the command code in a second frame while the in-band interrupt is serviced. The command code may include a broadcast command code that is configured to cause a plurality of slave devices to receive payload data transmitted by the source slave device in the first frame. The source address or the target address may identify a bus master device.

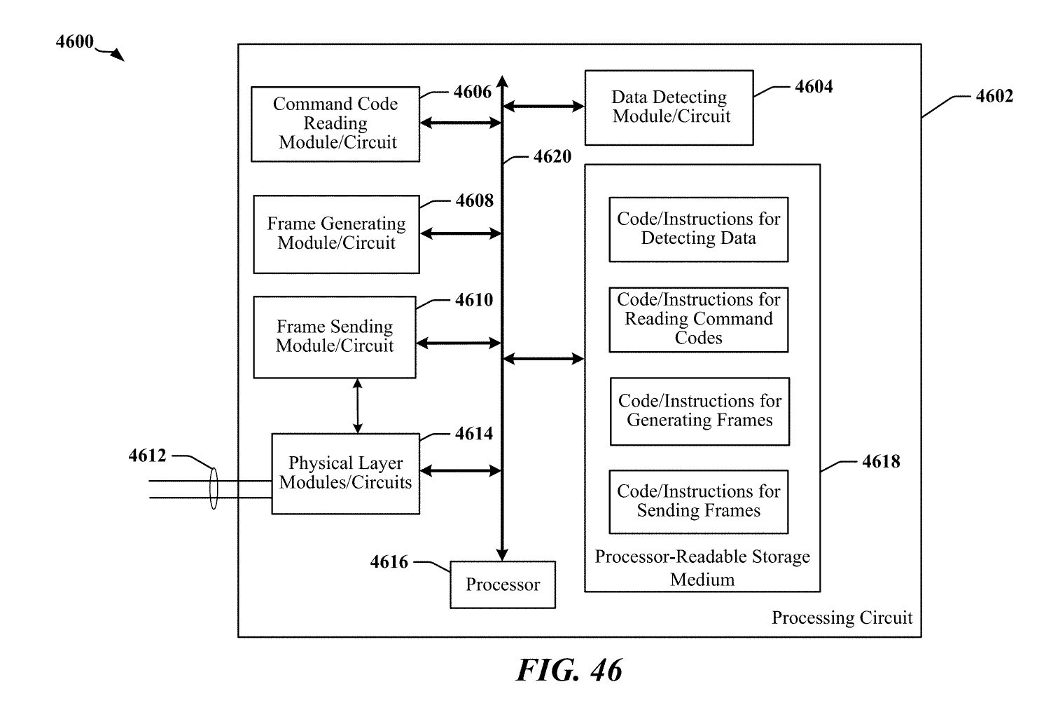

FIG. 46 is a diagram illustrating an example of a hardware implementation for an apparatus 4600 employing a processing circuit 4602. The apparatus may implement a bridging circuit in accordance with certain aspects disclosed herein. The processing circuit typically has a controller or processor 4616 that may include one or more microprocessors, microcontrollers, digital signal processors, sequencers and/or state machines. The processing circuit 4602 may be implemented with a bus architecture, represented generally by the bus 4620. The bus 4620 may include any number of interconnecting buses and bridges depending on the specific application of the processing circuit 4602 and the overall design constraints. The bus 4620 links together various circuits including one or more processors and/or hardware modules, represented by the controller or processor 4616, the modules or circuits 4604, 4606, 4608, and 4610 and the processor-readable storage medium 4618. One or more physical layer circuits and/or modules 4614 may be provided to support communications over a communication link implemented using a multi-wire bus 4612 or other communication structure. The bus 4620 may also link various other circuits such as timing sources, peripherals, voltage regulators, and power management circuits, which are well known in the art, and therefore, will not be described any further.

The processor 4616 is responsible for general processing, including the execution of software, code and/or instructions stored on the processor-readable storage medium 4618. The processor-readable storage medium may include a non-transitory storage medium. The software, when executed by the processor 4616, causes the processing circuit 4602 to perform the various functions described supra (e.g., the functions described with respect to FIGS. 14-17 and 33) for any particular apparatus. The processor-readable storage medium may be used for storing data that is manipulated by the processor 4616 when executing software. The processing circuit 4602 further includes at least one of the modules 4604, 4606, 4608, and 4610. The modules 4604, 4606, 4608 and 4610 may be software modules running in the processor 4616, resident/stored in the processor-readable storage medium 4618, one or more hardware modules coupled to the processor 4616, or some combination thereof. The modules 4604, 4606, 4608, and 4610 may include microcontroller instructions, state machine configuration parameters, or some combination thereof.

In one configuration, the apparatus 4600 includes modules and/or circuits 4604 configured to detect, at a source slave, data to be communicated to at least one target slave, modules and/or circuits 4610 configured to send a first frame from the source slave via the serial bus, the first frame including a source slave address and a command code indicating that the source slave intends to communicate data to the at least one target slave, modules and/or circuits 4606 configured to read, at a master, the command code included in the first frame, and modules and/or circuits 4608 configured to generate a second frame at the master based on the command code to facilitate the data communication between the source slave and the at least one target slave. The modules and/or circuits 4610 may be further configured to send the second frame from the master to the at least one target slave via the serial bus.

In various examples, the apparatus 4600 includes physical layer circuits and/or modules 4614 that are adapted to provide an interface that couples the apparatus 4600 to a multi-wire bus 4612 that is operated in accordance with a serial bus protocol. The apparatus 4600 also includes a processing circuit 4602 configured to receive a request for a slave-to-slave transaction while servicing an in-band interrupt detected on the multi-wire bus 4612, the request for the slave-to-slave transaction indicating a source slave address and a target address, generate a first frame that includes the source slave address, the target address and a command code configured to initiate the slave-to-slave transaction between the source slave device and at least one target slave device, and a data transfer on the multi-wire bus 4612 between the source slave device and the at least one target slave device by transmitting the first frame on the multi-wire bus 4612. The target address may be a broadcast address that is configured to cause a plurality of slave devices to receive payload data transmitted by the source slave device in the first frame. A first indicator provided in the source slave address may indicate that the data on the source slave device is to be read as a part of the first frame. The command code may be configured to cause the source slave device to transmit a data payload as a part of the first frame. The command code may be further configured to cause the at least one target slave device to monitor the serial bus and receive the data payload transmitted by the source slave device. The processing circuit 4602 may be configured to receive the source slave address and the command code in a second frame transmitted by an initiating slave device while servicing the in-band interrupt process, and transmit the first frame in response to reception of the second frame. The first frame may be generated by a bus master device and the target address may identify the bus master device. The processing circuit 4602 may be configured to receive data identifier information in the second frame, and transmit a write command in the first frame, the write command being configured to cause the data identifier information to be written to the source slave device. The first frame may include a data payload transmitted by the source slave device.

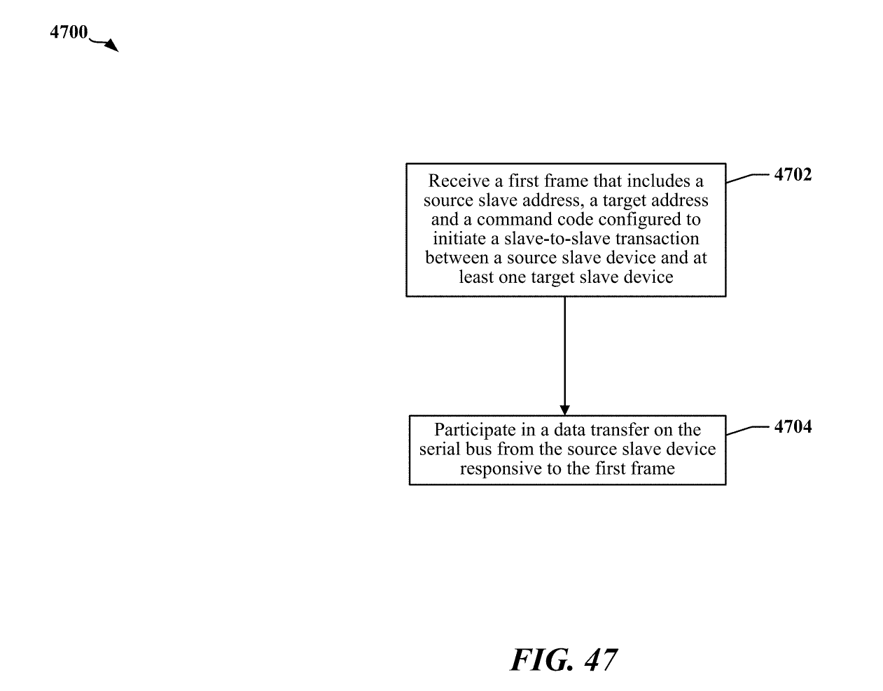

FIG. 47 is a flowchart 4700 illustrating an example of a method for facilitating a slave-to-slave communication that may be performed at a device coupled to a serial bus.

At block 4702, the device may receive a first frame that includes a source slave address, a target address and a command code configured to initiate a slave-to-slave transaction between a source slave device and at least one target slave device. The command code may include a broadcast command code, and the device may receive payload data transmitted by the source slave device in the first frame.

At block 4704, the device may participate in a data transfer on the serial bus from the source slave device responsive to the first frame.

The device may monitor the serial bus for data transmitted by the source slave device after receiving the command code, and receive a data payload transmitted by the source slave. The device may transmit the source slave address and the command code in a second frame during an in-band interrupt process. The first frame may be transmitted in response to the second frame. The device may transmit a target slave address in the second frame.

In certain examples, the source slave address and the command code are transmitted in a second frame transmitted by an initiating slave device during an in-band interrupt process. The first frame may be transmitted in response to the second frame. The device may maintain a unique slave device identifier in storage. The device may respond to the command code when the command code is transmitted with a target slave address matching the unique slave device identifier.

The first frame may be configured to cause data identifier information to be written to the source slave device. The first frame may include a data payload transmitted by the source slave device responsive to the data identifier information.

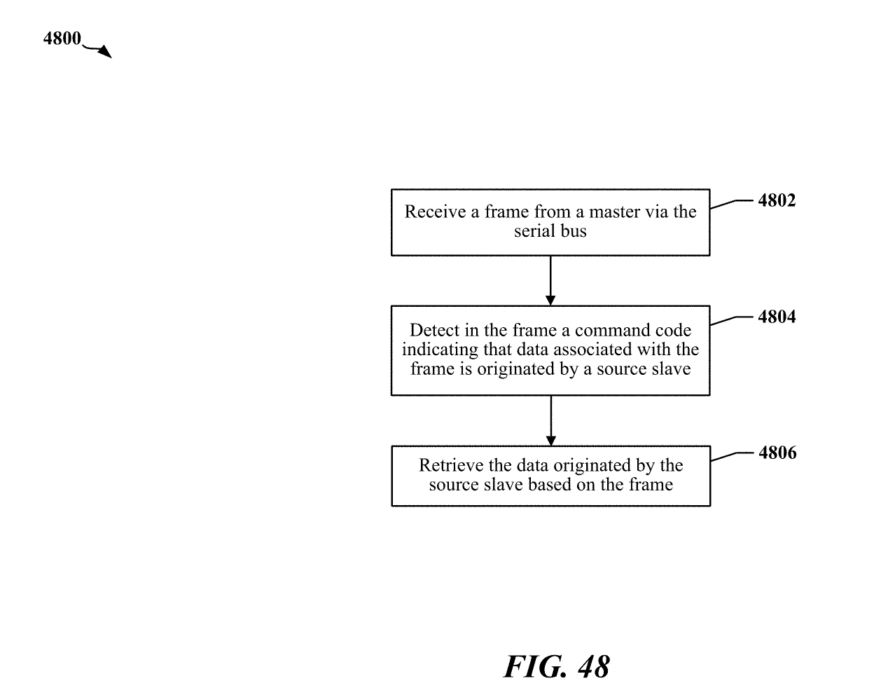

FIG. 48 is a flowchart 4800 of a method that may be performed at a target slave for receiving a slave-to-slave communication on a serial bus.

At block 4802, the target slave may receive a frame from a master via the serial bus.

At block 4804, the target slave may detect in the frame a command code indicating that data associated with the frame is originated by a source slave. In an aspect, the data is a hardware event status

At block 4806, the target slave may retrieve the data originated by the source slave based on the frame.

In an aspect, the frame includes a target slave address when the data is intended to be communicated to a single target slave.

In another aspect, the frame includes the data originated by the source slave, and the data is retrieved from the frame.

In a further aspect, the command code included in the frame commands the target slave to monitor a data line to receive the data originated by the source slave. Accordingly, the target slave retrieves the data by monitoring the data line to receive the data originated by the source slave. Moreover, the frame may include a source slave address.

In some implementations, the data may be received by the target slave in accordance with a standards-defined protocol that controls transmissions over a shared communication link. For example, the shared communication link may include a serial bus operated in accordance with an I2C, I3C, RFFE, SPMI or other protocol defined by the MIPI Alliance.

In various aspects of the disclosure, a method performed at a target slave for facilitating a slave-to-slave communication on a serial bus, may include receiving a frame from a master via the serial bus, detecting in the frame a command code indicating that a requesting device intends to retrieve data from the target slave, and sending the data to the requesting device via the serial bus based on the frame. In an aspect, the data is a hardware event status.

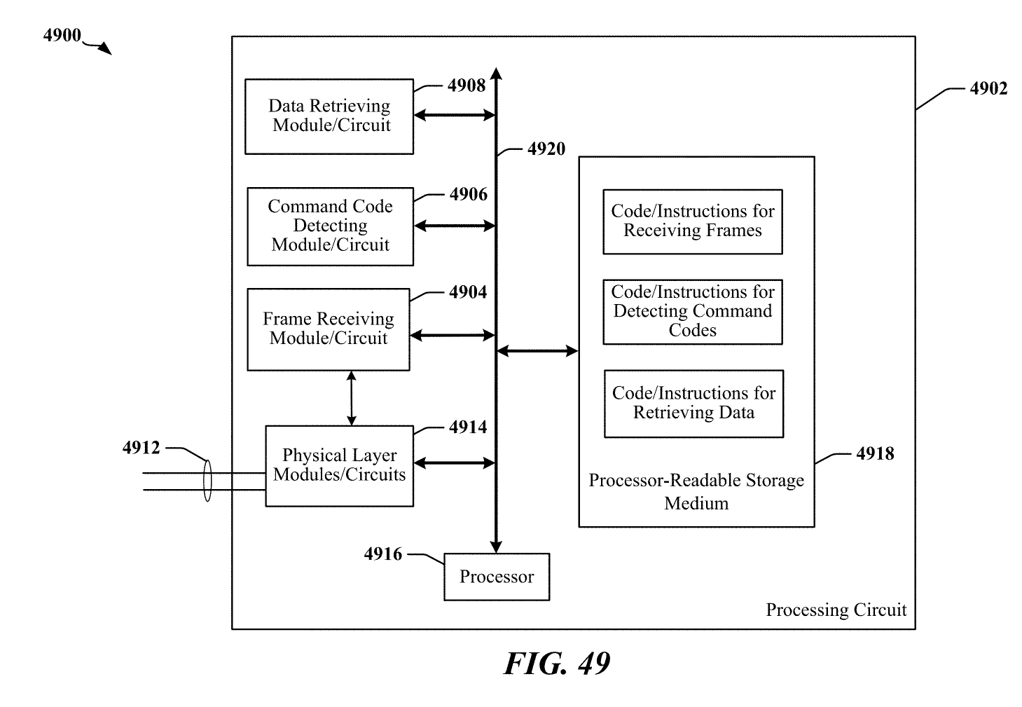

FIG. 49 is a diagram illustrating an example of a hardware implementation for an apparatus 4900 employing a processing circuit 4902. The apparatus may implement a bridging circuit in accordance with certain aspects disclosed herein. The processing circuit typically has a controller or processor 4916 that may include one or more microprocessors, microcontrollers, digital signal processors, sequencers and/or state machines. The processing circuit 4902 may be implemented with a bus architecture, represented generally by the bus 4920. The bus 4920 may include any number of interconnecting buses and bridges depending on the specific application of the processing circuit 4902 and the overall design constraints. The bus 4920 links together various circuits including one or more processors and/or hardware modules, represented by the controller or processor 4916, the modules or circuits 4904, 4906, and 4908 and the processor-readable storage medium 4918. One or more physical layer circuits and/or modules 4914 may be provided to support communications over a communication link implemented using a multi-wire bus 4912 or other communication structure. The bus 4920 may also link various other circuits such as timing sources, peripherals, voltage regulators, and power management circuits, which are well known in the art, and therefore, will not be described any further.

The processor 4916 is responsible for general processing, including the execution of software, code and/or instructions stored on the processor-readable storage medium 4918. The processor-readable storage medium may include a non-transitory storage medium. The software, when executed by the processor 4916, causes the processing circuit 4902 to perform the various functions described supra (e.g., the functions described with respect to FIGS. 14-17 and 37) for any particular apparatus. The processor-readable storage medium may be used for storing data that is manipulated by the processor 4916 when executing software. The processing circuit 4902 further includes at least one of the modules 4904, 4906, and 4908. The modules 4904, 4906, and 4908 may be software modules running in the processor 4916, resident/stored in the processor-readable storage medium 4918, one or more hardware modules coupled to the processor 4916, or some combination thereof. The modules 4904, 4906, and 4908 may include microcontroller instructions, state machine configuration parameters, or some combination thereof.

In one configuration, the apparatus 4900 includes modules and/or circuits 4904 configured to receive a frame from a master via the serial bus, modules and/or circuits 4906 configured to detect in the frame a command code indicating that data associated with the frame is originated by a source slave, and modules and/or circuits 4908 configured to retrieve the data originated by the source slave based on the frame.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for facilitating slave-to-slave communication, comprising:
receiving a request for a slave-to-slave transaction while servicing an in-band interrupt detected on a serial bus, the request for the slave-to-slave transaction indicating a source address and a target address;
generating a first frame that indicates the source address and the target address and includes a command code configured to initiate the slave-to-slave transaction between a source slave device and at least one target slave device; and
initiating a data transfer on the serial bus between the source slave device and the at least one target slave device by transmitting the first frame on the serial bus.

2. The method of claim 1, wherein the target address comprises a broadcast address that is configured to cause a plurality of slave devices to receive payload data transmitted by the source slave device in the first frame.

3. The method of claim 1, further comprising:
providing a first indicator in the source address that indicates that slave data on the source slave device is to be read as a part of the first frame.

4. The method of claim 1, wherein:
the command code is configured to cause the source slave device to transmit a data payload as a part of the first frame; and
the command code is further configured to cause the at least one target slave device to monitor the serial bus and receive the data payload.

5. The method of claim 1, further comprising:
receiving an indication of the source address and the command code in a second frame transmitted by an initiating slave device while servicing the in-band interrupt; and
transmitting the first frame in response to reception of the second frame.

6. The method of claim 5, wherein a target slave address is indicated in the second frame, the target slave address identifying the at least one target slave device.

7. The method of claim 5, further comprising:
receiving data identifier information in the second frame; and
transmitting a write command in the first frame, the write command being configured to cause the data identifier information to be written to the source slave device.

8. The method of claim 1, wherein the first frame includes a data payload transmitted by the source slave device.

9. The method of claim 1, wherein the command code comprises a broadcast command code that is configured to cause a plurality of slave devices to receive payload data transmitted by the source slave device in the first frame.

10. The method of claim 1, wherein the source address or the target address identifies a bus master device.

11. An apparatus comprising:
an interface adapted to couple the apparatus to a serial bus; and
a processing circuit configured to:
receive a request for a slave-to-slave transaction while servicing an in-band interrupt detected on a serial bus, the request for the slave-to-slave transaction indicating a source address and a target address;
generate a first frame that indicates the source address and the target address and includes a command code configured to initiate the slave-to-slave transaction between a source slave device and at least one target slave device; and
initiate a data transfer on the serial bus between the source slave device and the at least one target slave device by transmitting the first frame on the serial bus.

12. The apparatus of claim 11, wherein the target address comprises a broadcast address that is configured to cause a plurality of slave devices to receive payload data transmitted by the source slave device in the first frame.

13. The apparatus of claim 11, wherein a first indicator provided in the source address indicates that data on the source slave device is to be read as a part of the first frame.

14. The apparatus of claim 11, wherein:
the command code is configured to cause the source slave device to transmit a data payload as a part of the first frame; and
the command code is further configured to cause the at least one target slave device to monitor the serial bus and receive the data payload transmitted by the source slave device.

15. The apparatus of claim 11, wherein the processing circuit is further configured to:
receive an indication of the source address and the command code in a second frame transmitted by an initiating slave device while servicing the in-band interrupt; and
transmit the first frame in response to reception of the second frame.

16. The apparatus of claim 15, wherein the first frame is generated by a bus master device and the target address identifies the bus master device.

17. The apparatus of claim 15, wherein the processing circuit is further configured to:
receive data identifier information in the second frame; and
transmit a write command in the first frame, the write command being configured to cause the data identifier information to be written to the source slave device.

18. The apparatus of claim 11, wherein the first frame includes a data payload transmitted by the source slave device.

19. A method for slave-to-slave communication, comprising:
asserting in-band interrupt on a serial bus;
transmitting a request for a slave-to-slave transaction while the in-band interrupt is serviced, the request for the slave-to-slave transaction indicating a source address and a target address;
receiving a first frame that indicates the source address, the target address and includes a command code configured to initiate the slave-to-slave transaction between a source slave device and at least one target slave device; and
participating in the slave-to-slave transaction as the source slave device or the target slave device.

20. The method of claim 19, wherein the target address comprises a broadcast address, further comprising:
receiving payload data transmitted by the source slave device as part of the first frame.

21. The method of claim 19, further comprising:
transmitting a data payload as a part of the first frame.

22. The method of claim 19, further comprising:
transmitting an indication of the source address and the command code in a second frame while the in-band interrupt is serviced.

23. The method of claim 19, wherein the command code comprises a broadcast command code that is configured to cause a plurality of slave devices to receive payload data transmitted by the source slave device in the first frame.

24. The method of claim 19, wherein the source address or the target address identifies a bus master device.

25. A processor-readable storage medium having one or more instructions which, when executed by at least one processor of a processing circuit, cause the processing circuit to:
assert in-band interrupt on a serial bus;
transmitting a request for a slave-to-slave transaction while the in-band interrupt is serviced, the request for the slave-to-slave transaction indicating a source address and a target address;
receive a first frame that indicates the source address and the target address and includes a command code configured to initiate the slave-to-slave transaction between a source slave device and at least one target slave device; and
participate in the slave-to-slave transaction as the source slave device or the target slave device.

26. The storage medium of claim 25, wherein the target address comprises a broadcast address and wherein the instructions cause the processing circuit to:
receive payload data transmitted by the source slave device as part of the first frame.

27. The storage medium of claim 25, wherein the instructions cause the processing circuit to:
transmit a data payload as a part of the first frame.

28. The storage medium of claim 25, wherein the instructions cause the processing circuit to:
transmit an indication of the source address and the command code in a second frame while the in-band interrupt is serviced.

29. The storage medium of claim 25, wherein the command code comprises a broadcast command code that is configured to cause a plurality of slave devices to receive payload data transmitted by the source slave device in the first frame.

30. The storage medium of claim 25, wherein the source address or the target address identifies a bus master device.
